(19) United States
(12) Patent Application Publication
(10) Pub. No.: US 2022/0086489 A1
(43) Pub. Date: Mar. 17, 2022

(54) IMAGE PROCESSING APPARATUS AND METHOD

(71) Applicant: SONY GROUP CORPORATION, TOKYO (JP)

(72) Inventor: YUJI FUJIMOTO, TOKYO (JP)

(21) Appl. No.: 17/309,668

(22) PCT Filed: Dec. 6, 2019
(86) PCT No.: PCT/JP2019/047781

§ 371 Date: Jun. 14, 2021

(30) Foreign Application Priority Data
Dec. 21, 2018 (JP) 2018-240107

(51) Int. Cl. H04N 19/61; H04N 19/436; H04N 19/176; H04N 19/91; H04N 19/96; H04N 19/159

(52) U.S. Cl. CPC H04N 19/61; H04N 19/436; H04N 19/159; H04N 19/91; H04N 19/96; H04N 19/176

(57) ABSTRACT

The present disclosure relates to an image processing apparatus and a method capable of reducing a decrease in a degree of parallelism of coding and decoding. Coefficient data associated with an image is coded in parallel for each line of transform blocks each of which is a unit of transforming image data into coefficient data. Moreover, coded data obtained by coding coefficient data associated with an image is decoded in parallel for each line of transform blocks each of which is a unit of transforming image data into coefficient data. The present disclosure is applicable to an image processing apparatus, an image coding apparatus, or an image decoding apparatus, for example.

### TECHNICAL FIELD

The present disclosure relates to an image processing apparatus and a method, and particularly to an image processing apparatus and a method capable of reducing a decrease in a degree of parallelism of coding and decoding.

### BACKGROUND ART

A tool WPP (Wavefront Parallel Processing), which parallelizes CABAC (Context-based Adaptive Binary Arithmetic Code) coding for each CTU (Coding Tree Unit) line while reducing a decrease in coding efficiency as much as possible, has conventionally been introduced to HEVC (High Efficiency Video Coding) (e.g., see NPL 1).

Moreover, there has been proposed a method which pipelines respective processes such as coding (decoding), transform and quantization (inverse quantization and inverse transform), deblocking (de-blocking), and SAO (Sample Adaptive Offset) in processing units of 64×64 block for luminance components and 32×32 block for chrominance components (e.g., see NPL 2 and NPL 3).

### CITATION LIST

### Non Patent Literature

### [NPL 1]

Telecommunication Standardization Sector of ITU

(International Telecommunication Union), “High efficiency video coding”, H.265, 12/2016

### [NPL 2]

Tzu-Der Chuang, Ching-Yeh Chen, Yu-Wen Huang, Shaw-Min Lei, “CE1-related: Separate tree partitioning at 64×64—luma/32×32—chroma unit level”, JVET-K0230-v3, Joint Video Experts Team (JVET) of ITU-T SG 16 WP 3 and ISO/IEC JTC 1/SC 29/WG 11 11th Meeting: Ljubljana, SI, 10-18 Jul. 2018

### [NPL 3]

Chia-Ming Tsai, Chih-Wei Hsu, Tzu-Der Chuang, Ching-Yeh Chen, Yu-Wen Huang, Shaw-Min Lei, “CE1. 2. 1: Constraint for binary and ternary partitions”, JVET-L0081-v2, Joint Video Experts Team (JVET) of ITU-T SG 16 WP 3 and ISO/IEC JTC 1/SC 29/WG 11 12th Meeting: Macao, CN, 3-12 Oct. 2018

### SUMMARY

### Technical Problems

However, with a recent increase in image resolution, handling a larger CTU size has been demanded also in the field of coding. For example, the maximum CTU size is 64×64 for HEVC described in NPL 1 but is 128×128 for the methods described in NPL 2 and NPL 3.

In WPP performed for the same image (i.e., for the same resolution), the number of CTU lines of one frame decreases as the CTU size increase as described above. In this case, the degree of parallelism of coding and decoding (i.e., the number of CTUs concurrently processed) may decrease, and a delay of parallel pipelines may increase (i.e., the processing time may increase).

Moreover, according to the methods described in NPL 2 and NPL 3, pipelining of respective processes such as coding (decoding), transform and quantization (inverse quantization and inverse transform), deblocking, and SAO is achievable by designating a smaller-size block as a unit of processing, but parallel-pipelining of coding and decoding for each of these blocks is difficult to achieve.

The present disclosure has been developed in consideration of the abovementioned circumstances, and achieves reduction of a decrease in a degree of parallelism of coding and decoding.

### Solution to Problems

An image processing apparatus according to an aspect of the present technology is directed to an image processing apparatus including a coding section that codes coefficient data associated with an image, in parallel for each of lines of transform blocks each of which is a unit transforming image data into coefficient data.

An image processing method according to an aspect of the present technology is directed to an image processing method that codes coefficient data associated with an image, in parallel for each of lines of transform blocks each of which is a unit transforming image data into coefficient data.

An image processing apparatus according to another aspect of the present technology is directed to an image processing apparatus including a decoding section that decodes coded data that has been obtained by coding coefficient data associated with an image, in parallel for each line of transform blocks each of which is a unit of transforming image data into coefficient data.

An image processing method according to another aspect of the present technology is directed to an image processing method that decodes coded data, that has been obtained by coding coefficient data associated with an image, in parallel for each line of transform blocks each of which is a unit of transforming image data into coefficient data.

According to the image processing apparatus and the method of the one aspect of the present technology, coefficient data associated with an image is coded, in parallel for each of lines of transform blocks each of which is a unit transforming image data into coefficient data.

According to the image processing apparatus and the method of the other aspect of the present technology, coded data obtained by coding coefficient data associated with an image is decoded in parallel for each line of transform blocks each of which is a unit of transforming image data into coefficient data.

### BRIEF DESCRIPTION OF DRAWINGS

FIG. 1 is a diagram explaining an example of WPP.

FIG. 2 is a diagram explaining an example of a relation between a degree of parallelism and a block size.

FIG. 3 is a diagram explaining an example of VPDUs.

FIG. 4 is a diagram explaining an example of pipelining using VPDUs.

FIG. 5 is a diagram explaining a method for parallel pipelining of coding and decoding.

FIG. 6 is a diagram explaining an example of parallelization for each VPDU line.

FIG. 7 is a diagram explaining an example of processing timing of each thread.

FIG. 8 is a diagram explaining a comparative example of parallelization for each CTU line and parallelization for each VPDU line.

FIG. 9 is a diagram explaining an example of parallelization for each CTU line.

FIG. 10 is a diagram explaining an example of parallelization for each VPDU line.

FIG. 11 is a diagram explaining an example of a reference limit of intra prediction.

FIG. 12 depicts diagrams explaining an example of a reference limit of intra prediction.

FIG. 13 depicts diagrams explaining an example of a reference limit of intra prediction.

FIG. 14 depicts diagrams explaining an example of a reference limit of inter prediction.

FIG. 15 depicts diagrams explaining an example of a reference limit of inter prediction.

FIG. 16 is a diagram explaining an example of a reference limit of inter prediction.

FIG. 17 depicts diagrams explaining an example of a reference limit of inter prediction.

FIG. 18 is a block diagram depicting a main configuration example of an image coding apparatus.

FIG. 19 is a flowchart explaining an example of a flow of an image coding process.

FIG. 20 is a flowchart explaining an example of a flow of a prediction process.

FIG. 21 is a flowchart explaining an example of a flow of a coding process.

FIG. 22 is a flowchart explaining an example of a flow of a VPDU process.

FIG. 23 is a flowchart explaining an example of a flow of a VPDU coding process.

FIG. 24 is a flowchart explaining an example of a flow of a VPDU process.

FIG. 25 is a block diagram depicting a main configuration example of an image decoding apparatus.

FIG. 26 is a flowchart explaining an example of a flow of an image decoding process.

FIG. 27 is a flowchart explaining an example of a flow of a decoding process.

FIG. 28 is a flowchart explaining an example of a flow of a VPDU process.

FIG. 29 is a flowchart explaining an example of a flow of a VPDU decoding process.

FIG. 30 is a flowchart explaining an example of a flow of a VPDU process.

FIG. 31 is a flowchart explaining an example of a flow of a VPDU process.

FIG. 32 is a flowchart explaining the example of the flow of the VPDU process and continuing from FIG. 31.

FIG. 33 is a diagram explaining an example of parallelization for each VPDU line.

FIG. 34 is a diagram explaining an example of processing timing of each thread.

FIG. 35 is a flowchart explaining an example of a flow of a prediction process.

FIG. 36 is a flowchart explaining an example of a flow of a VPDU process.

FIG. 37 is a flowchart explaining an example of a flow of a VPDU process.

FIG. 38 is a flowchart explaining an example of a flow of a VPDU process.

FIG. 39 is a flowchart explaining the example of the flow of the VPDU process and continuing from FIG. 38.

FIG. 40 is a block diagram depicting a main configuration example of a computer.

### DESCRIPTION OF EMBODIMENTS

Modes for carrying out the present disclosure (hereinafter referred to as embodiments) will be hereinafter described. Note that the description will be presented in the following order.

1. Literature and the like for supporting technical contents and technical terms

2. WPP, VPDU

3. Concept

4. Method 1

5. First embodiment (image coding apparatus, image decoding apparatus)

6. Method 2

7. Second embodiment (image coding apparatus, image decoding apparatus)

8. Supplementary notes

### <1. Literature and the Like for Supporting Technical Contents and Technical Terms>

The scope disclosed in the present technology includes not only contents described in examples, but also contents described in the following pieces of NPL known at the time of filing.

NPL 1: (described above)

NPL 2: (described above)

NPL 3: (described above)

NPL 4: Telecommunication Standardization Sector of ITU (International Telecommunication Union), “Advanced video coding for generic audiovisual services”, H. 264, 04/2017

NPL 5: Jianle Chen, Elena Alshina, Gary J. Sullivan, Jens-Rainer, Jill Boyce, “Algorithm Description of Joint Exploration Test Model 4”, JVET-G1001_v1, Joint Video Exploration Team (JVET) of ITU-T SG 16 WP 3 and ISO/IEC JTC 1/SC 29/WG 11 7th Meeting: Torino, IT, 13-21 Jul. 2017

NPL 6: Benjamin Bross, Jianle Chen, Shan Liu, “Versatile Video Coding (Draft 2)”, JVET-K1001-v7, Joint Video Experts Team (JVET) of ITU-T SG 16 WP 3 and ISO/IEC JTC 1/SC 29/WG 11 11th Meeting: Ljubljana, SI 10-18 Jul. 2018

Accordingly, contents described in the above non-patent literature are also grounds on the basis of which support requirements are determined. For example, it is assumed that Quad-Tree Block Structure described in NPL 1, and QTBT (Quad Tree Plus Binary Tree) Block Structure described in NPL 5 fall within the scope disclosed in the present technology, and meet support requirements of the claims even in a case where these are not directly described in examples. Moreover, it is assumed, for example, that technical terms such as parsing, syntax, and semantics similarly fall within the scope disclosed in the present technology, and meet support requirements of the claims even in a case where these are not directly described in examples.

Furthermore, a “block” (not a block indicating a processing section) used as a term for explaining a partial region or a processing unit of an image (picture) in the present description represents any partial region within the picture, and does not impose limitations on a size, a shape, a property, or the like of the partial region unless otherwise specified. For example, it is assumed that the “block” includes any partial region (processing unit), such as a TB (Transform Block), a TU (Transform Unit), a PB (Prediction Block), a PU (Prediction Unit), an SCU (Smallest Coding Unit), a CU (Coding Unit), an LCU (Largest Coding Unit), a CTB (Coding Tree Block), a CTU (Coding Tree Unit), a transform block, a sub block, a macro block, a tile, and a slice described in above NPL 1 to NPL 6.

Moreover, the block size of the block described above may be designated not only directly but also indirectly. For example, the block size may be designated using identification information for identifying the size. In addition, for example, the block size may be designated on the basis of a ratio of the block size to a block size of a reference block (e.g., LCU and SCU), or a difference between the block size of the block size of the reference block. For example, information transferred as a syntax element or the like to designate the block size may be information indirectly designating the size as described above. In such a manner, reduction of an information volume, and improvement of coding efficiency are achievable depending on circumstances. Moreover, designation of the block size includes designation of a range of the block size (e.g., designation of an allowable range of the block size).

Furthermore, in the present description, coding includes not only an overall process for transforming an image into a bit stream, but also a part of this process. For example, coding includes not only a process containing a prediction process, orthogonal transform, quantization, arithmetic coding, and the like, but also a process collectively referring to quantization and arithmetic coding, a process containing a prediction process, quantization, and arithmetic coding, and other processes. Similarly, decoding includes not only an overall process for transforming a bit stream into an image, but also a part of this process. For example, decoding includes not only a process containing inverse arithmetic decoding, inverse quantization, inverse orthogonal transform, a prediction process, and the like, but also a process containing inverse arithmetic decoding and inverse quantization, a process containing inverse arithmetic decoding, inverse quantization, and a prediction process, and other processes.

### <2. Wpp, Vpdu>

### <WPP>

For example, as described in NPL 1, a tool WPP (Wavefront Parallel Processing), which parallelizes CABAC (Context-based Adaptive Binary Arithmetic Code) coding for each CTU (Coding Tree Unit) line while reducing a decrease in coding efficiency as much as possible, has conventionally been introduced to HEVC (High Efficiency Video Coding).

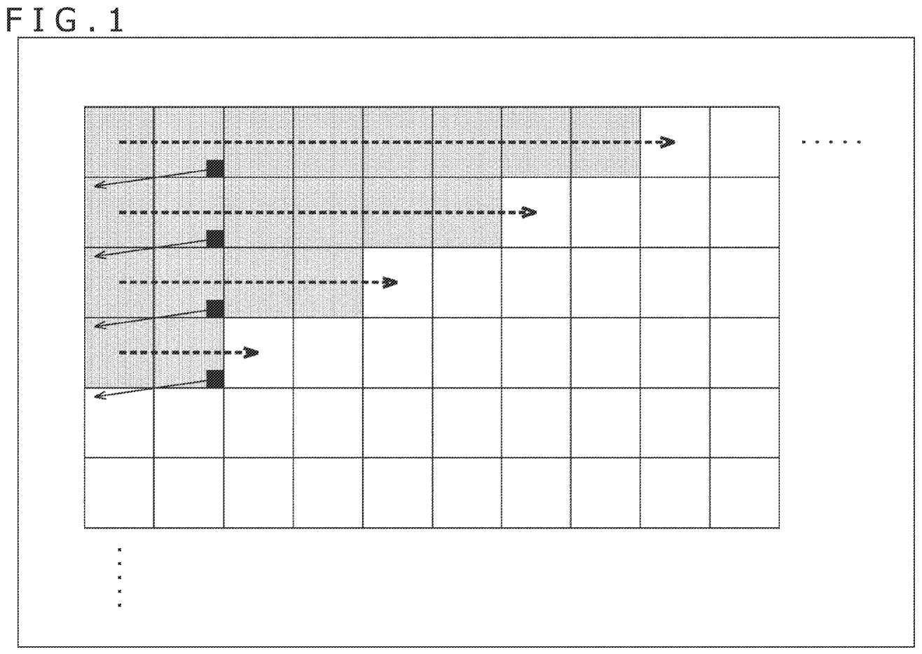

For example, FIG. 1 depicts a part of an image corresponding to a coding target, where each square represents a CTU. The CTUs are arranged in the form of matrix as depicted in FIG. 1. In a case where WPP is applied, coding and decoding (entropy-coding and entropy-decoding) are parallelized for each row of the CTUs (also referred to as a CTU line) (That is, processing for each CTU line is executed in parallel). In each of the CTU lines, processing (entropy coding and entropy decoding) is performed for the CTUs one by one from the left end CTU as indicated by a dotted arrow in the figure.

Each of the CTUs is processed using an occurrence probability which has been derived at the time of processing of a CTU one CTU before as context. However, the CTU at the left end of the uppermost CTU line in the image is processed using an initial value of context. Moreover, each of the CTUs at the left ends of the second uppermost CTU line and the CTU lines below the second uppermost CTU line is processed by using, as context, an occurrence probability (also called a learned occurrence probability) derived at the time of processing of the second CTU in the CTU line located one line above the processing target CTU line (also referred to as a current CTU line) as indicated by black squares and arrows in FIG. 1. In other words, as indicated by gray squares in FIG. 1, each of the CTU lines is processed with a delay of 2 CTUs from the CTU line located one line above.

In such a manner, parallel processing is achievable for the respective CTU lines (That is, the respective CTU lines are processed such that at least the processing timing overlaps in part (a time at which CTUs in a plurality of CTU lines are processed is present) even with deviation of timing). Accordingly, coding and decoding are achievable at a higher speed than in a case of processing for all CTUs of the image in series.

### <Reduction of Degree of Parallelism>

However, with a recent increase in image resolution, handling a larger CTU size has been demanded also in the field of coding. For example, the maximum CTU size is 64×64 for HEVC described in NPL 1 but is 128×128 for the methods of NPL 2 and NPL 3.

In WPP performed for the same image (i.e., for the same resolution), the number of CTU lines of one frame decreases as the CTU size increases as described above. In this case, the degree of parallelism of coding and decoding (i.e., the number of CTUs concurrently processed) may decrease, and a delay of parallel pipelines may increase (i.e., the processing time may increase).

For example, suppose that the processing time is equalized for all of the respective CTUs. A maximum degree of parallelism indicating the maximum number of CTUs processed at the same time is defined as following Equation (1). In Equation (1), CTUw represents the number of CTUs located in the horizontal direction and present in an image corresponding to a processing target. Moreover, CTUh represents the number of CTUs located in the vertical direction and present in the image corresponding to the processing target. Furthermore, function ceil represents rounding up after the decimal point.

[Math.1]

Maximum degree of parallelism=min(cell(CTUw/2),CTUh) (1)

In addition, an average degree of parallelism representing an average number of CTUs processed at the same time is defined as following Equation (2). In Equation (2), p (x, y) represents a degree of parallelism at the time of processing of CTU(x, y). Moreover, CTUw and CTUh are defined similarly to those of Equation (1).

[Math.2]

Average degree of parallelism=Σp(x,y)/(CTUw CTUh) (2)

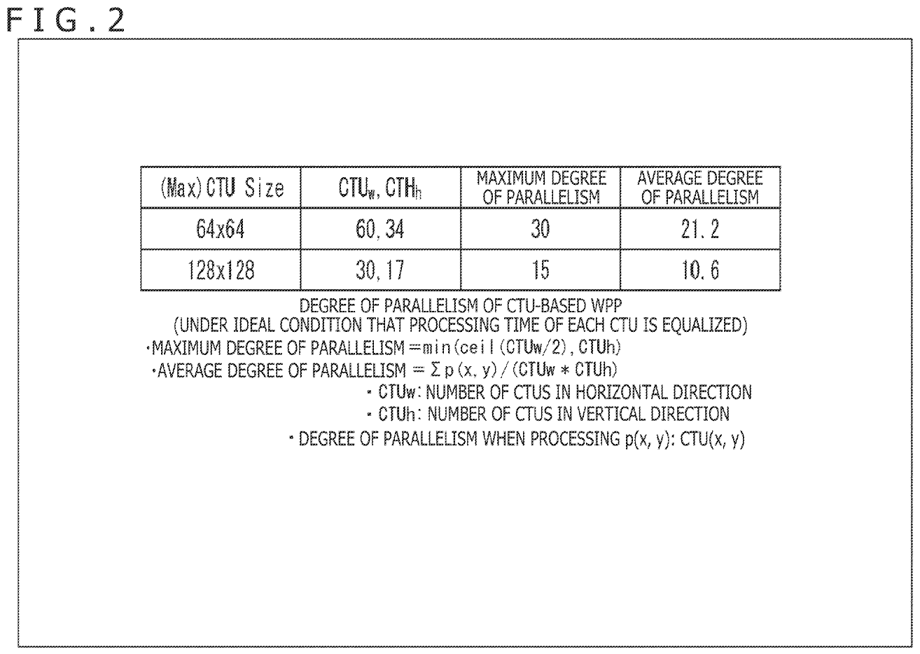

For example, a table in FIG. 2 represents a result of comparison between the maximum CTU size of 64×64 and the maximum CTU size of 128×128 in processing of WPP for a 4 k image (image with resolution of 3840×2160) in view of the maximum degree of parallelism and the average degree of parallelism.

As represented in the table in FIG. 2, CTUw and CTUh are 60 and 34, respectively, in the case of the maximum CTU size of 64×64. Accordingly, on the basis of Equation (1) and Equation (2) described above, the maximum degree of parallelism of 30, and the average degree of parallelism of 21.2 are obtained. On the other hand, in the case of the maximum CTU size of 128×128, CTUw and CTUh are 30 and 17, respectively. Accordingly, on the basis of Equation (1) and Equation (2) described above, the maximum degree of parallelism of 15, and the average degree of parallelism of 10.6 are obtained. In this case, the degree of parallelism (maximum degree of parallelism and average degree of parallelism) decreases by half. Accordingly, in the case of the maximum CTU size of 128×128, a delay of parallel pipelines may increase, and thus a processing time may become longer in comparison with the maximum CTU size of 64×64 as described above.

Moreover, when variations in processing loads of the respective CTUs processed in parallel are produced, a waiting time may be required to equalize processing timing of the respective CTU lines. A grain size of parallelism increases as the CTU size increases. In this case, distribution of variations of the CTU processing loads becomes more difficult to achieve. Specifically, a waiting time produced by these variations may increase as the CTU size increases. The increase in the waiting time may further reduce the actual degree of parallelism, and thus may further increase the processing time.

### <VPDU>

Moreover, as described in NPL 2 and NPL 3, there has been proposed a method which pipelines respective processes such as coding (decoding), transform and quantization (inverse quantization and inverse transform), deblocking (de-blocking), and SAO (Sample Adaptive Offset) in processing units of 64×64 block for luminance components and 32×32 block for chrominance components.

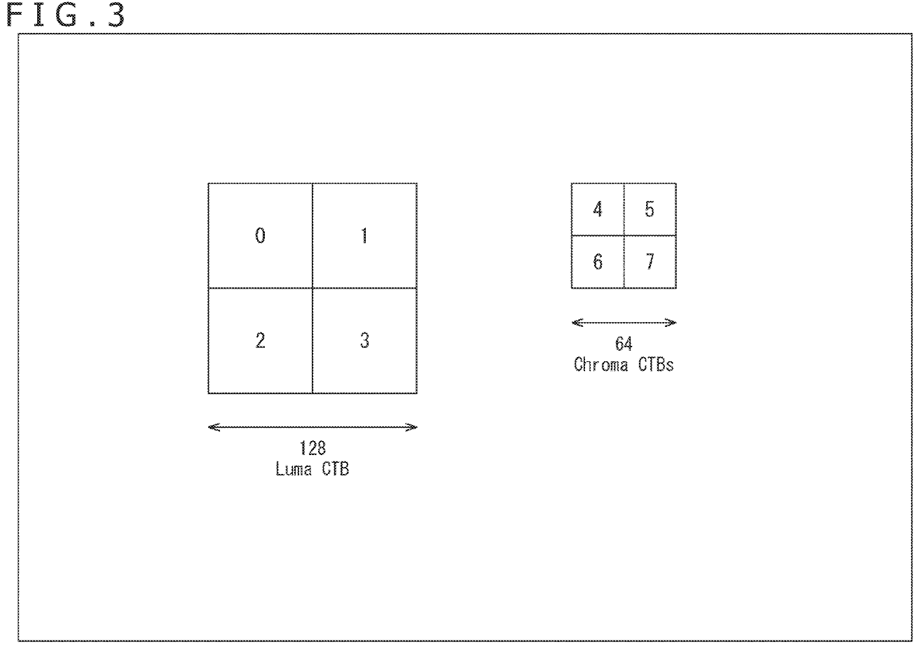

For example, as depicted in FIG. 3, it is assumed that a processing unit of luminance components is a block of 64×64 (also referred to as a VPDU (Virtual pipeline data Unit)) obtained by dividing a CTB of 128×128 by four (by vertically two and horizontally two). Moreover, it is assumed that a processing unit of chrominance components is a block of 32×32 (also referred to as a VPDU) obtained by dividing a CTB of 64×64 by four (vertically two and horizontally two).

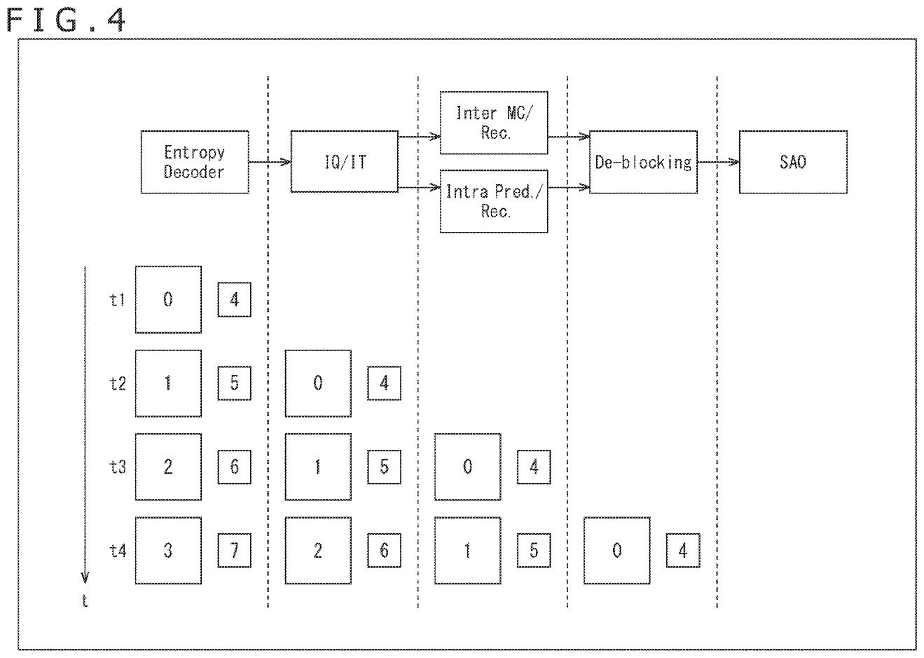

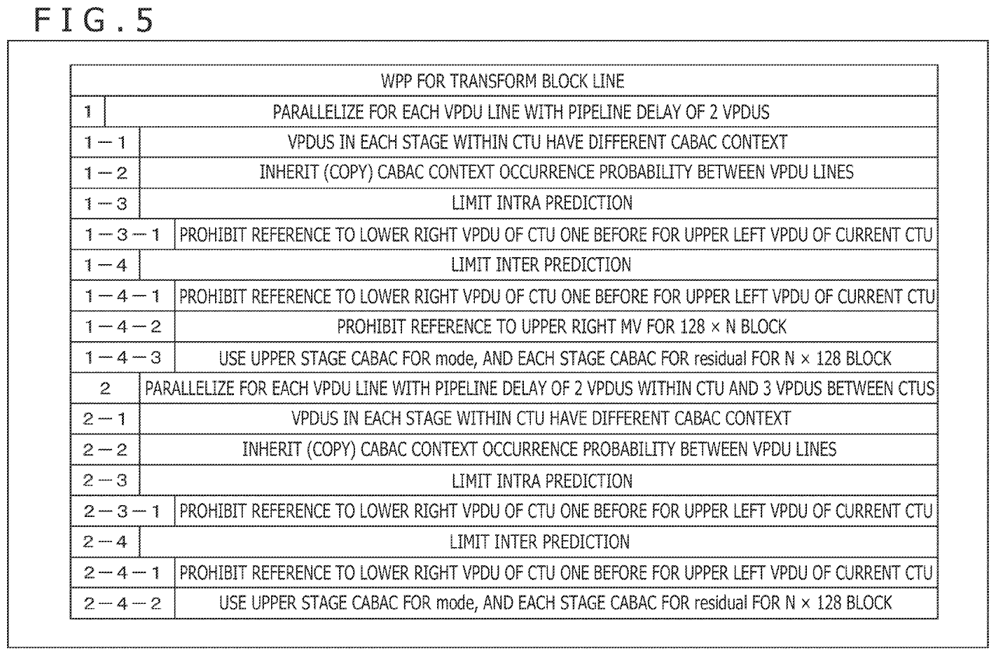

As depicted in an example in FIG. 4, respective processes such as coding (decoding), transform and quantization (inverse quantization and inverse transform), deblocking, and SAO are pipelined in processing units of VPDU described above. In such a manner, an increase in the entire processing time can be reduced.

However, parallel pipelining for each block of coding and decoding is difficult to achieve by this method.

### <3. Concept>

<WPP for each transform block line>

Accordingly, as presented in a first stage from the upper side of the table in FIG. 5, WPP is achieved for each transform block line. A transform block is a processing unit of a transform process such as an orthogonal transform for image data, while a transform block line represents each row (line) of transform blocks arranged in the form of a matrix. Therefore, WPP is achieved for each line of blocks each having a size smaller than that of a CTU.

For example, coefficient data associated with an image is coded in parallel for each line of transform blocks each of which is a unit of transforming image data into coefficient data. In addition, for example, an image processing apparatus includes a coding section which codes coefficient data associated with an image in parallel for each line of transform blocks each of which is a unit of transforming image data into coefficient data. In such a manner, parallelization of processes is achievable for each line of transform blocks each smaller than a CTU. Accordingly, reduction of a decrease in a degree of parallelism of coding, and therefore reduction of an increase in a processing time of coding are achievable.

Moreover, for example, coded data obtained by coding coefficient data associated with an image is decoded in parallel for each line of transform blocks each of which is a unit of transforming image data into coefficient data. In addition, for example, an image processing apparatus includes a decoding section which decodes coded data obtained by coding coefficient data associated with an image in parallel for each line of transform blocks each of which is a unit of transforming image data into coefficient data. In such a manner, parallelization of processes is achievable for each line of transform blocks each smaller than a CTU. Accordingly, reduction of a decrease in a degree of parallelism of decoding, therefore reduction of an increase in a processing time of decoding are achievable.

Furthermore, as method 1 presented in the second stage from the upper side of the table in FIG. 5, coding and decoding may be parallelized for each line of VPDU (Virtual pipeline data Unit) (also referred to as a VPDU line) (That is, WPP for each VPDU line may be performed). In this case, a delay between respective lines (pipeline delay) may be set to 2 VPDUs.

In addition, as method 1-1 presented in the third stage from the upper side of the table in FIG. 5, VPDUs in respective stages within a CTU may have CABAC context different for each. Besides, as method 1-2 presented in the fourth stage from the upper side of the table in FIG. 5, an occurrence probability of CABAC context may be inherited (copied) between VPDU lines.

For example, at the time of coding, each line of transform blocks of coefficient data associated with an image may be coded sequentially transform block by transform block from the left transform block. Moreover, each of the transform blocks may be entropy-coded using an occurrence probability derived by entropy-coding one coding before. Furthermore, the leftmost transform block in the uppermost transform block line in the image may be entropy-coded using an initial occurrence probability value, and each of the leftmost transform blocks in the second uppermost transform block line and the transform block lines below the second uppermost transform block line in the image may be entropy-coded using an occurrence probability derived by entropy-coding of the second leftmost transform block in the transform block line located one line above. In such a manner, parallelization similar to that of WPP for CTU lines performed by HEVC or the like is achievable for each transform block line.

For example, at the time of decoding, coded data of each line of transform blocks of coefficient data associated with an image may be decoded sequentially transform block by transform block from the left transform block. Moreover, each of the transform blocks may be entropy-decoded using an occurrence probability derived by entropy-decoding one decoding before. Furthermore, coded data of the leftmost transform block in the uppermost transform block line in the image may be entropy-decoded using an initial occurrence probability value, and each of the leftmost transform blocks in the second uppermost transform block line and the transform block lines below the second uppermost transform block line in the image may be entropy-decoded using an occurrence probability derived by entropy-decoding coded data of the second leftmost transform block in the transform block line located one line above. In such a manner, parallelization similar to that of WPP for CTU lines performed by HEVC or the like is achievable for each transform block line.

Note that each of the transform blocks in this case may be any unit as long as the unit constitutes a transmission processing unit, such as a VPDU as described above.

Furthermore, as method 1-3 presented in the fifth stage from the upper side of the table in FIG. 5, a limitation may be imposed on intra prediction. For example, as method 1-3-1 presented in the sixth stage from the upper side of the table in FIG. 5, for an upper left VPDU of a processing target CTU (also referred to as a current CTU), reference to a lower right VPDU of a CTU located one CTU before may be prohibited (unavailable).

For example, for intra prediction of an upper left transform block of a coding tree unit in the highest order of a coding block of a tree structure, reference to a lower right transform block of a coding tree unit coded one unit before may be made unavailable. In such a manner, a dependence relation between transform block lines, which is a relation established by the reference in the intra prediction, can be reduced. Accordingly, reduction of an increase in the waiting time is achievable.

Furthermore, as method 1-4 presented in the seventh stage from the upper side of the table in FIG. 5, a limitation may be imposed on inter prediction. For example, as method 1-4-1 presented in the eighth stage from the upper side of the table in FIG. 5, for inter prediction of a processing target which is an upper left VPDU of a current CTU (current prediction block), reference to a lower right VPDU of a CTU located one CTU before may be prohibited (unavailable). Accordingly, a limitation similar to that of method 1-3-1 described above (i.e., limitation to intra prediction) may be imposed.

For example, for inter prediction of an upper left transform block of a coding tree unit in the highest order of a coding block of a tree structure, reference to a motion vector of a lower right transform block of a coding tree unit coded one unit before may be made unavailable. In such a manner, a dependence relation between transform block lines, which is a relation established by the reference in the inter prediction, can be reduced. Accordingly, reduction of an increase in the waiting time is achievable.

Moreover, as method 1-4-2 presented in the ninth stage from the upper side of the table in FIG. 5, reference to an upper right block may be prohibited (unavailable) for inter prediction for a current prediction block having a block size of 128×N.

For example, for inter prediction of a prediction block which is a processing unit of inter prediction and has the same horizontal length as that of a coding tree unit in the highest order of a coding block of a tree structure, reference to a motion vector of an upper right transform block may be made unavailable. In such a manner, a dependence relation between transform block lines, which is a relation established by the reference in the inter prediction, can be reduced. Accordingly, reduction of an increase in the waiting time is achievable.

Moreover, as method 1-4-3 presented in the tenth stage from the upper side of the table in FIG. 5, in a case where a prediction block for which inter prediction is to be performed has a block size of N×128, mode information indicating a mode of the inter prediction may be created using CABAC of a transform block in an upper stage, while coefficient data (residual) associated with residual data between an image and a prediction image may be generated using CABAC of transform blocks in respective stages.

For example, for prediction blocks each having the same horizontal length as that of a coding tree unit in the highest order of a coding block of a tree structure, mode information indicating a mode of inter prediction may be coded for each of the prediction blocks, and residual data between an image and a prediction image may be coded for each of transform blocks contained in the corresponding prediction block. In such a manner, the prediction block having the block size of N×128 for inter prediction can be parallelized and processed for each transform block line.

Furthermore, as method 2 presented in the eleventh stage from the upper side of the table in FIG. 5, coding and decoding may be parallelized for each VPDU line (That is, WPP for each VPDU line may be performed). In this case, a delay between respective lines (pipeline delay) may be set to 2 VPDUs within a CTU and may be set to 3 VPDUs between CTUs.

For example, at the time of coding, the leftmost transform block in the uppermost transform block line in the image may be entropy-coded using an initial occurrence probability value. Each of the leftmost transform blocks in the transform block lines each belonging to a coding tree unit in the highest order of a coding block having the same tree structure as that of the transform blocks located one line above, and in the second uppermost transform block line and the transform block lines below the second uppermost transform block line in the image may be entropy-coded using an occurrence probability derived by entropy-coding of the second leftmost transform block in the transform block line located one line above. Each of the leftmost transform blocks in the transform block lines belonging to a coding tree unit different from that of the transform blocks located one line above, and in the second uppermost transform block line and the transform block lines below the second uppermost transform block line in the image may be entropy-coded using an occurrence probability derived by entropy-coding of the third leftmost transform block in the transform block line located one line above.

Similarly, at the time of decoding, coded data of the leftmost transform block in the uppermost transform block line in the image may be entropy-decoded using an initial occurrence probability value. Each of coded data of the leftmost transform blocks in the transform block lines each belonging to a coding tree unit in the highest order of a coding block having the same tree structure as that of the transform blocks located one line above, and in the second uppermost transform block line and the transform block lines below the second uppermost transform block line in the image may be entropy-decoded using an occurrence probability derived by entropy-decoding of coded data of the second leftmost transform block in the transform block line located one line above. Each of coded data of the leftmost transform blocks in the transform block lines belonging to a coding tree unit different from that of the transform blocks located one line above, and in the second uppermost transform block line and the transform block lines below the second uppermost transform block line in the image may be entropy-decoded using an occurrence probability derived by entropy-decoding of coded data of the third leftmost transform block in the transform block line located one line above.

In such a manner, a dependence relation between transform block lines, which is a relation established by the reference of the inter prediction, can be reduced without using the limitation to inter prediction of method 1-4-2. Accordingly, reduction of an increase in the waiting time is achievable.

Note that VPDUs in respective stages within a CTU may have CABAC context different for each similarly to method 1-1 (method 2-1 described in the twelfth stage from the upper side of the table in FIG. 5). Besides, similarly to method 1-2, an occurrence probability of CABAC context may be inherited (copied) between VPDU lines (method 2-2 described in the thirteenth stage from the upper side of the table in FIG. 5).

Furthermore, similarly to method 1-3, a limitation may be imposed on intra prediction (method 2-3 described in the fourteenth stage from the upper side of the table in FIG. 5). For example, similarly to method 1-3-1, reference to a lower right VPDU of a CTU one CTU before may be prohibited (unavailable) for an upper left VPDU of a processing target CTU (also referred to as a current CTU) (method 2-3-1 presented in the fifteenth stage from the upper side of the table in FIG. 5).

In addition, similarly to method 1-4, a limitation may be imposed on inter prediction (method 2-4 described in the sixteenth stage from the upper side of the table in FIG. 5). For example, similarly to method 1-4-1, reference to a lower right VPDU of a CTU one CTU before may be prohibited (unavailable) for an upper left VPDU of a current CTU (method 2-4-1 presented in the seventeenth stage from the upper side of the table in FIG. 5). Accordingly, a limitation similar to that of method 2-3-1 described above (i.e., limitation to intra prediction) may be imposed.

Moreover, similarly to method 1-4-3, in a case where a current CTU has a block size of N×128, mode information indicating a mode of the inter prediction may be created using CABAC of a transform block in an upper stage, while coefficient data (residual) associated with residual data between an image and a prediction image may be generated using CABAC of transform blocks in respective stages (method 2-4-2 presented in the lowermost stage in the table of FIG. 5).

### <4. Method 1>

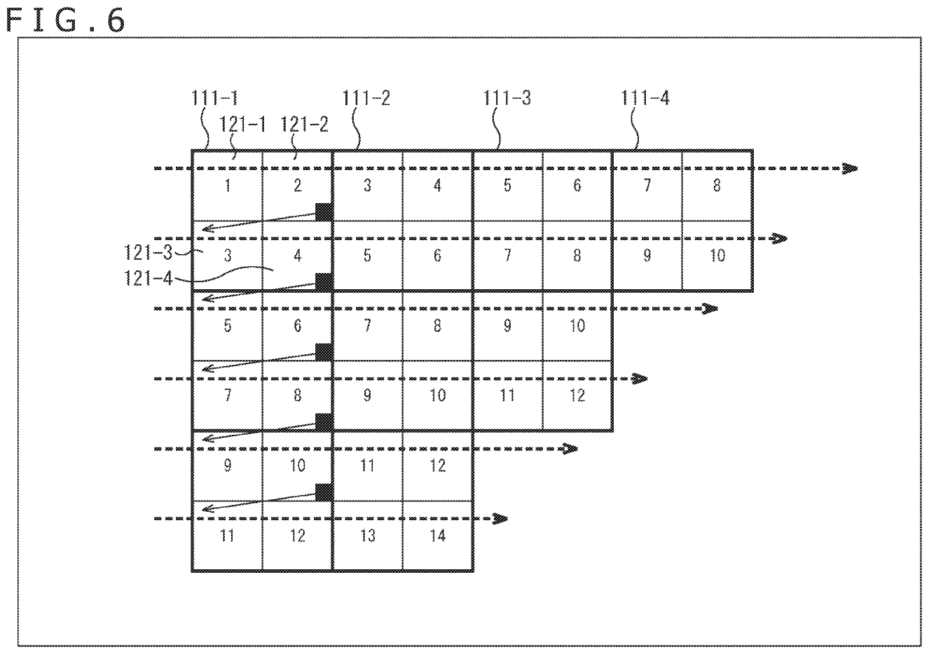

“Method 1” described above will be subsequently described in detail. FIG. 6 depicts a part of an image as a coding target. The image is divided into CTUs 111 in the highest order in a coding block of a tree structure. In FIG. 6, respective regions each surrounded by a thick-line square constitute the CTUs 111. According to WPP using HEVC, processes (entropy-coding and entropy-decoding) are parallelized for each line of the CTUs 111. The respective CTU lines are processed for each of the CTUs 111 along the CTU lines from the left to the right, such as processing in an order of CTU 111-1, CTU 111-2, CTU 111-3, and CTU 111-4.

According to method 1, each of the CTUs 111 is divided into VPDUs 121. In FIG. 6, respective regions each surrounded by a thin-line square constitute the VPDUs 121. In this example, each of the CTUs 111 is divided by four (two in each of the vertical direction and the horizontal direction). For example, the CTU 111-1 is divided into a VPDU 121-1, a VPDU 121-2, a VPDU 121-3, and a VPDU 121-4. Accordingly, two VPDU lines are formed in one CTU line. Note that the size of each of the CTUs 111 may be any size. Similarly, the size of each of the VPDUs 121 may be any size as long as this size is smaller than the size of the CTUs 111. In the present description, it is assumed that each of the CTUs has a size of 128×128, and that each of the VPDUs has a size of 64×64.

According to method 1, processes (entropy-coding and entropy-decoding) are parallelized for each line of the VPDUs 121 as indicated by dotted arrows in FIG. 6. In FIG. 6, a numeral contained in each of the VPDUs 121 indicates a processing order. Specifically, a process for each of the VPDU lines is executed with a delay of 2 VPDUs from a VPDU line located one line above.

### <4-1: Method 1-1, Method 1-2>

Entropy-coding and entropy-decoding here refer to reversible coding and reversible decoding, respectively, using an occurrence probability derived by a process one process before as context. For example, entropy-coding and entropy-decoding may be arithmetic coding and arithmetic decoding of CABAC or the like. In the present description, CABAC is assumed to be adopted.

Moreover, in method 1-1, CABAC context different for each processing of the VPDUs 121 in each of the stages within the CTU 111 is used. Moreover, in method 1-2, CABAC context is inherited (copied) between VPDU lines.

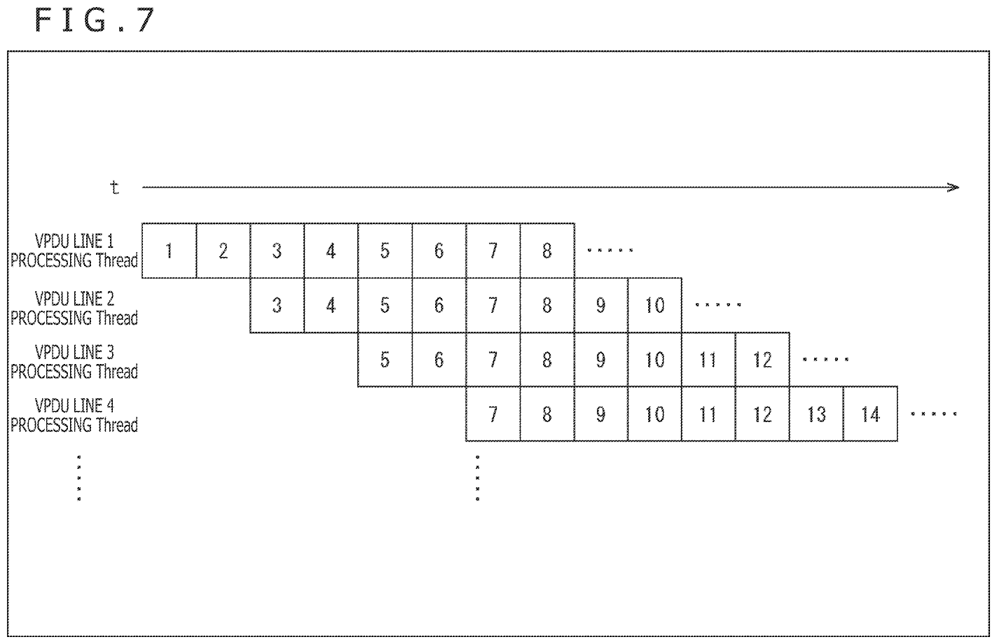

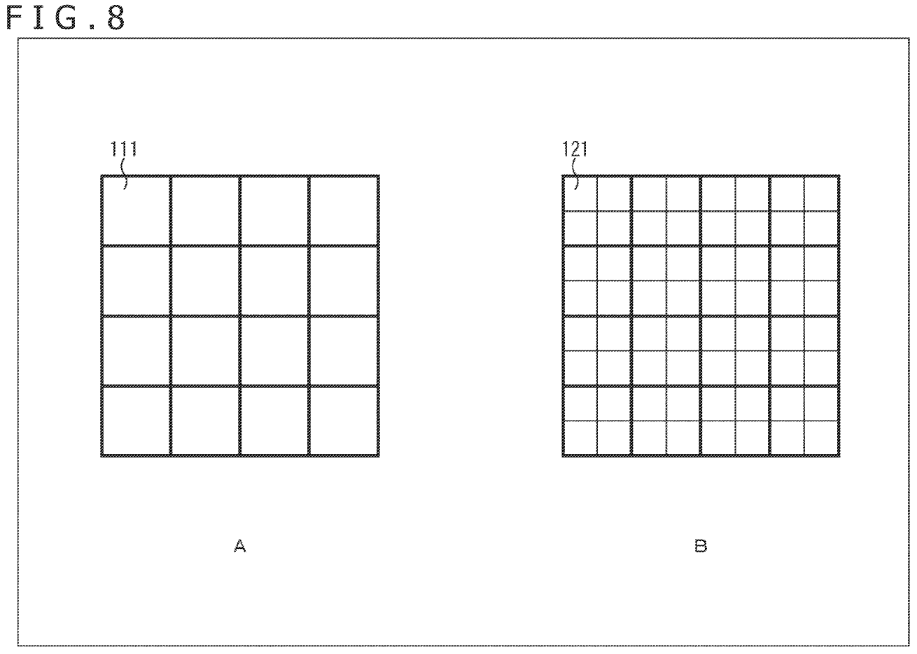

As described above, each of the VPDUs in each of the VPDU lines is processed using an occurrence probability derived at the time of VPDU processing one processing before as context. However, the VPDU at the left end of the uppermost VPDU line in the image is processed using an initial context value. Moreover, each of the VPDUs at the left ends of the second uppermost VPDU line and the VPDU lines below the second uppermost VPDU line is processed using, as context, an occurrence probability (also called a learned occurrence probability) derived at the time of processing of the second VPDU in the VPDU line located one line above the processing target VPDU line (also referred to as a current VPDU line) as indicated by a black square and an arrow in FIG. 6. Accordingly, as depicted in FIG. 7, a processing thread in each of the VPDU lines has a delay of 2 VPDUs from a processing thread in the VPDU line located one line above.

plural threads are executed concurrently with each other even with deviation of timing as described above. In such a manner, a maximum degree of parallelism of 30, and an average degree of parallelism of 21.2 are obtained in a case where a processing target is an image having 4K image size (3840×2160), for example. In this case, a decrease in a degree of parallelism of coding and decoding as a result of an increase in the CTU size can be reduced. Accordingly, reduction of an increase in a parallel pipelining delay, and therefore reduction of an increase in a processing time are achievable.

Moreover, the grain size of parallelism decreases. This decrease in the grain size can reduce an increase in processing load variations produced between the threads. This variation reduction therefore reduces an increase in processing time variations between the threads. Accordingly, reduction of an increase in the waiting time, and therefore reduction of an increase in a processing time of the entire image are achievable.

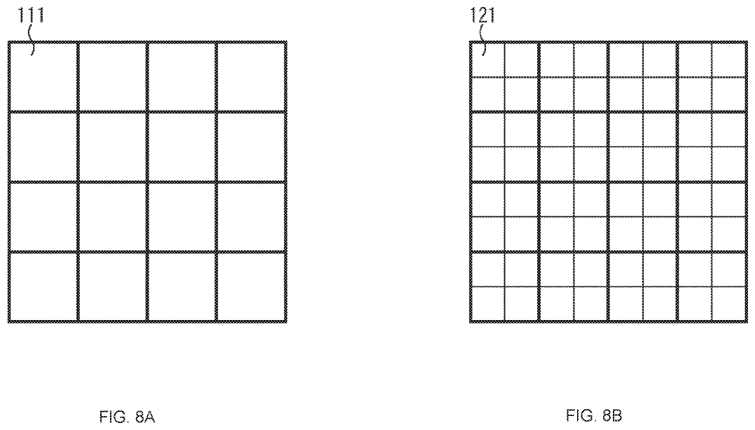

Described herein will be a comparison between WPP of CTU lines and WPP of VPDU lines. In a case of A of FIG. 8, a processing target image is divided into the 4×4, i.e., 16 CTUs 111, and processed in parallel for each of CTU lines (WPP for CTU lines). On the other hand, in a case of B of FIG. 8, each of the CTUs 111 is divided into the 2×2 VPDUs 121. Accordingly, the processing target image is divided into the 8×8, i.e., 64 VPDUs 121, and processed in parallel for each of VPDU lines (WPP for VPDU lines). Processing loads imposed on the respective CTUs are equalized. It is assumed that each of processing loads on the respective VPDUs is a quarter of the processing load on each CTU.

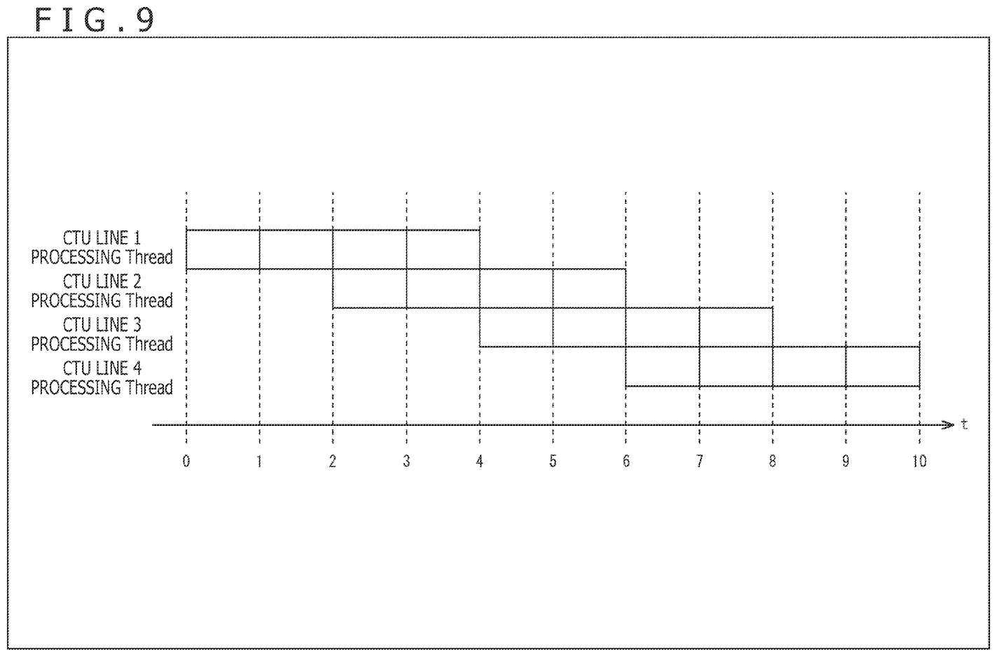

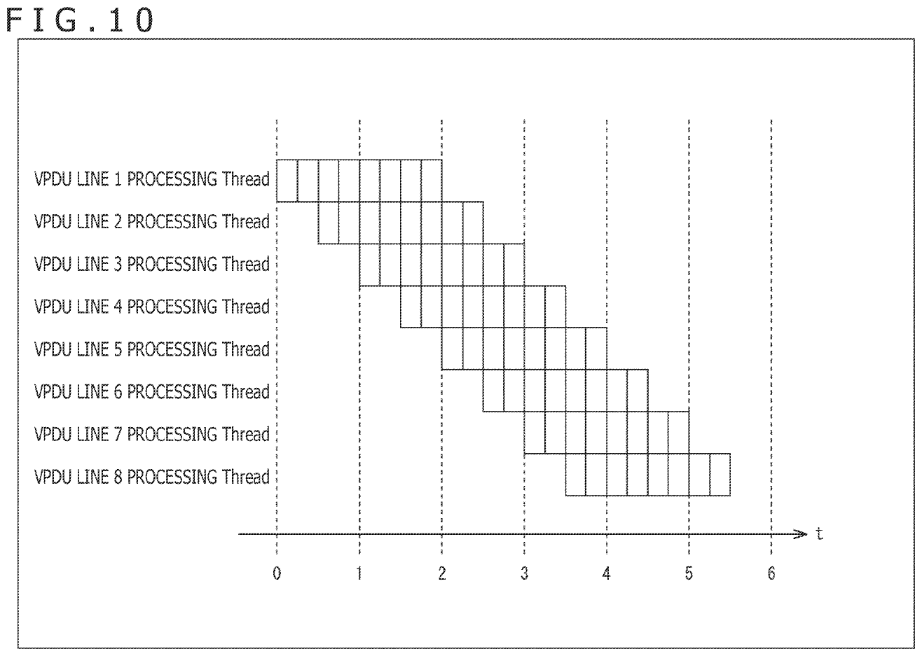

FIG. 9 depicts an example of a state of a processing time of each thread in the case of A of FIG. 8. As depicted in FIG. 9, a processing time of an entire image is 10 t in this case. FIG. 10 depicts an example of a state of a processing time of each thread in the case of B of FIG. 8. As depicted in FIG. 10, a processing time of an entire image is 5.5 t in this case.

As apparent from above, WPP for the VPDU lines more reduces a decrease in the degree of parallelism which decreases in accordance with an increase in the CTU size than WPP for the CTU lines, and therefore more reduces an increase in the processing time than WPP of the CTU lines.

In addition, in a case where the processes are parallelized for each VPDU line as described above, a limitation similar to that of VPDU pipeline processing as described in NPL 2 and NPL 3 is applied to processing of a prediction block or a transform block.

### <4-2: Method 1-3>

In method 1-3, a partial mode limitation is imposed on intra prediction. In a case where a processing target block is in an intra prediction mode, this mode is predicted with reference to an intra prediction mode of an adjacent block, and a prediction image is formed with reference of pixels of the adjacent block.

### <4-2-1: Method 1-3-1>

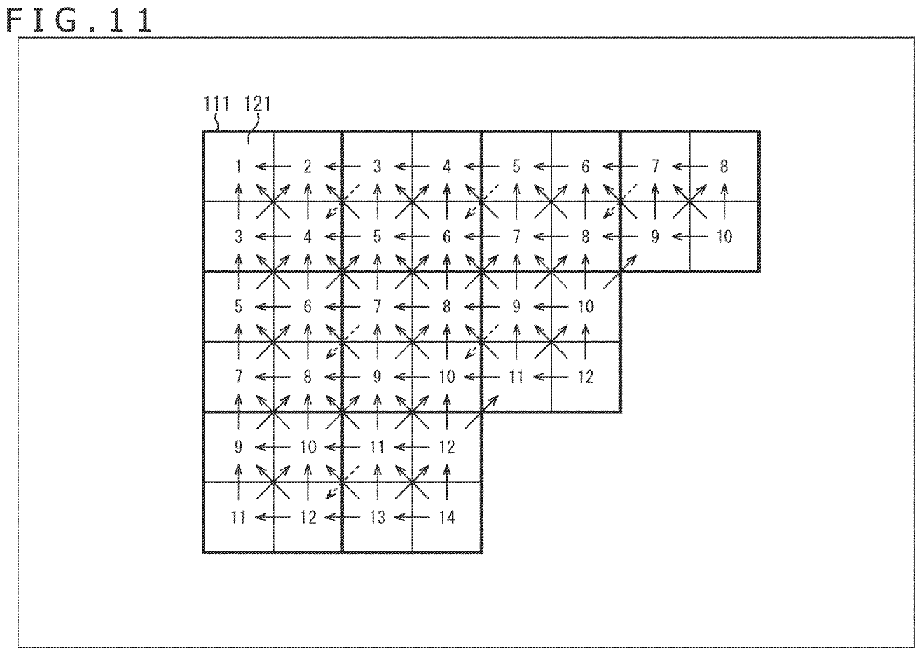

In method 1-3-1, for intra prediction of an upper left VPDU of a CTU, reference to a lower right VPDU of a CTU processed one CTU before (i.e., CTU located next to the left) is made unavailable as indicated by dotted arrows in FIG. 11. Accordingly, reference to an intra prediction mode and prediction pixels indicated by the dotted arrows in FIG. 11 is prohibited.

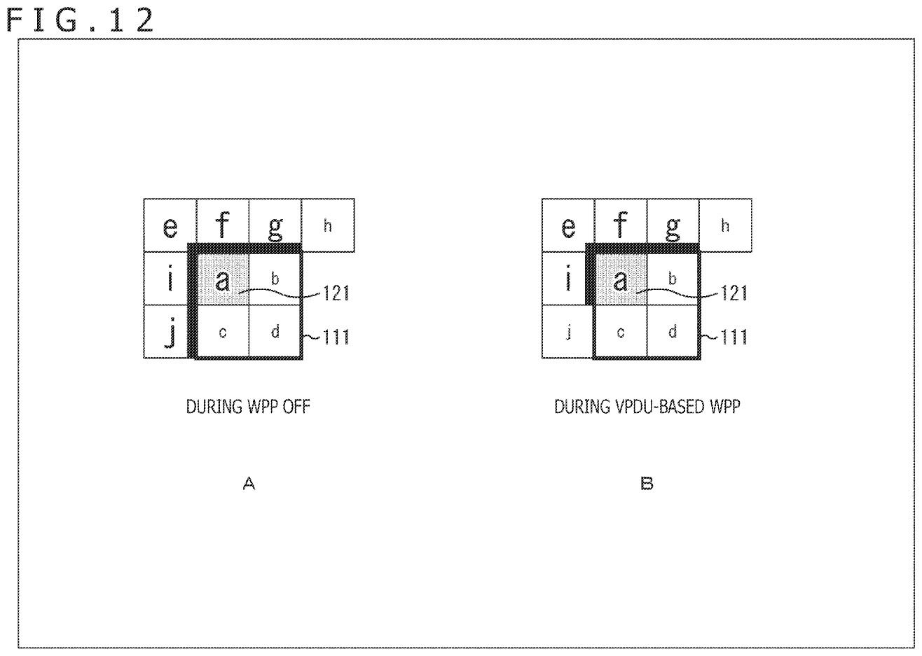

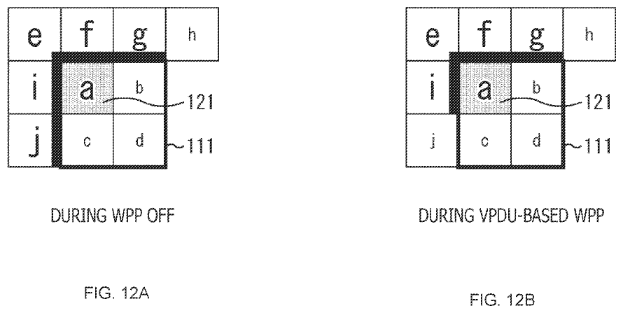

For example, in a case where coding and decoding are not parallelized (during WPP OFF), for intra prediction of a VPDU [a] which is the upper left VPDU 121 of the current CTU 111, an intra prediction mode and adjacent pixels of each of a VPDU [e], a VPDU [f], a VPDU [g], a VPDU [i], and a VPDU [j] (black band portion in the figure) are reference targets as indicated by A of FIG. 12. In this case, the block size of the intra prediction is 64×64 or smaller (VPDU 121 or smaller). Accordingly, a reference range becomes the maximum when the block size of the intra prediction is corresponding to the size of the VPDU 121.

On the other hand, according to method 1-3-1, in a case where coding and decoding are parallelized for each VPDU line as in method 1 (during VPDU-based WPP), for intra prediction of the VPDU [a] which is the upper left VPDU 121 of the CTU 111, reference to the intra prediction mode and the adjacent pixels of the VPDU [j] is prohibited (made unavailable) as indicated in B of FIG. 12.

In the case of method 1, the processes are parallelized for each VPDU line. In addition, a delay between the lines is set to 2 VPDUs. Accordingly, while processing for the VPDU [a] is allowed to be performed before processing of the VPDU [j], the processing for the VPDU [a] may be required to wait until completion of the processing for the VPDU [j] (i.e., the waiting time may increase) due to the presence of the reference relation described above.

By limiting the reference as in method 1-3-1, the above reference relation of intra prediction is not established (intra prediction of the VPDU [a] is allowed to be performed independently of the VPDU [j]). Accordingly, reduction of an increase in the waiting time is achievable.

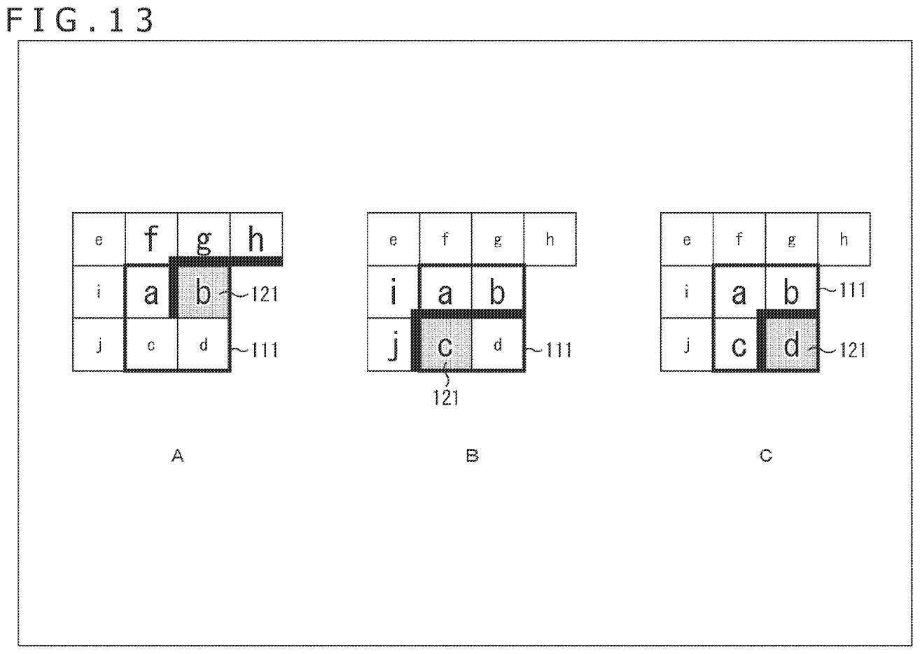

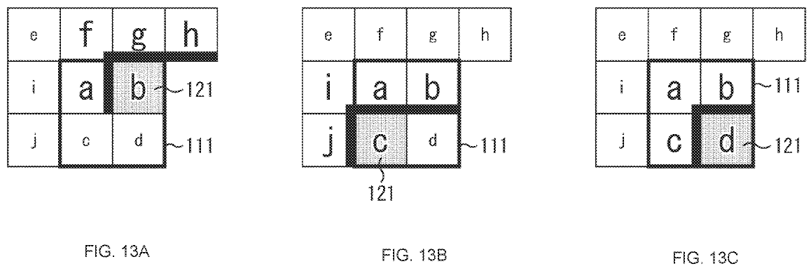

For the other VPDUs 121 of the CTU 111, reference similar to the reference during WPP off is allowed even during VPDU-based WPP. For example, for intra prediction of a VPDU [b] which is the upper right VPDU 121 of the current CTU 111, the intra prediction mode and the adjacent pixels of each of the VPDU [f], the VPDU [g], a VPDU [h], and the VPDU [a] (black band portion in the figure) are reference targets during both WPP off and VPDU-based WPP as indicated by A of FIG. 13. A VPDU [c] is processed later than the VPDU [b] in the processing order during both WPP off and VPDU-based WPP. Accordingly, reference to the VPDU [c] is not allowed.

Moreover, for example, for intra prediction of the VPDU [c] which is the lower left VPDU 121 of the current CTU 111, the intra prediction mode and the adjacent pixels of each of the VPDU [a], the VPDU [b], the VPDU [i], and the VPDU[j] (black band portion in the figure) are reference targets during both WPP off and VPDU-based WPP as indicated by B of FIG. 13. A VPDU located on the lower left of the VPDU [c] is processed later than the current CTU 111 in the processing order during both WPP off and VPDU-based WPP. Accordingly, reference to the VPDU located on the lower left of the VPDU [c] is not allowed.

Moreover, for example, for intra prediction of a VPDU [d] which is the lower right VPDU 121 of the current CTU 111, the intra prediction mode and the adjacent pixels of each of the VPDU [a], the VPDU [b], and the VPDU [c] (black band portion in the figure) are reference targets during both WPP off and VPDU-based WPP as indicated by C of FIG. 13. VPDUs located on the upper right and the lower left of the VPDU [d] are processed later than the current CTU 111 in the processing order during both WPP off and VPDU-based WPP. Accordingly, reference to the VPDUs located on the upper right and the lower left of the VPDU [d] is not allowed.

### <4-3: Method 1-4>

In method 1-4, a limitation is imposed on inter prediction. In a case where a processing target block is in an inter prediction mode, this mode is predicted with reference to an inter prediction mode of an adjacent block, and a motion vector is predicted with reference of the motion vector of the adjacent block.

### <4-3-1: Method 1-4-1>

In method 1-4-1, for inter prediction designating an upper left VPDU of a CTU as a current prediction block, reference to a lower right VPDU of a CTU processed one CTU before (i.e., CTU located next to the left) is made unavailable as indicated by dotted arrows in FIG. 11. In other words, reference to an inter prediction mode and a motion vector indicated by each of the dotted arrows in FIG. 11 is prohibited. Accordingly, a reference relation similar to that of intra prediction is made unavailable (limitation similar to that of method 1-3-1 is imposed).

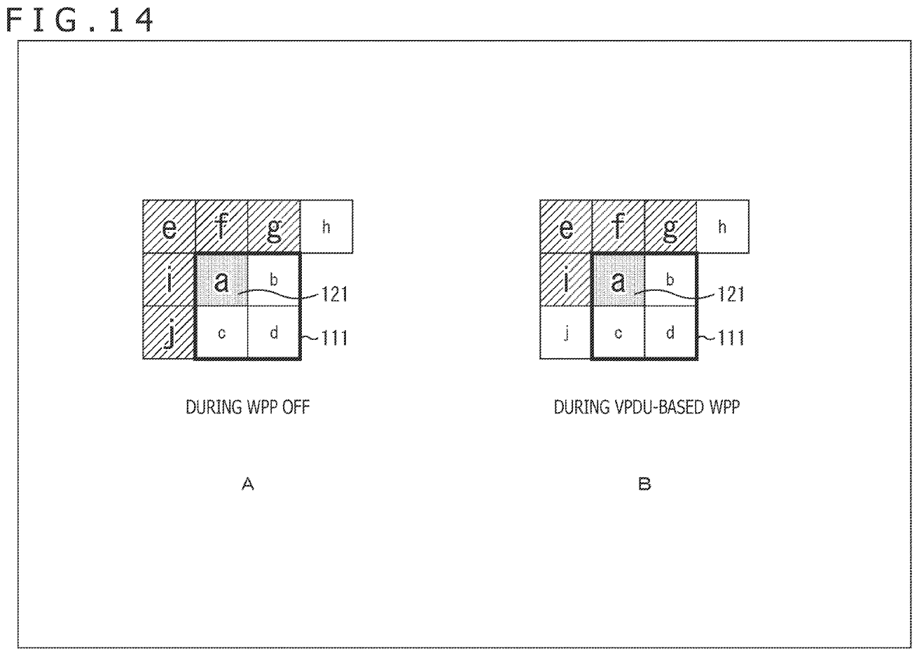

For example, for inter prediction designating a VPDU [a] which is the upper left VPDU 121 of the current CTU 111 as a current prediction block during WPP OFF, an inter prediction mode and a motion vector of each of a VPDU [e], a VPDU [f], a VPDU [g], a VPDU [i], and a VPDU [j] are reference targets as indicated by A of FIG. 14.

On the other hand, according to method 1-4-1, for inter prediction of the VPDU [a] which is the upper left VPDU 121 of the CTU 111 during VPDU-based WPP, reference to the inter prediction mode and the motion vector of the VPDU [j] is prohibited (made unavailable) as indicated in B of FIG. 14.

In the case of method 1, the processes are parallelized for each VPDU line. In addition, a delay between the lines is set to 2 VPDUs. Accordingly, while processing for the VPDU [a] (i.e., current prediction block) is allowed to be performed before processing of the VPDU [j], the processing for the current prediction block (VPDU [a]) may be required to wait until completion of the processing for the VPDU [j] (i.e., the waiting time may increase) due to the presence of the reference relation described above.

By limiting this reference as in method 1-4-1, the above reference relation of inter prediction is not established (inter prediction of the VPDU [a] is performed independently of the VPDU [j]). Accordingly, reduction of an increase in the waiting time is achievable.

For inter prediction designating the other VPDUs 121 of the CTU 111 as current prediction blocks, reference similar to the reference during WPP OFF is allowed even during VPDU-based WPP similarly to the case of intra prediction (FIG. 13). In addition, in a case where the block size of inter prediction is 64×64 or smaller (VPDU 121 or smaller), it is sufficient if this reference limitation in method 1-4-1 is imposed.

However, in the case of inter prediction, the block size of the prediction block may be set to a size larger than the size of 64×64, such as 128×64, 64×128, and 128×128.

### <4-3-2: Method 1-4-2>

According to method 1-4-2, in a case where a current prediction block has a block size of 128×N, reference to an upper right of the current prediction is made unavailable.

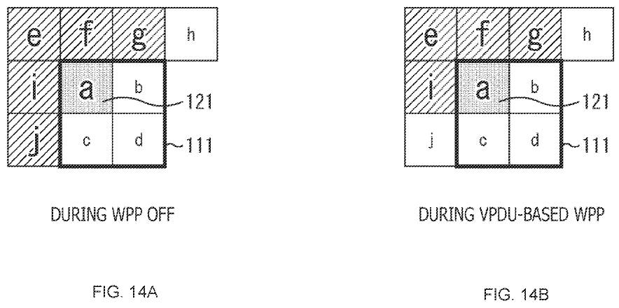

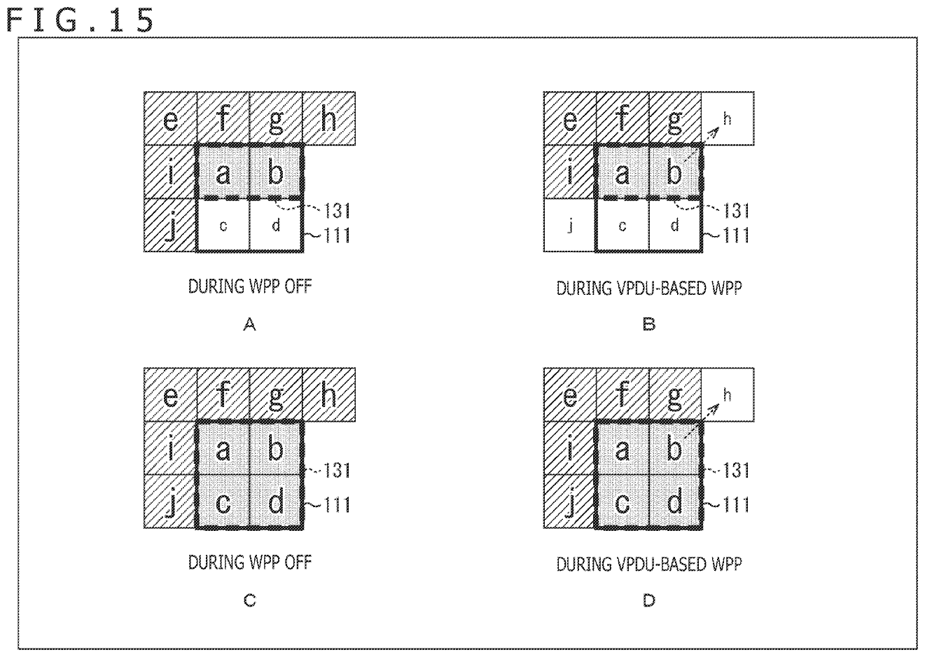

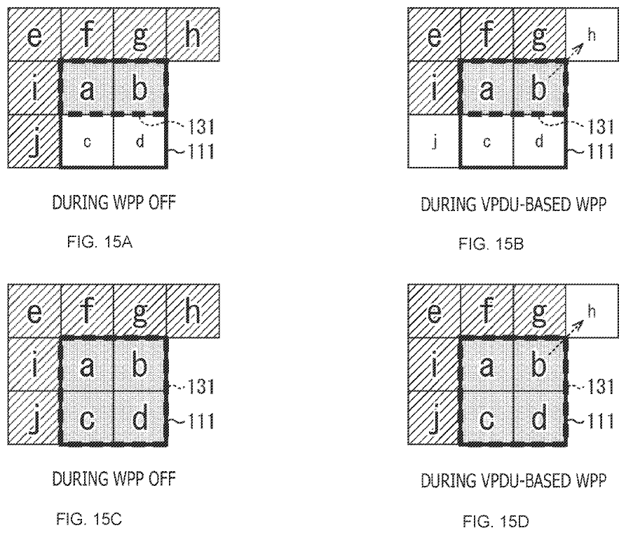

For example, for inter prediction of a prediction block having a block size of 128×64, reference to an inter prediction mode and a motion vector of a block located on the upper right of the prediction block is prohibited (made unavailable). For example, suppose that a prediction block [ab] including an upper left VPDU [a] and an upper right VPDU [b] of the current CTU 111 depicted in A of FIG. 15 is a current prediction block 131. In this case, during WPP OFF, an inter prediction mode and a motion vector of each of a VPDU [e], a VPDU [f], a VPDU [g], a VPDU [h], a VPDU [i], and VPDU [j] are reference targets as presented in A of FIG. 15.

On the other hand, in method 1-4-2, for inter prediction of the prediction block [ab] during VPDU-based WPP, reference to the inter prediction mode and the motion vector of the VPDU [h] located on the upper right of the prediction block [ab] is prohibited (made unavailable) as indicated in B of FIG. 15.

In the case of method 1, processes are parallelized for each VPDU line, and a delay between the lines is set to 2 VPDUs. Accordingly, processing for the VPDU [a] (i.e., prediction block [ab]) and processing for the VPDU [h] are allowed to be simultaneously performed. However, the processing for the prediction block [ab] may be required to wait until completion of the processing for the VPDU [h] (i.e., the waiting time may increase) due to the presence of the reference relation described above.

By limiting this reference as in method 1-4-2, the above reference relation of inter prediction is not established (inter prediction of the prediction block [ab] is performed independently of the VPDU [h]). Accordingly, reduction of an increase in the waiting time is achievable.

Moreover, for example, in inter prediction of the prediction block having the block size of 128×128, reference to an inter prediction mode and a motion vector of a block located on the upper right of the prediction block is similarly prohibited (made unavailable). For example, suppose that a prediction block [abcd] including all VPDUs of the current CTU 111 (VPDU [a], VPDU [b], VPDU [c], and VPDU [d]) depicted in C of FIG. 15 is the current prediction block 131. In this case, during WPP OFF, an inter prediction mode and a motion vector of each of the VPDU [e], the VPDU [f], the VPDU [g], the VPDU [h], the VPDU [i], and the VPDU [j] are reference targets as indicated by C of FIG. 15.

On the other hand, in method 1-4-2, for inter prediction of the prediction block [abcd] during VPDU-based WPP, reference to the inter prediction mode and the motion vector of the VPDU [h] located on the upper right of the prediction block [abcd] is prohibited (made unavailable) as indicated in D of FIG. 15.

In the case of method 1, processes are parallelized for each VPDU line, and a delay between the lines is 2 VPDUs. Accordingly, while processing for the VPDU [a] (i.e., prediction block [abcd]) and processing for the VPDU [h] are allowed to be simultaneously performed, the processing for the prediction block [abcd] may be required to wait until completion of the processing for the VPDU [h] (i.e., the waiting time may increase) due to the presence of the reference relation described above.

By limiting this reference as in method 1-4-2, the above reference relation of inter prediction is not established (inter prediction of the prediction block [abcd] is performed independently of the VPDU [h]). Accordingly, reduction of an increase in the waiting time is achievable.

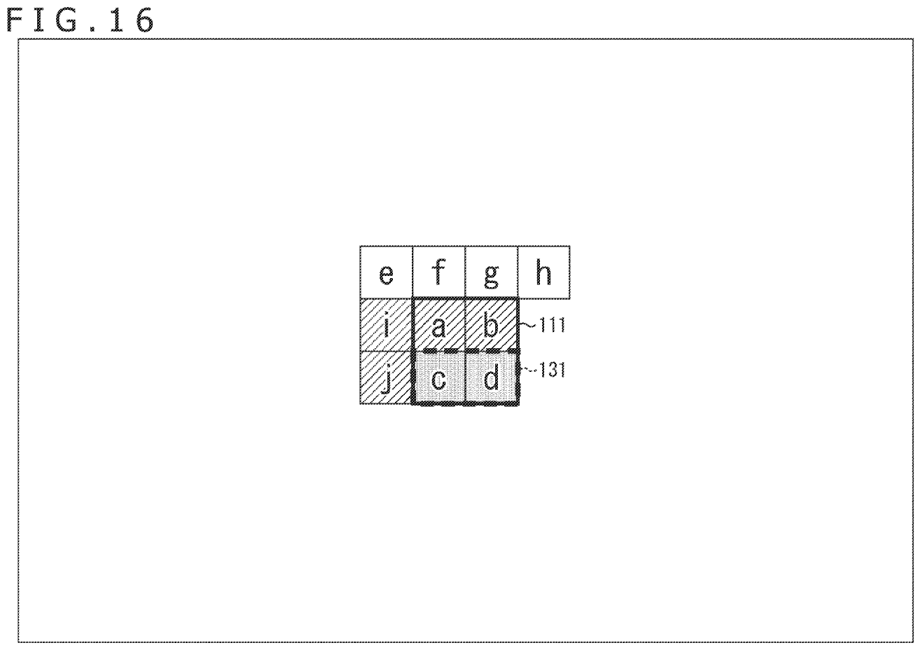

In addition, in a case where a prediction block [cd] including a lower left VPDU [c] and a lower right VPDU [d] of the current CTU 111 is the current prediction block 131, reference similar to the reference during WPP OFF (reference to the inter prediction modes and the motion vectors of the VPDU [a], the VPDU [b], the VPDU [i], and the VPDU [j]) is allowed even during VPDU-based WPP as depicted in FIG. 16 (The block located on the upper right is processed later in the processing order and therefore is not referred to also during WPP off.).

### <4-3-3: Method 1-4-3>

In method 1-4-3, in a case where a current prediction block has a block size of N×128, mode information indicating a mode of inter prediction is created using CABAC of a transform block in an upper stage, while coefficient data (residual) associated with residual data between an image and a prediction image is generated using each CABAC of transform blocks in respective stages. Accordingly, in this case, the mode information is coded and decoded for each prediction block, while the coefficient data (residual) is coded and decoded for each transform block.

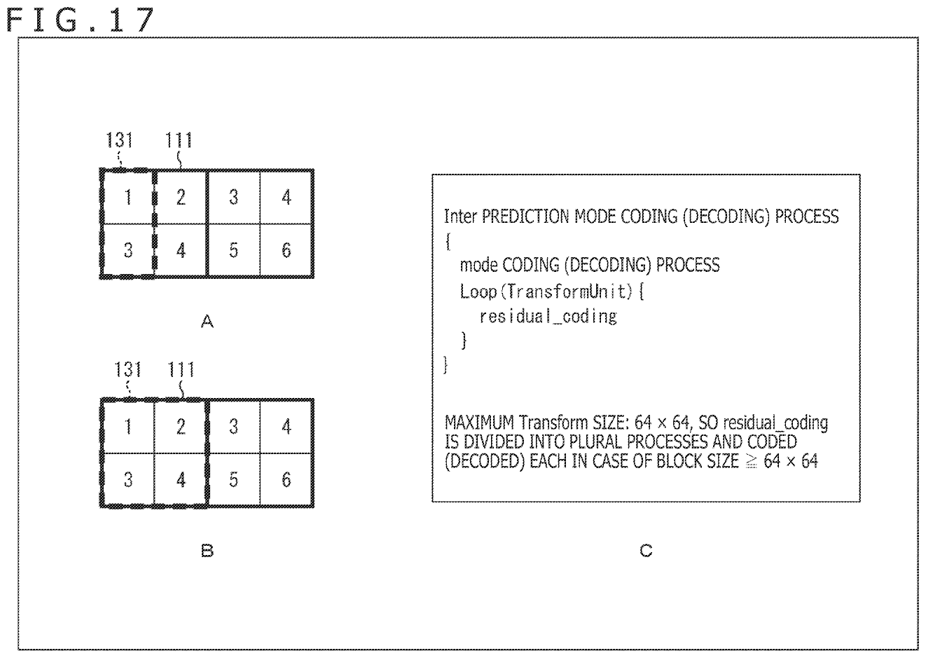

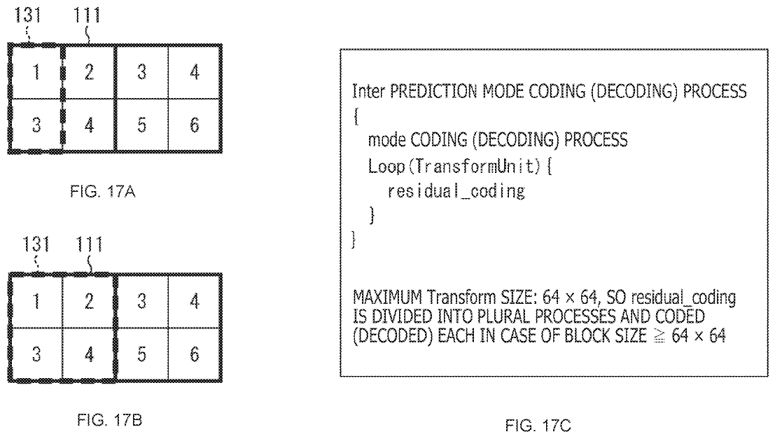

For example, as depicted in A of FIG. 17, it is assumed to code the VPDU 121 located in a lower stage and given a numeral “3” in the prediction block 131 having a block size of 64×128 for which inter prediction has been performed. In this case, a coding result of the VPDU 121 located in an upper stage and given a numeral “1” within the same prediction block 131 is applied to coding of the mode information.

On the other hand, coding of coefficient data (residual) is performed as a process different from the process of the coding of the VPDU 121 located in the upper stage and given the numeral “1” within the same prediction block 131. The maximum size of the transform block is 64×64. In this case, coefficient data (residual) of the VPDU 121 on an upper stage and coefficient data (residual) of the VPDU 121 on a lower stage can be generated independently of each other. Accordingly, coding of the coefficient data (residual) of the VPDU 121 on the upper stage is performed for coding of the line of the VPDU 121 on the upper stage, while coding of the coefficient data (residual) of the VPDU 121 on the lower stage is performed for coding of the line of the VPDU 121 on the lower stage.

Note that this is also applicable to decoding. Moreover, a prediction block including the VPDU 121 given a numeral “2” and the VPDU 121 given a numeral “4” can be similarly processed.

For example, as depicted in B of FIG. 17, the prediction block 131 having a block size of 128×128 for which inter prediction has been performed is similarly processed. Specifically, in this case, a coding result of the VPDU 121 located in an upper stage and given a numeral “1” or “2” within the same prediction block 131 is applied to coding of mode information associated with the VPDU 121 located on a lower stage and given a numeral “3” or “4.” On the other hand, coding of coefficient data (residual) of the VPDU 121 located on the lower stage and given a numeral “3” or “4” is performed as a process different from the process of the coding of the VPDU 121 located in the upper stage and given the numeral “1” or “2” within the same prediction block 131. Note that this is also applicable to decoding.

An example of syntax for performing this process is presented in C of FIG. 17. Specifically, mode information is coded and decoded for each prediction block, while coefficient data (residual) is coded and decoded for each transform block.

In such a manner, the prediction block of inter prediction having the block size of N×128 can be processed while parallelized for each transform block line. Moreover, redundancy of coding of the mode information can be reduced. Accordingly, reduction of an increase in a processing load and reduction of a decrease in coding efficiency are achievable.

### 5. First Embodiment

### <5-1: Image Coding Apparatus>

The present technology described above is applicable to any apparatus, device, system, or the like. For example, the present technology described above is applicable to an image coding apparatus which codes image data.

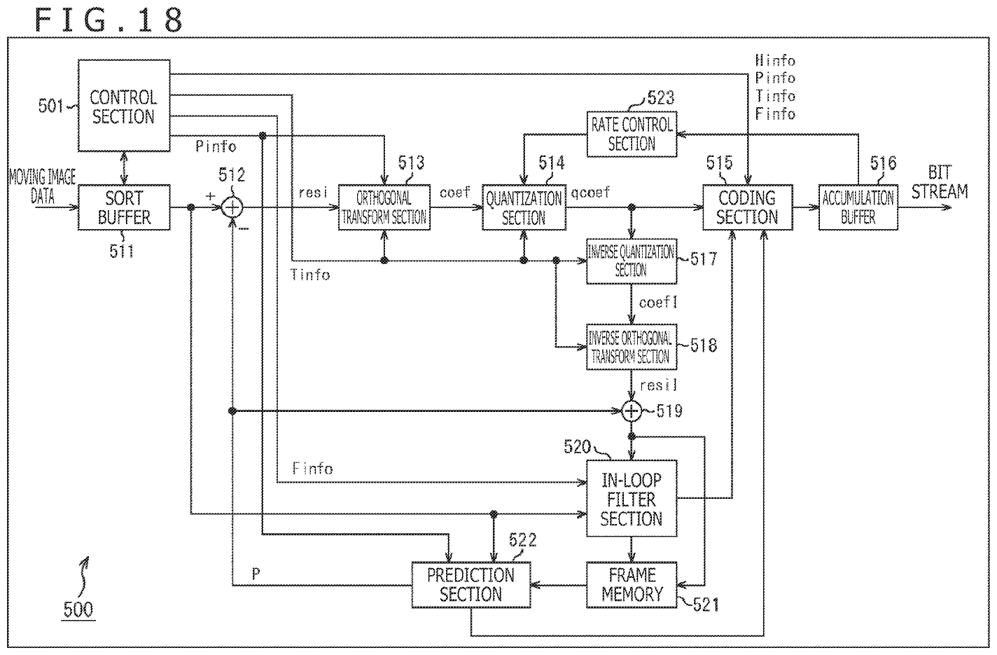

FIG. 18 is a block diagram depicting an example of a configuration of an image coding apparatus according to an aspect of an image processing apparatus to which the present technology is applied. An image coding apparatus 500 depicted in FIG. 18 is an apparatus which codes image data of a moving image. For example, the image coding apparatus 500 incorporates the technologies described in NPL 1 to NPL 6, and codes image data of a moving image by using a method in conformity with standards described in any one of these references.

Note that FIG. 18 depicts only main processing sections and data flows. All processing sections and data flows are not necessarily contained in FIG. 18. Specifically, the image coding apparatus 500 may include a processing section not depicted as a block in FIG. 18, or a process or a data flow not depicted as an arrow or the like in FIG. 18.

As depicted in FIG. 18, the image coding apparatus 500 includes a control section 501, a sort buffer 511, a calculation section 512, an orthogonal transform section 513, a quantization section 514, a coding section 515, an accumulation buffer 516, an inverse quantization section 517, an inverse orthogonal transform section 518, a calculation section 519, an in-loop filter section 520, a frame memory 521, a prediction section 522, and a rate control section 523.

### <Control Section>

The control section 501 divides moving image data retained by the sort buffer 511 into blocks (e.g., CUs, PUs, and transform blocks) of processing units on the basis of a block size of processing units designated outside or beforehand.

Moreover, the control section 501 determines coding parameters supplied to respective blocks (e.g., header information Hinfo, prediction mode information Pinfo, transform information Tinfo, and filter information Finfo) on the basis of RDO (Rate-Distortion Optimization), for example.

Details of these coding parameters will be described below. After determining the coding parameters described above, the control section 501 supplies the determined coding parameters to the respective blocks. Specifically, the following is performed.

The header information Hinfo is supplied to the respective blocks. The prediction mode information Pinfo is supplied to the coding section 515 and the prediction section 522. The transform information Tinfo is supplied to the coding section 515, the orthogonal transform section 513, the quantization section 514, the inverse quantization section 517, and the inverse orthogonal transform section 518. The filter information Finfo is supplied to the in-loop filter section 520.

### <Sort Buffer>

Respective fields (input images) of moving image data are input to the image coding apparatus 500 in a reproduction order (display order). The sort buffer 511 acquires the respective input images in the reproduction order (display order), and retains (stores) the input images. The sort buffer 511 rearranges the input images in a coding order (decoding order), and divides the input images into blocks of processing units under control by the control section 501. The sort buffer 511 supplies the respective processed input images to the calculation section 512. Moreover, the sort buffer 511 supplies the respective input images (original images) to the prediction section 522 and the in-loop filter section 520.

### <Calculation Section>

The calculation section 512 receives an input of an image I corresponding to a block of a processing unit, and a prediction image P supplied from the prediction section 522, subtracts the prediction image P from the image I as represented in following Equation (3) to derive a prediction residue resi, and supplies the prediction residue resi to the orthogonal transform section 513.

[Math.3]

resi=I−P (3)

### <Orthogonal Transform Section>

The orthogonal transform section 513 receives an input of the prediction residue resi supplied from the calculation section 512, and transform information Tinfo supplied from the control section 501, and performs orthogonal transform for the prediction residue resi on the basis of the transform information Tinfo to derive a transform coefficient coef. The orthogonal transform section 513 supplies the obtained transform coefficient coef to the quantization section 514.

### <Quantization Section>

The quantization section 514 receives an input of the transform coefficient coef supplied from the orthogonal transform section 513, and the transform information Tinfo supplied from the control section 501, and scales (quantizes) the transform coefficient coef on the basis of the transform information Tinfo. Note that a rate of this quantization is controlled by the rate control section 523. The quantization section 514 supplies a quantized transform coefficient obtained by this quantization, i.e., a quantization transform coefficient level qcoef to the coding section 515 and the inverse quantization section 517.

### <Coding Section>

The coding section 515 receives an input of the quantization transform coefficient level qcoef supplied from the quantization section 514, various types of coding parameters (e.g., header information Hinfo, prediction mode information Pinfo, transform information Tinfo, and filter information Finfo) supplied from the control section 501, information associated with a filter, such as a filter coefficient, supplied from the in-loop filter section 520, and information associated with an optimum prediction mode and supplied from the prediction section 522. The coding section 515 codes the quantization transform coefficient level qcoef (e.g., performs arithmetic coding of CABAC or the like) to generate a bit string.

Moreover, the coding section 515 derives residual information Rinfo from the quantization transform coefficient level qcoef, and codes the residual information Rinfo to generate a bit string.

Furthermore, the coding section 515 adds information associated with the filter and supplied from the in-loop filter section 520 to the filter information Finfo, and adds information associated with the optimum prediction mode and supplied from the prediction section 522 to the prediction mode information Pinfo. Moreover, the coding section 515 codes the various types of coding parameter described above (e.g., header information Hinfo, prediction mode information Pinfo, transform information Tinfo, and filter information Finfo) to generate a bit string.

Moreover, the coding section 515 multiplexes bit strings of various types of information generated in the manner described above to generate coded data. The coding section 515 supplies the coded data to the accumulation buffer 516.

### <Accumulation Buffer>

The accumulation buffer 516 temporarily retains coded data obtained by the coding section 515. The accumulation buffer 516 outputs the retained coded data to the outside of the image coding apparatus 500 as a bit stream or the like, for example, at predetermined timing. For example, this coded data is transferred to the decoding side via any recording medium, any transfer medium, any information processing apparatus, or the like. Accordingly, the accumulation buffer 516 also functions as a transfer section which transfers coded data (bit stream).

### <Inverse Quantization Section>

The inverse quantization section 517 performs a process associated with inverse quantization. For example, the inverse quantization section 517 receives an input of the quantization transform coefficient level qcoef supplied from the quantization section 514, and the transform information Tinfo supplied from the control section 501, and scales (inversely quantizes) the value of the quantization transform coefficient level qcoef on the basis of the transform information Tinfo. Note that this inverse quantization is an inverse process of quantization performed by the quantization section 514. The inverse quantization section 517 supplies a transform coefficient coefI obtained by this inverse quantization to the inverse orthogonal transform section 518.

### <Inverse Orthogonal Transform Section>

The inverse orthogonal transform section 518 performs a process associated with inverse orthogonal transform. For example, the inverse orthogonal transform section 518 receives an input of the transform coefficient coefI supplied from the inverse quantization section 517, and the transform information Tinfo supplied from the control section 501, and performs inverse orthogonal transform for the transform coefficient coefI on the basis of the transform information Tinfo to derive a prediction residue resiI. Note that this inverse orthogonal transform is an inverse process of orthogonal transform performed by the orthogonal transform section 513. The inverse orthogonal transform section 518 supplies the prediction residue resiI obtained by this inverse orthogonal transform described above to the calculation section 519. Note that the inverse orthogonal transform section 518 is similar to an inverse orthogonal transform section on the decoding side (described below). Accordingly, corresponding description for the decoding side (presented below) is applicable to the inverse orthogonal transform section 518.

### <Calculation Section>

The calculation section 519 receives an input of the prediction residue resiI supplied from the inverse orthogonal transform section 518, and a prediction image P supplied from the prediction section 522. The calculation section 519 adds the prediction residue resiI to the prediction image P corresponding to the prediction residue resiI to derive a locally decoded image Rlocal. The calculation section 519 supplies the derived locally decoded image Rlocal to the in-loop filter section 520 and the frame memory 521.

### <In-Loop Filter Section>

The in-loop filter section 520 performs a process associated with in-loop filtering. For example, the in-loop filter section 520 receives an input of the locally decoded image Rlocal supplied from the calculation section 519, the filter information Finfo supplied from the control section 501, and an input image (original image) supplied from the sort buffer 511. Note that information input to the in-loop filter section 520 may be any information. Information other than the above information may be input to the in-loop filter section 520. For example, information such as a prediction mode, movement information, a code quantity target value, a quantization parameter QP, a picture type, and a block (e.g., CU and CTU) may be input to the in-loop filter section 520 as necessary.

The in-loop filter section 520 performs filtering for the locally decoded image Rlocal as appropriate on the basis of the filter information Finfo given to the in-loop filter section 520. The in-loop filter section 520 also uses an input image (original image) and other input information as necessary to perform filtering.

For example, the in-loop filter section 520 applies four in-loop filters, i.e., a bilateral filter, a deblocking filter (DBF (DeBlocking Filter)), an adaptive offset filter (SAO (Sample Adaptive Offset)), and an adaptive loop filter (ALF (Adaptive Loop Filter)) in this order. Note that which filters to be applied and in what order the filters are applied may be selected in any manner as appropriate.

Needless to say, filtering performed by the in-loop filter section 520 may be any process, and is not limited to the example described above. For example, the in-loop filter section 520 may apply a Wiener filter or the like.

The in-loop filter section 520 supplies the filtered locally decoded image Rlocal to the frame memory 521. In addition, in a case of transfer of information associated with the filter such as a filter coefficient to the decoding side, the in-loop filter section 520 supplies the information associated with the filter to the coding section 515.

### <Frame Memory>

The frame memory 521 performs a process associated with storage of data corresponding to images. For example, the frame memory 521 receives an input of the locally decoded image Rlocal supplied from the calculation section 519, and the locally decoded image Rlocal filtered and supplied from the in-loop filter section 520, and retains (stores) these images. Moreover, the frame memory 521 reconstructs a decoded image R for each picture unit using the locally decoded image Rlocal, and retains the decoded image R (stores the decoded image R in a buffer within the frame memory 521). The frame memory 521 supplies the decoded image R (or a part of the decoded image R) to the prediction section 522 in accordance with a request from the prediction section 522.

### <Prediction Section>

The prediction section 522 performs a process associated with formation of a prediction image. For example, the prediction section 522 receives an input of the prediction mode information Pinfo supplied from the control section 501, the input image (original image) supplied from the sort buffer 511, and the decoded image R (or a part of the decoded image R) read from the frame memory 521. The prediction section 522 performs a prediction process such as inter prediction and intra prediction using the prediction mode information Pinfo and the input image (original image), performs prediction with reference to the decoded image R as a reference image, and performs a motion compensation process on the basis of a prediction result thus obtained to form a prediction image P. The prediction section 522 supplies the formed prediction image P to the calculation section 512 and the calculation section 519. Moreover, the prediction section 522 supplies a prediction mode selected by the above process, i.e., information associated with an optimum prediction mode to the coding section 515 as necessary.

### <Rate Control Section>

The rate control section 523 performs a process associated with rate control. For example, the rate control section 523 controls a rate of a quantizing operation performed by the quantization section 514, in such a manner as not to produce overflow or underflow, on the basis of a code quantity of coded data accumulated in the accumulation buffer 516.

### <Application of Present Technology>

The present technology described above in <3. Concept> and <4.1 Method 1> is applied to the image coding apparatus 500 configured as above. Specifically, the coding section 515 applies WPP for each transform block. For example, the coding section 515 codes coefficient data associated with an image in parallel for each line of transform blocks each of which is a unit of transforming image data into coefficient data.

“Method 1” may be applied to the image coding apparatus 500 described above. For example, the control section 501 may set the VPDUs 121 for the CTUs 111, and the coding section 515 may perform coding in parallel for each VPDU line (applies WPP for each VPDU line). Moreover, the coding section 515 may execute a process for each VPDU line with a delay of 2 VPDUs from a VPDU line located one line above.

Furthermore, “method 1-1” or “method 1-2” may be applied to the image coding apparatus 500 described above. Specifically, the coding section 515 may use CABAC context different for each processing of the VPDUs 121 in each of the stages within the CTU 111. Besides, context of coding may be inherited (copied) between VPDU lines.

For example, the coding section 515 may code each line of transform blocks of coefficient data associated with an image sequentially transform block by transform block from the left transform block. Moreover, the coding section 515 may entropy-code each transform block using an occurrence probability derived by entropy-coding one coding before.

Furthermore, for example, the coding section 515 may entropy-code the leftmost transform block in the uppermost transform block line in the image using an initial occurrence probability value. In addition, the coding section 515 may entropy-code each of the leftmost transform blocks in the second uppermost transform block line and the transform block lines below the second uppermost transform block line in the image using an occurrence probability derived by entropy-coding of the second leftmost transform block in the transform block line located one line above.

Moreover, “method 1-3” may be applied to the image coding apparatus 500 described above. In other words, the prediction section 522 may impose a partial mode limitation in intra prediction. For example, “method 1-3-1” may be applied to the image coding apparatus 500 described above. Specifically, for intra prediction of an upper left VPDU of a CTU, the control section 501 may make reference to a lower right VPDU of a CTU processed one CTU before (i.e., CTU located next to the left) to be unavailable, and the prediction section 522 may perform intra prediction under this control. Specifically, the prediction section 522 may perform intra prediction for the upper left VPDU of the CTU while making reference to the lower right VPDU of the CTU located next to the left to be unavailable.

For example, for intra prediction of an upper left transform block of a coding tree unit in the uppermost order of a coding block of a tree structure, the prediction section 522 may perform intra prediction while making reference to a lower right transform block of a coding tree unit coded one unit before to be unavailable.

Moreover, “method 1-4” may be applied to the image coding apparatus 500 described above. In other words, the prediction section 522 may impose a limitation on intra prediction. For example, “method 1-4-1” may be applied to the image coding apparatus 500 described above. Specifically, for inter prediction designating an upper left VPDU of a CTU as a current prediction block, the control section 501 may make reference to an inter prediction mode and a motion vector of a lower right VPDU of a CTU processed one CTU before (i.e., CTU located next to the left) to be unavailable, and the prediction section 522 may perform inter prediction under this control. In other words, in a case where the upper left VPDU of the CTU is designated as a current prediction block, the prediction section 522 may perform inter prediction while making reference to the inter prediction mode and the motion vector of the lower right VPDU of the CTU next to the left to be unavailable.

For example, for inter prediction of an upper left transform block of a coding tree unit in the uppermost order of a coding block of a tree structure, the prediction section 522 may perform inter prediction while making reference to a motion vector of a lower right transform block of a coding tree unit coded one unit before to be unavailable.

Moreover, for example, “method 1-4-2” may be applied to the image coding apparatus 500 described above. Specifically, for inter prediction of a prediction block having a block size of 128×N, the control section 501 may prohibit (make unavailable) reference to an inter prediction mode and a motion vector of a block on the upper right of the prediction block, and the prediction section 522 may perform inter prediction under this control. In other words, the prediction section 522 may perform inter prediction while making reference to the block on the upper right of the current prediction block having the block size of 128×N to be unavailable.

For example, for inter prediction of a prediction block which is a processing unit of inter prediction, and has the same horizontal length as that of a coding tree unit in the highest order of a coding block of a tree structure, the prediction section 522 may make reference to a motion vector of an upper right transform block to be unavailable.

Moreover, for example, “method 1-4-3” may be applied to the image coding apparatus 500 described above. Specifically, for a prediction block of a block size of N×128 for which inter prediction has been performed, the coding section 515 may code mode information indicating a mode of the inter prediction for each prediction block, and may code coefficient data (residual) associated with residual data between an image and a prediction image for each transform block.

For example, for prediction blocks each of which is a processing unit of inter prediction and has the same horizontal length as that of a coding tree unit in the highest order of a coding block of a tree structure, the coding section 515 may code mode information indicating a mode of inter prediction for each of the prediction blocks, and may code residual data between an image and a prediction image for each transform block contained in the prediction blocks.

The image coding apparatus 500 thus configured is capable of reducing a decrease in the degree of parallelism of coding, and therefore is capable of reducing an increase in a processing time.

### <5-2: Flow of Process>

### <Flow of Image Coding Process>

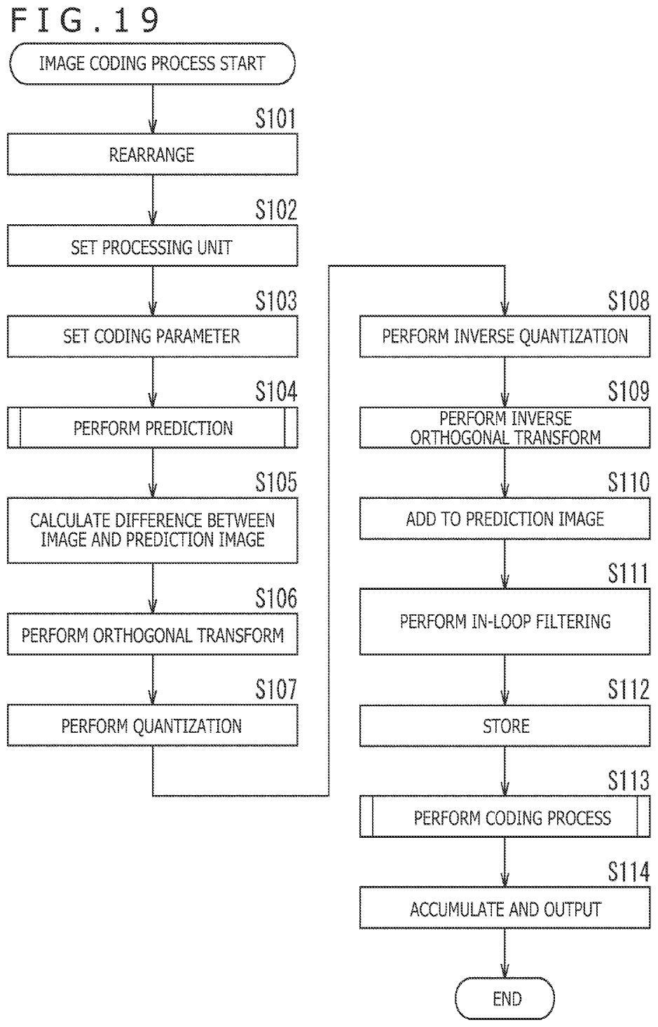

Described next will be flows of respective processes executed by the image coding apparatus 500 described above. An example of a flow of an image coding process will be initially described with reference to a flowchart in FIG. 19.

At a start of the image coding process, the sort buffer 511 in step S101 rearranges input frames of moving image data from a display order to a coding order under control by the control section 501.

In step S102, the control section 501 sets a processing unit for an input image retained by the sort buffer 511 (divides the image into blocks).

In step S103, the control section 501 determines (sets) coding parameters for the input image retained by the sort buffer 511. At this time, the control section 501 determines settings associated with a limitation to intra prediction or inter prediction described above as necessary. These settings are supplied to the prediction section 522 as prediction mode information Pinfo, for example.

In step S104, the prediction section 522 performs a prediction process under control by the control section 501 to form a prediction image or the like in an optimum prediction mode. Details of the prediction process will be described below.

In step S105, the calculation section 512 calculates a difference between the input image and the prediction image in the optimum mode selected by the prediction process in step S104. Specifically, the calculation section 512 generates a prediction residue resi between the input image and the prediction image. The prediction residue resi thus obtained has a data volume smaller than that of the original image data. Accordingly, data volume compression is achievable in comparison with a case where the image is coded as it is.

In step S106, the orthogonal transform section 513 performs an orthogonal transform process for the prediction residue resi generated by the processing in step S105 to derive a transform coefficient coef.

In step S107, the quantization section 514 quantizes the transform coefficient coef obtained by the processing in step S106 using quantization parameters calculated by the control section 501, for example, to derive a quantization transform coefficient level qcoef.

In step S108, the inverse quantization section 517 inversely quantizes the quantization transform coefficient level qcoef generated by the processing in step S107 in accordance with a property corresponding to a property of the quantization in step S107 to derive a transform coefficient coefI.

In step S109, the inverse orthogonal transform section 518 performs inverse orthogonal transform for the transform coefficient coefI obtained by the processing in step S108, using a method corresponding to the orthogonal transform process in step S106, to derive a prediction residue resiI. Note that this inverse orthogonal transform process is similar to an inverse orthogonal transform process performed on the decoding side (described below). Accordingly, corresponding description for the decoding side (described below) is applicable to the inverse orthogonal transform process in step S109.

In step S110, the calculation section 519 adds the prediction image obtained by the prediction process in step S104 to the prediction residue resiI derived by the processing in step S109 to form a decoded image locally decoded.

In step S111, the in-loop filter section 520 performs an in-loop filtering process for the decoded image derived by the processing in step S110 and locally decoded.

In step S112, the frame memory 521 stores the decoded image derived by the processing in step S110 and locally decoded, and the decoded image locally decoded and filtered in step S111.

In step S113, the coding section 515 performs a coding process to code the quantization transform coefficient level qcoef obtained by the processing in step S107. For example, the coding section 515 codes the quantization transfer coefficient level qcoef which is information associated with the image by arithmetic coding or the like to generate coded data. Moreover, the coding section 515 at this time codes various types of coding parameters (header information Hinfo, prediction mode information Pinfo, and transform information Tinfo).

Furthermore, the coding section 515 derives residual information RInfo from the quantization transform coefficient level qcoef, and codes the residual information RInfo. Details of this coding process will be described below.

In step S114, the accumulation buffer 516 accumulates coded data obtained In such a manner, and outputs the coded data to the outside of the image coding apparatus 500 as a bit stream, for example. This bit stream is transferred to the decoding side via a transfer path or a recording medium, for example. Moreover, the rate control section 523 performs rate control as necessary.

After completion of the processing in step S114, the image coding process ends.

In the coding process executed in step S113 of the image coding process described above, the coding section 515 codes coefficient data associated with the image in parallel for each line of transform blocks each of which is a unit of transforming image data into coefficient data. In such a manner, the image coding apparatus 500 is capable of reducing a decrease in the degree of parallelism of coding, and therefore is capable of reducing an increase in a processing time.

### <Flow of Prediction Process>

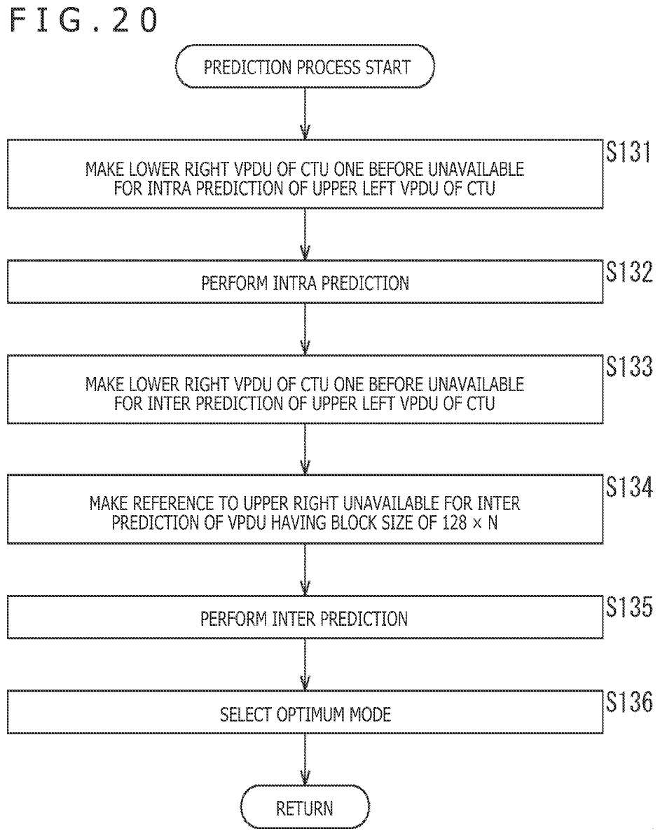

An example of a flow of the prediction process executed in step S104 in FIG. 19 will be subsequently described with reference to a flowchart in FIG. 20.

At a start of the prediction process, for intra prediction of an upper left VPDU of a CTU, the control section 501 in step S131 makes reference to a lower right VPDU of a CTU located one CTU before to be unavailable. In step S132, the prediction section 522 performs intra prediction in accordance with the setting in step S131. Specifically, the prediction section 522 performs intra prediction for each of VPDUs. In a case where the upper left VPDU of the CTU is a processing target, the prediction section 522 performs intra prediction while making reference to the lower right VPDU of the CTU one CTU before to be unavailable.

In step S133, for inter prediction of a prediction block including the upper left VPDU of the CTU, the control section 501 makes reference to the lower right VPDU of the CTU one CTU before to be unavailable. Moreover, in step S134, for inter prediction of a prediction block having a block size of 128×N, the control section 501 makes reference to a block on the upper right of the prediction block to be unavailable. In step S135, the prediction section 522 performs inter prediction in accordance with the settings in steps S133 and S134.

Specifically, the prediction section 522 performs inter prediction for the respective prediction blocks. In a case where the prediction block including the upper left VPDU of the CTU is designated as a processing target, the prediction section 522 performs inter prediction while making reference to the lower right VPDU of the CTU located one CTU before to be unavailable. In a case where the prediction block having the block size of 128×N is designated as a processing target, the prediction section 522 performs inter prediction while making reference to the block on the upper right of the prediction block to be unavailable.

In step S136, the prediction section 522 selects an optimum prediction mode on the basis of a result of the processing in step S132 and a result of the processing in step S135. Specifically, the prediction section 522 forms a prediction image or the like in an optimum intra prediction mode by performing intra prediction, forms a prediction image or the like of an optimum inter prediction mode by performing inter prediction, and selects an optimum prediction mode from these on the basis of a cost function value or the like.

After completion of the processing in step S136, the prediction process ends, and the process returns to FIG. 19.

### <Flow of Coding Process>

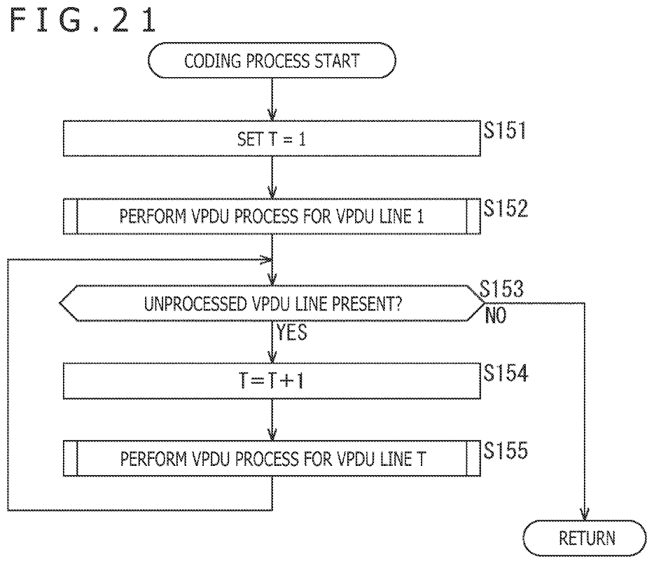

An example of a flow of the coding process executed in step S113 in FIG. 19 will be subsequently described with reference to a flowchart in FIG. 21.

At a start of the coding process, the coding section 515 in step S151 sets a variable T indicating a position of a VPDU line designated as a processing target (line number from the upper side in the image) to an initial value (=1).

In step S152, the coding section 515 performs a VPDU process for a VPDU line 1 which is the first VPDU line from the upper side of the image. Details of this process will be described below. After completion of the process performed for the VPDU line 1, the process proceeds to step S153.

In step S153, the coding section 515 determines whether or not an unprocessed VPDU line is present. In a case of a determination that an unprocessed VPDU line is present without completion of processing until the VPDU line on the lowermost stage of the image, the process proceeds to step S154.

In step S154, the coding section 515 adds 1 to the value of the variable T (T=T+1). After increment of the value of the variable T, the process proceeds to step S155.

In step S155, the coding section 515 performs a VPDU process for a VPDU line T which is a Tth VPDU line from the upper side of the image. Details of this process will be described below. After completion of the process performed for the VPDU line T, the process returns to step S153.

In such a manner, the processing in each of the steps from step S153 to step S155 is repeated until completion of all the VPDU lines. Thereafter, in a case of determination that no unprocessed VPDU line is present (all VPDU lines have been processed) in step S153, the coding process ends, and the process returns to FIG. 19.

### <Flow of VPDU Process for VPDU Line 1>

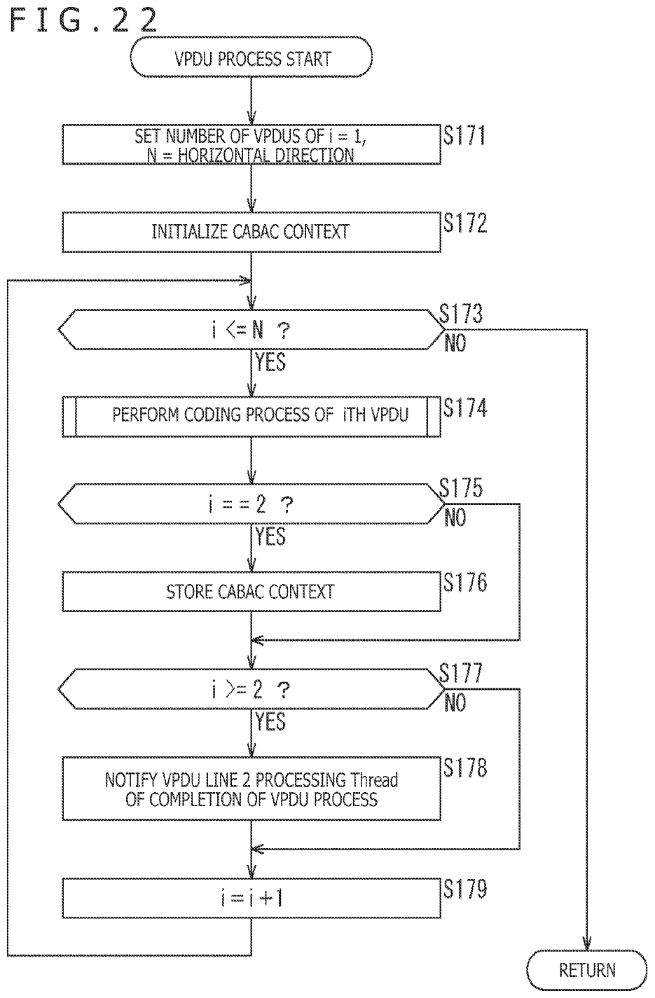

An example of a flow of the VPDU process for the VPDU line 1 executed in step S152 in FIG. 21 will be subsequently described with reference to a flowchart in FIG. 22.

At a start of the VPDU process, the coding section 515 in step S171 sets a variable i indicating a position of a current VPDU (VPDU number from the left end of the image) to an initial value (=1). Moreover, the coding section 515 sets a number N to the number of VPDUs in the horizontal direction. Accordingly, the number N indicates the number of VPDUs in the VPDU line 1.

In step S172, the coding section 515 initializes CABAC context (occurrence probability).

In step S173, the coding section 515 determines whether or not the variable i is N or smaller (i<=N). In a case of determination that the variable i is N or smaller and that an unprocessed VPDU is present in the VPDU line 1, the process proceeds to step S174.

In step S174, the coding section 515 executes a VPDU coding process to code an ith VPDU from the left end. This VPDU coding process will be described below. After coding of the ith VPDU from the left end, the process proceeds to step S175.

In step S175, the coding section 515 determines whether or not a variable i has a value of 2 (i==2). In a case of determination that the variable i has a value of 2, the process proceeds to step S176.

In step S176, the coding section 515 stores CABAC context (occurrence probability) associated with a second VPDU from the left end of the image and generated in step S174. After the context is stored, the process proceeds to step S177.

Moreover, in a case of determination in step S175 that the variable i has a value other than 2 (the processing target is not the second VPDU from the left end of the image), the process proceeds to step S177 while skipping the processing in step S176.

In step S177, the coding section 515 determines whether or not the variable i has a value of 2 or larger (i>=2). In a case of determination that the variable i has a value of 2 or larger, the process proceeds to step S178.

In step S178, the coding section 515 notifies a VPDU line 2 processing Thread, which is a thread processing the VPDU line 2, of completion of the VPDU process. After completion of the VPDU process completion notification, the process proceeds to step S179.

Moreover, in a case of determination in step S177 that the variable i has a value smaller than 2 (the processing target is the VPDU at the left end of the image), the process proceeds to step S179 while skipping the processing in step S178.

In step S179, the coding section 515 adds 1 to the value of the variable i (i=i+1). After increment of the value of the variable i, the process returns to step S173.

In other words, the processing in each of the steps from step S173 to step S179 is repeated until completion of all the VPDUs in the VPDU line 1. Thereafter, in a case of determination that no unprocessed VPDU is present (all VPDUs in the VPDU line 1 have been processed) in step S173, this VPDU process ends, and the process returns to FIG. 21.

### <Flow of VPDU Coding Process>

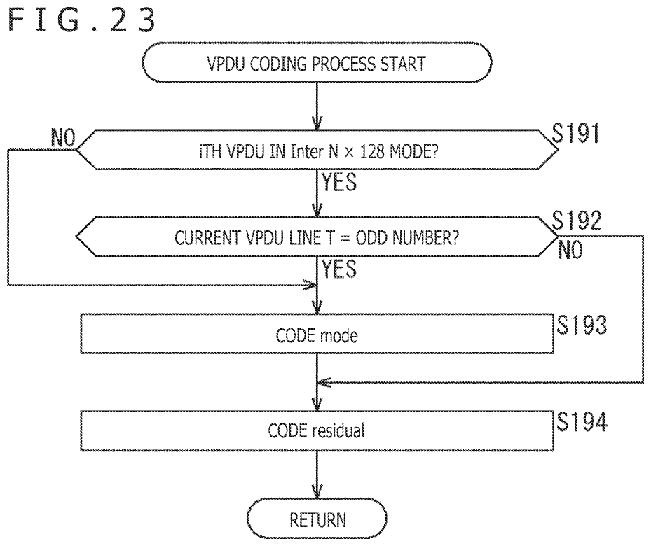

An example of a flow of the VPDU coding process executed in step S174 in FIG. 22 and other steps, for example, will be subsequently described with reference to a flowchart in FIG. 23.

At a start of the VPDU coding process, the coding section 515 in step S191 determines whether or not an ith VPDU (i.e., current VPDU) is in an Inter N×128 mode (i.e., included in a prediction block having a block size of N×128 for which inter prediction has been performed). In a case of determination that the mode is in Inter N×128 mode, the process proceeds to step S192.

In step S192, the coding section 515 determines whether or not a variable T is an odd number, i.e., whether or not a current VPDU line T as a processing target is an odd-numbered VPDU line from the upper side of the image. In a case of determination that the variable T is an odd number, the process proceeds to step S193.

Moreover, in a case of determination that the current VPDU is not in Inter N×128 mode in step S191, the process proceeds to step S193 while skipping the processing in step S192.

In this case, the current VPDU is a VPDU located in an upper stage within a CTU, the coding section 515 in step S193 codes mode information. After the mode information is coded, the process proceeds to step S194.

In addition, in a case of determination that the variable T is an even number (i.e., the current VPDU line T is an even-numbered VPDU line from the upper side of the image, and the current VPDU is a VPDU in a lower stage within the CTU), a coded result of the VPDU in the upper stage of the CTU is applied. In this case, the process proceeds to step S194 while skipping the processing in step S193.

In step S194, the coding section 515 codes coefficient data (residual) associated with residual data between the image and a prediction image for the current VPDU. After completion of the processing in step S194, the VPDU coding process ends, and the process returns to the VPDU process which has executed this VPDU coding process.

### <Flow of VPDU Process for VPDU Line T>

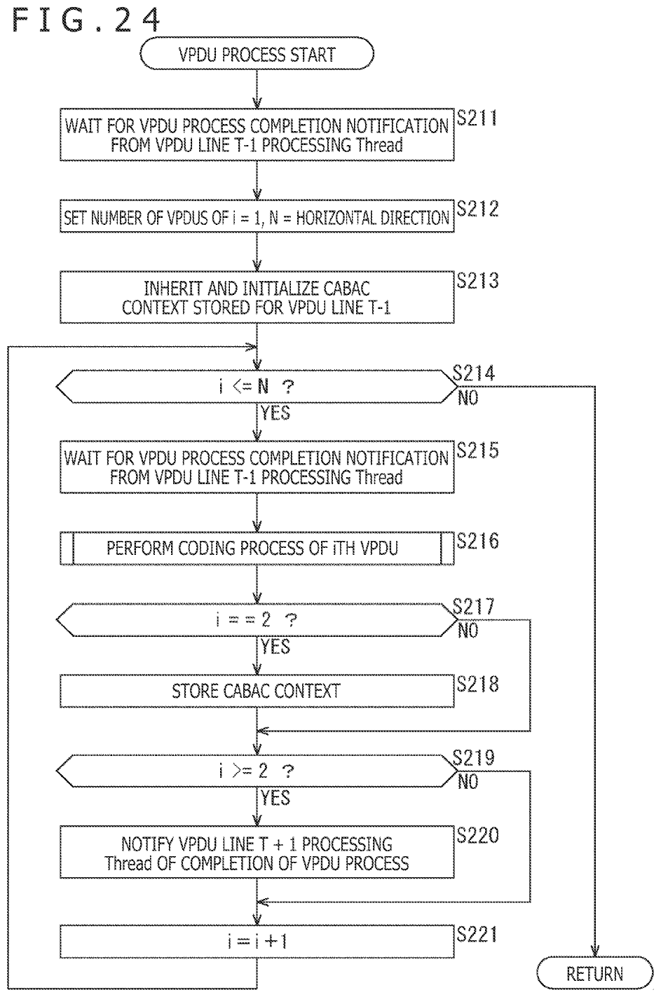

An example of a flow of the VPDU process for the VPDU line T executed in step S155 in FIG. 21 will be subsequently described with reference to a flowchart in FIG. 24.

At a start of the VPDU process, the coding section 515 in step S211 waits until reception of a VPDU process completion notification from a VPDU line T−1 processing Thread which is a thread processing a VPDU line T−1 located one line above. After acquisition of the VPDU process completion notification from the VPDU line T−1 processing Thread, the process proceeds to step S212.

In step S212, the coding section 515 sets a variable i to an initial value (=1). Moreover, the coding section 515 sets a number N to the number of VPDUs in the horizontal direction.

In step S213, the coding section 515 inherits CABAC context (occurrence probability) stored by the VPDU process for the VPDU line T−1 located one line above, and initializes CABAC.

In step S214, the coding section 515 determines whether or not the variable i is N or smaller (i<=N). In a case of determination that the variable i is N or smaller and that an unprocessed VPDU is present in the VPDU line T, the process proceeds to step S215.

In step S215, the coding section 515 waits until reception of a VPDU process completion notification from the VPDU line T−1 processing Thread to control processing timing. After acquisition of the VPDU process completion notification from the VPDU line T−1 processing Thread, the process proceeds to step S216.

In step S216, the coding section 515 executes a VPDU coding process (FIG. 23) to code an ith VPDU from the left end. After coding the ith VPDU from the left end, the process proceeds to step S217.

In step S217, the coding section 515 determines whether or not a variable i has a value of 2 (i==2). In a case of determination that the variable i has a value of 2, the process proceeds to step S218.

In step S218, the coding section 515 stores CABAC context (occurrence probability) associated with the second VPDU from the left end of the image and generated in step S216. After the context is stored, the process proceeds to step S219.

Moreover, in a case of determination that the variable i has a value other than 2 (the processing target is not the second VPDU from the left end of the image) in step S217, the process proceeds to step S219 while skipping the processing in step S218.

In step S219, the coding section 515 determines whether or not the variable i has a value of 2 or larger (i >=2). In a case of determination that the variable i has a value of 2 or larger, the process proceeds to step S220.

In step S220, the coding section 515 notifies a VPDU line T+1 processing Thread, which is a thread processing the VPDU line T+1 located one line below, of completion of the VPDU process. After completion of the VPDU process completion notification, the process proceeds to step S221.

Moreover, in a case of determination that the variable i has a value smaller than 2 (the processing target is the VPDU at the left end of the image) in step S219, the process proceeds to step S221 while skipping the processing in step S220.

In step S221, the coding section 515 adds 1 to the value of the variable i (i=i+1). After increment of the value of the variable i, the process returns to step S214.

In such a manner, the processing in each of the steps from step S214 to step S221 is repeated until completion of processing for all the VPDUs in the VPDU line T. Thereafter, in a case of determination that no unprocessed VPDU is present (all VPDUs in the VPDU line T have been processed) in step S214, this VPDU process ends, and the process returns to FIG. 21.

By executing the respective processes in the manner described above, the image coding apparatus 500 is capable of reducing a decrease in the degree of parallelism of coding.

### <5-3: Image Decoding Apparatus>

Moreover, for example, the present technology described above is applicable to an image decoding apparatus which decodes coded data obtained by coding image data.

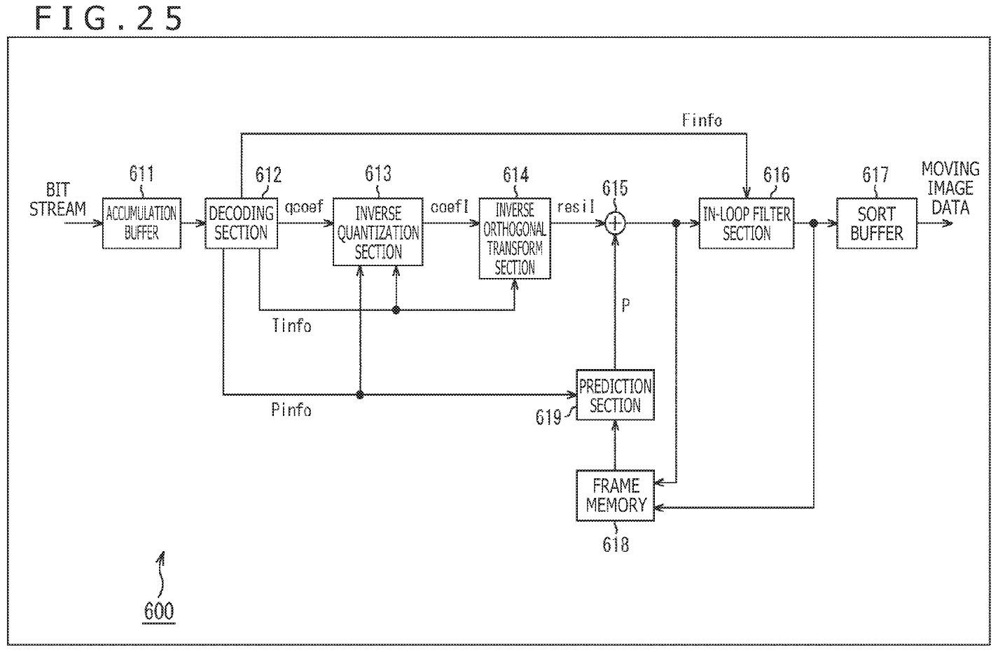

FIG. 25 is a block diagram depicting an example of a configuration of an image decoding apparatus according to an aspect of an image processing apparatus to which the present technology is applied. An image decoding apparatus 600 depicted in FIG. 25 is an apparatus which decodes coded data generated by coding a prediction residue between an image and a prediction image, such as AVC and HEVC. For example, the image decoding apparatus 600 incorporates the technologies described in NPL 1 to NPL 6, and decodes coded data obtained by coding image data of a moving image by using a method in conformity with standards described in any one of these references. For example, the image decoding apparatus 600 decodes coded data (bit stream) generated by the image coding apparatus 500 described above.

Note that FIG. 25 depicts only main processing sections and data flows. All processing sections and data flows are not necessarily contained in FIG. 25. Specifically, the image decoding apparatus 600 may include a processing section not depicted as a block in FIG. 25, or a process or a data flow not depicted as an arrow or the like in FIG. 25.

In FIG. 25, the image decoding apparatus 600 includes an accumulation buffer 611, a decoding section 612, an inverse quantization section 613, an inverse orthogonal transform section 614, a calculation section 615, an in-loop filter section 616, a sort buffer 617, a frame memory 618, and a prediction section 619. Note that the prediction section 619 includes a not-depicted intra prediction section and a not-depicted inter prediction section. The image decoding apparatus 600 is an apparatus for generating moving image data by decoding coded data (bit stream).

### <Accumulation Buffer>

The accumulation buffer 611 acquires a bit stream input to the image decoding apparatus 600, and retains (stores) the bit stream. The accumulation buffer 611 supplies an accumulated bit stream to the decoding section 612 at predetermined timing or in a case where a predetermined condition is met, for example.

### <Decoding Section>

The decoding section 612 performs a process associated with decoding of an image. For example, the decoding section 612 receives an input of a bit stream supplied from the accumulation buffer 611, and performs variable-length decoding of syntax values of respective syntax elements from the bit string in accordance with definitions of a syntax table to derive parameters.

Examples of the parameters derived from the syntax elements and the syntax values of the syntax elements include header information Hinfo, prediction mode information Pinfo, transform information Tinfo, residual information Rinfo, and filter information Finfo. Accordingly, the decoding section 612 parses (analyzes and acquires) these types of information from the bit stream. These types of information will be hereinafter described.

### <Header Information Hinfo>

For example, the header information Hinfo includes header information such as VPS (Video Parameter Set), SPS (Sequence ParameterSet), PPS (Picture Parameter Set), and SH (slice header). For example, the header information Hinfo includes information which specifies an image size (width PicWidth and height PicHeight), a bit depth (luminance bitDepthY, chrominance bitDepthC), chrominance array type ChromaArrayType, CU size maximum value MaxCUSize or minimum value MinCUSize, maximum depth MaxQTDepth or minimum depth MinQTDepth of quadtree division (also called a Quad-tree division), maximum depth MaxBTDepth or minimum depth MinBTDepth of binary tree division (Binary-tree division), maximum value MaxTSSize (also called a maximum transform skip block size) of a transform skip block, on-off flags (also called enabled flags) of respective coding tools, and the like.

For example, the on-off flags of the coding tools contained in the header information Hinfo include on-off flags associated with a transform and a quantization process presented below. Note that each of the on-off flags of the coding tools is allowed to be interpreted as a flag indicating whether or not syntax associated with the coding tool is present in coded data. Moreover, the on-off flag having a value of 1 (true) indicates that the coding tool is available, while the on-off flag having a value of 0 (false) indicates that the coding tool is unavailable. Note that the flag values may be interpreted to have meanings opposite of the above.

A cross-component prediction enabled flag (ccp_enabled_flag) is flag information indicating whether or not cross-component prediction (CCP (Cross-Component Prediction), also called a CC prediction) is available. For example, this flag information indicating “1” (true) represents that CCP is available, while this flag information indicating “0” (false) represents that CCP is unavailable.

Note that this CCP is also referred to as a cross-component linear prediction (CCLM or CCLMP).

### <Prediction Mode Information Pinfo>

For example, the prediction mode information Pinfo includes information such as size information PBsize (prediction block size) associated with a projection target PB (projection block), intra prediction mode information IPinfo, and motion prediction information MVinfo.

For example, the intra prediction mode information IPinfo includes prev_intra_luma_pred_flag, mpm_idx, and rem_intra_pred_mode in JCTVC-W1005, 7.3.8.5 Coding Unit syntax, a luminance intra prediction mode IntraPredModeY derived from this syntax, and the like.

Moreover, for example, the intra prediction mode information IPinfo includes a cross-component prediction flag (ccp_flag (cclmp_flag)), multi-class linear prediction mode flag (mclm_flag), a chrominance sample position type identifier (chroma_sample_loc_type_idx), a chrominance MPM identifier (chroma_mpm_idx), and a luminance lntra prediction mode (IntraPredModeC) derived from these types of syntax, and the like.

The cross-component prediction flag (ccp_flag (cclmp_flag)) is flag information indicating whether or not to apply cross-component linear prediction. For example, ccp_flag==1 indicates that cross-component prediction is to be applied, while ccp_flag==0 indicates that cross-component prediction is not to be applied.

The multi-class linear prediction mode flag (mclm_flag) is information associated with a mode of linear prediction (linear prediction mode information). More specifically, the multi-class linear prediction mode flag (mclm_flag) is flag information indicating whether or not to adopt the multi-class linear prediction mode. For example, “0” indicates one class mode (single class mode) (e.g., CCLMP), while “1” indicates two class mode (multi-class mode) (e.g., MCLMP).

The chrominance sample position type identifier (chroma_sample_loc_type_idx) is an identifier which identifies a type of a pixel position of a chrominance component (also referred to as a chrominance sample position type). For example, in a case where a chrominance array type (ChromaArrayType) which is information associated with a color format indicates a 420-type format, the chrominance sample position type identifier adopts allocation in a manner represented by following Equation (4).

[Math.4]

chroma_sample_loc_type_idx==0:Type2chroma_sample_loc_type_idx==1:Type3chroma_sample_loc_type_idx==2:Type0chroma_sample_loc_type_idx==3:Type1 (4)

Note that the chrominance sample position type identifier (chroma_sample_loc_type_idx) is transferred (while being stored) as information associated with the chrominance component pixel position (chroma_sample_loc_info( )).

The chrominance MPM identifier (chroma_mpm_idx) is an identifier indicating which prediction mode candidate in a chrominance intra prediction mode candidate list (intraPredModeCandListC) is to be designated as a chrominance intra prediction mode.

For example, the motion prediction information MVinfo includes merge_idx, merge_flag, inter_pred_idc, ref_idx_LX, mvp_1X_flag, X={0, 1}, mvd, and the like (e.g., see JCTVC-W1005, 7.3.8.6, see Prediction Unit Syntax).

Needless to say, the prediction mode information Pinfo may include any information, and may include information other than the types of information described above.

### <Transform Information Tinfo>

For example, the transform information Tinfo includes following types of information. Needless to say, the transform information Tinfo may include any information, and may include information other than the types of information described above.

The width size TBWSize and the height TBHSize of a processing target transform block (or log2TBWSize and log2TBHSize which are binary logarithms of TBWSize and TBHSize, respectively, are allowed). A transform skip flag (ts_flag) is a flag indicating whether or not to skip (inverse) primary transform and (inverse) secondary transform.

Scanning Identifier (scanIdx)

Quantization Parameter (Qp)

Quantization matrix (scaling_matrix (e.g., JCTVC-W1005, 7.3.4 Scaling list data syntax))

### <Residual Information Rinfo>

For example, the residual information Rinfo (e.g., see 7.3.8.11 Residual Coding syntax of JCTVC-W1005) includes following types of syntax.

cbf (coded_block_flag): residual data presence/absence flag

last_sig_coeff_x_pos: last non-zero coefficient X coordinate

last_sig_coeff_y_pos: last non-zero coefficient Y coordinate

coded_sub_block_flag: sub block non-zero coefficient presence/absence flag

sig_coeff flag: non-zero coefficient presence/absence flag

gr1_flag: flag indicating whether or not non-zero coefficient level is larger than 1 (also called GR1 flag)

gr2_flag: flag indicating whether or not non-zero coefficient level is larger than 2 (also called GR2 flag)

sign_flag: symbol indicating plus or minus sign of non-zero coefficient (also called a sign symbol)

coeff_abs_level remaining: remaining level of non-zero coefficient (also called a non-zero coefficient remaining level), and others

Needless to say, the residual information Rinfo may include any information, and may include information other than the types of information described above.

### <Filter Information Finfo>

For example, the filter information Finfo includes control information associated with respective filtering processes presented below.

control information associated with a deblocking filter (DBF)

control information associated with an adaptive offset filter (SAO)

control information associated with an adaptive loop filter (ALF)

control information associated with other linear or non-linear filters

More specifically, for example, the filter information includes information designating a picture to which respective filters are applied, or designating a region within the picture, filter on-off control information in units of CU, filter on-off control information associated with a boundary of a slice and a tile, and the like. Needless to say, the filter information Finfo may include any information, and may include information other than the types of information described above.

Returning to the description about the decoding section 612, the decoding section 612 derives a quantization transform coefficient level qcoef of each of coefficient positions within each of transform blocks with reference to the residual information Rinfo. The decoding section 612 supplies the quantization transform coefficient level qcoef thus obtained to the inverse quantization section 613.

Moreover, the decoding section 612 supplies the header information Hinfo, the prediction mode information Pinfo, the quantization transform coefficient level qcoef, the transform information Tinfo, and the filter information Finfo, each of which has been parsed, to the respective blocks. Specifically, followings are performed.

The header information Hinfo is supplied to the inverse quantization section 613, the inverse orthogonal transform section 614, the prediction section 619, and the in-loop filter section 616. The prediction mode information Pinfo is supplied to the inverse quantization section 613 and the prediction section 619. The transform information Tinfo is supplied to the inverse quantization section 613 and the inverse orthogonal transform section 614. The filter information Finfo is supplied to the in-loop filter section 616.

Needless to say, the example described above is presented by way of example, and not required to be adopted. For example, the respective coding parameters may be supplied to any processing section. Moreover, other types of information may be supplied to any processing section.

### <Inverse Quantization Section>

The inverse quantization section 613 performs a process associated with inverse quantization. For example, the inverse quantization section 613 receives an input of the transform information Tinfo and the quantization transform coefficient level qcoef supplied from the decoding section 612, and scales (inversely quantizes) the value of the quantization transform coefficient level, on the basis of the transform information Tinfo, to derive a transform coefficient coefI inversely quantized.

Note that this inverse quantization is an inverse process of quantization performed by the quantization section 514. Moreover, this inverse quantization is a process similar to the inverse quantization performed by the inverse quantization section 517. Accordingly, the inverse quantization section 517 performs a process (inverse quantization) similar to the process of the inverse quantization section 613.

The inverse quantization section 613 supplies the derived transform coefficient coefI to the inverse orthogonal transform section 614.

### <Inverse Orthogonal Transform Section>

The inverse orthogonal transform section 614 performs a process associated with inverse orthogonal transform. For example, the inverse orthogonal transform section 614 receives an input of the transform coefficient coefI supplied from the inverse quantization section 613, and the transform information Tinfo supplied from the decoding section 612, and performs an inverse orthogonal transform process for the transform coefficient coefI, on the basis of the transform information Tinfo, to derive a prediction residue resiI.

Note that this inverse orthogonal transform is an inverse process of orthogonal transform performed by the orthogonal transform section 513. Moreover, this inverse orthogonal transform is a process similar to the inverse orthogonal transform performed by the inverse orthogonal transform section 518. Accordingly, the inverse orthogonal transform section 518 performs a process (inverse orthogonal transform) similar to the process of the inverse orthogonal transform section 614.

The inverse orthogonal transform section 614 supplies the derived prediction residue resiI to the calculation section 615.

### <Calculation Section>

The calculation section 615 performs a process associated with addition of information relating to an image. For example, the calculation section 615 receives an input of the prediction residue resiI supplied from the inverse orthogonal transform section 614, and a prediction image P supplied from the prediction section 619. The calculation section 615 adds the prediction residue resiI to the prediction image P (prediction signal) corresponding to the prediction residue resiI to derive a locally decoded image Rlocal as represented in following Equation (5).

[Math.5]

Rlocal=resiI+P (5)

The calculation section 615 supplies the derived locally decoded image Rlocal to the in-loop filter section 616 and the frame memory 618.

### <In-Loop Filter Section>

The in-loop filter section 616 performs a process associated with in-loop filtering. For example, the in-loop filter section 616 receives an input of the locally decoded image Rlocal supplied from the calculation section 615, and the filter information Finfo supplied from the decoding section 612. Note that information input to the in-loop filter section 616 may be any information, and may receive an input of information other than the above information.

The in-loop filter section 616 performs filtering for the locally decoded image Rlocal as appropriate on the basis of the filter information Finfo.

For example, the in-loop filter section 616 applies four in-loop filters, i.e., a bilateral filter, a deblocking filter (DBF (DeBlocking Filter)), an adaptive offset filter (SAO (Sample Adaptive Offset)), and an adaptive loop filter (ALF (Adaptive Loop Filter)) in this order. Note that which filters to be applied and in what order the filters are applied may be selected in any manner as appropriate.

The in-loop filter section 616 performs a filtering process corresponding to the filtering process performed by the coding side (e.g., the in-loop filter section 520 of the image coding apparatus 500). Needless to say, filtering performed by the in-loop filter section 616 may be any process, and is not limited to the example described above. For example, the in-loop filter section 616 may apply a Wiener filter or the like.

The in-loop filter section 616 supplies the filtered locally decoded image Rlocal to the sort buffer 617 and the frame memory 618.

### <Sort Buffer>

The sort buffer 617 receives an input of the locally decoded image Rlocal supplied from the in-loop filter section 616, and retains (stores) the locally decoded image Rlocal. The sort buffer 617 reconstructs a decoded image R for each picture unit using the locally decoded image Rlocal, and retains the decoded image R (stores the decoded images R in a buffer). The sort buffer 617 rearranges the obtained decoded images R from the decoding order to the reproduction order. The sort buffer 617 outputs a group of the rearranged decoded images R to the outside of the image decoding apparatus 600 as moving image data.

### <Frame Memory>

The frame memory 618 performs a process associated with storage of data concerning images. For example, the frame memory 618 receives an input of the locally decoded image Rlocal supplied from the calculation section 615, reconstructs the decoded image R for each picture unit using the locally decoded image Rlocal, and stores the decoded images R in a buffer within the frame memory 618.

Moreover, the frame memory 618 receives an input of the locally decoded image Rlocal in-loop filtered and supplied from the in-loop filter section 616, reconstructs the decoded image R for each picture unit, and retains the decoded image R in the buffer within the frame memory 618. The frame memory 618 supplies the stored decoded image R (or a part of the decoded image R) to the prediction section 619 as a reference image as appropriate.

Note that the frame memory 618 may store the header information Hinfo, the prediction mode information Pinfo, the transform information Tinfo, the filter information Finfo, and the like each associated with formation of the decoded image.

### <Prediction Section>

The prediction section 619 performs a process associated with formation of a prediction image. For example, the prediction section 619 receives an input of the prediction mode information Pinfo supplied from the decoding section 612, and performs prediction using a prediction method designated by the prediction mode information Pinfo to derive a prediction image P. At the time of this derivation, the prediction section 619 uses, as a reference image, the decoded image R (or a part of the decoded image R) before and after filtering designated by the prediction mode information Pinfo and stored in the frame memory 618. The prediction section 619 supplies the derived prediction image P to the calculation section 615.

### <Application of Present Technology>

The present technology described in <3. Concept> and <4.1 Method 1> is applied to the image decoding apparatus 600 having the configuration described above. In other words, the decoding section 612 applies WPP for each transform block. For example, the decoding section 612 decodes coded data obtained by coding coefficient data associated with an image in parallel for each line of transform blocks each of which is a unit of transforming image data into coefficient data.

“Method 1” may be applied to the image decoding apparatus 600 described above. For example, the decoding section 612 may set the VPDUs 121 for each of the CTUs 111, and perform decoding in parallel for each of VPDU lines (applies WPP for each of VPDU lines). Moreover, the decoding section 612 may execute a process for each of VPDU lines with a delay of 2 VPDUs from a VPDU line located one line above.

Furthermore, “method 1-1” or “method 1-2” may be applied to the image decoding apparatus 600 described above.

Specifically, the decoding section 612 may use CABAC context different for each processing of the VPDUs 121 in each of the stages within the CTU 111. Besides, context of decoding may be inherited (copied) between VPDU lines.

For example, the decoding section 612 may decode coded data of each line of transform blocks of coefficient data associated with an image sequentially transform block by transform block from the left transform block. Moreover, the decoding section 612 may entropy-decode coded data of each transform block using an occurrence probability derived by entropy-decoding one decoding before.

Furthermore, for example, the decoding section 612 may entropy-decode coded data of the leftmost transform block in the uppermost transform block line in the image using an initial occurrence probability value. In addition, the decoding section 612 may entropy-decode coded data of each of the leftmost transform blocks in the second uppermost transform block line and the transform block lines below the second uppermost transform block line in the image using an occurrence probability derived by entropy-decoding coded data of the second leftmost transform block in the transform block line located one line above.

Moreover, “method 1-3” may be applied to the image decoding apparatus 600 described above. In other words, the prediction section 619 may impose a partial mode limitation on intra prediction. For example, “method 1-3-1” may be applied to the image decoding apparatus 600 described above. Specifically, the prediction section 619 may perform intra prediction while making reference to a lower right VPDU of a CTU processed one CTU before (i.e., CTU located next to the left) to be unavailable.

For example, for intra prediction of an upper left transform block of a coding tree unit in the uppermost order of a coding block of a tree structure, the prediction section 619 may perform intra prediction while making reference to a lower right transform block of a coding tree unit coded one unit before to be unavailable.

Moreover, “method 1-4” may be applied to the image decoding apparatus 600 described above. In other words, the prediction section 619 may impose a limitation on intra prediction. For example, “method 1-4-1” may be applied to the image decoding apparatus 600 described above. Specifically, for inter prediction designating an upper left VPDU of a CTU as a current prediction block, the prediction section 619 may perform inter prediction while making reference to an inter prediction mode and a motion vector of a lower right VPDU of a CTU processed one CTU before (i.e., CTU located next to the left) to be unavailable.

For example, for inter prediction of an upper left transform block of a coding tree unit in the uppermost order of a coding block of a tree structure, the prediction section 619 may perform inter prediction while making reference to a motion vector of a lower right transform block of a coding tree unit coded one unit before to be unavailable.

Moreover, for example, “method 1-4-2” may be applied to the image decoding apparatus 600 described above. Specifically, for inter prediction of a prediction block having a block size of 128×N, the prediction section 619 may perform inter prediction while making reference to an inter prediction mode and a motion vector of a block located on the upper right of the prediction block to be unavailable.

For example, for inter prediction of a prediction block which is a processing unit of inter prediction, and has the same horizontal length as that of a coding tree unit in the highest order of a coding block of a tree structure, the prediction section 619 may make reference to a motion vector of an upper right transform block to be unavailable.

Moreover, for example, “method 1-4-3” may be applied to the image decoding apparatus 600 described above. Specifically, for a prediction block having a block size of N×128 for which inter prediction has been performed, the decoding section 612 may decode coded data of mode information indicating an inter prediction mode for each prediction block, and may decode coded data of coefficient data (residual) associated with residual data between an image and a prediction image for each transform block.

For example, for prediction blocks each of which is a processing unit of inter prediction and has the same horizontal length as that of a coding tree unit in the highest order of a coding block of a tree structure, the decoding section 612 may decode coded data of mode information indicating a mode of inter prediction for each of the prediction blocks, and may decode coded data of residual data between an image and a prediction image for each transform block contained in the prediction blocks.

The image decoding apparatus 600 thus configured is capable of reducing a decrease in the degree of parallelism of decoding, and therefore is capable of reducing an increase in a processing time.

### <5-4: Flow of Process>

### <Flow of Image Decoding Process>

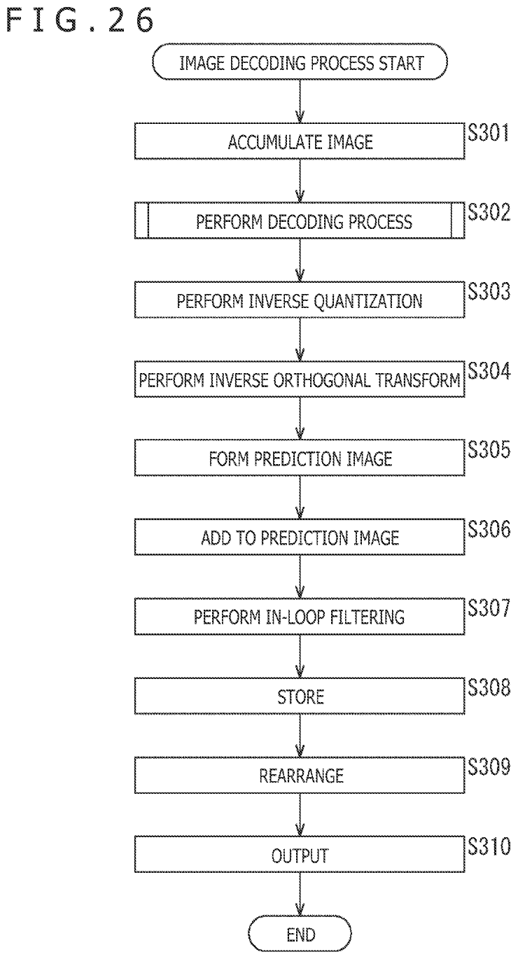

Described next will be flows of respective processes executed by the image decoding apparatus 600 described above. An example of a flow of an image decoding process will be initially described with reference to a flowchart in FIG. 26.

At a start of the image decoding process, the accumulation buffer 611 in step S301 acquires coded data (bit stream) supplied from the outside of the image decoding apparatus 600, and retains (accumulates) the coded data.

In step S302, the decoding section 612 performs a decoding process to decode coded data (bit stream) and obtain a quantization transform coefficient level qcoef. Moreover, the decoding section 612 parses (analyzes and acquires) various types of coding parameters from the coded data (bit stream) by this decoding. Details of this decoding process will be described below.

In step S303, the inverse quantization section 613 performs inverse quantization, which is an inverse process of quantization performed on the coding side, for the quantization transform coefficient level qcoef obtained by the processing in step S302, and obtains a transform coefficient coefI.

In step S304, the inverse orthogonal transform section 614 performs an inverse orthogonal transform process, which is an inverse process of an orthogonal transform process performed on the coding side, for the transform coefficient coefI obtained by the processing in step S303, and obtains a prediction residue resiI.

In step S305, the prediction section 619 executes a prediction process using a prediction method designated on the coding side on the basis of the information parsed in step S302, and forms a prediction image P with reference to a reference image stored in the frame memory 618, for example.

In step S306, the calculation section 615 adds the prediction residue resiI obtained by the processing in step S304 to the prediction image P obtained by the processing in step S305 to derive a locally decoded image Rlocal.

In step S307, the in-loop filter section 616 performs an in-loop filtering process for the locally decoded image Rlocal obtained by the processing in step S306.

Moreover, in step S308, the frame memory 618 stores at least either the locally decoded image Rlocal obtained by the processing in step S306, or the locally decoded image Rlocal filtered and obtained by the processing in step S307.

In step S309, the sort buffer 617 derives a decoded image R using the locally decoded image Rlocal filtered and obtained by the processing in step S307, and rearranges a group of the decoded images R from a decoding order to a reproduction order.

In step S310, the sort buffer 617 outputs the group of the decoded images R which have been rearranged in the reproduction order to the outside of the image decoding apparatus 600 as moving images. After completion of the processing in step S310, the image decoding process ends.

In the decoding process executed in step S302 of the image decoding process described above, the decoding section 612 decodes coded data obtained by coding coefficient data associated with the image in parallel for each line of transform blocks each of which is a unit of transforming image data into coefficient data. In such a manner, the image decoding apparatus 600 is capable of reducing a decrease in the degree of parallelism of decoding, and therefore is capable of reducing an increase in a processing time.

### <Flow of Decoding Process>

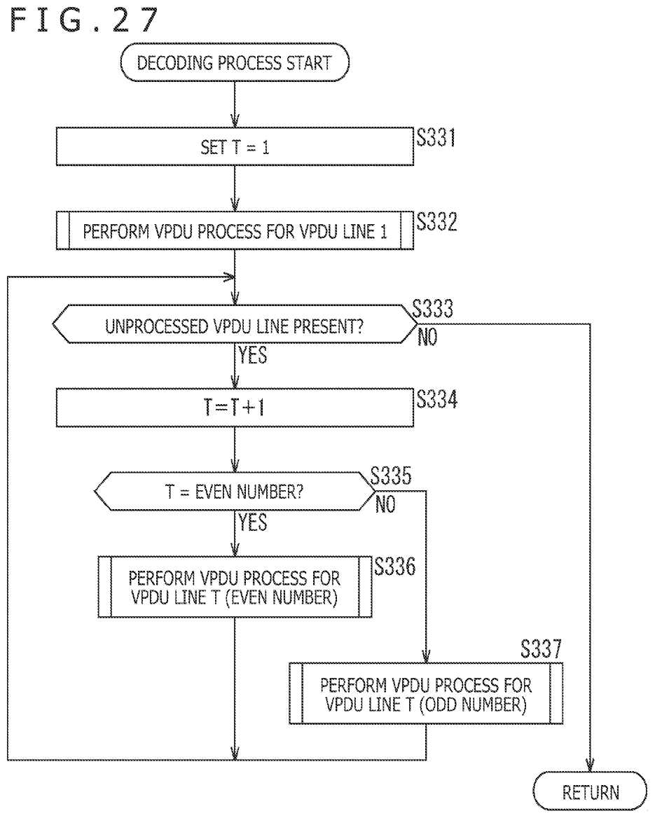

An example of a flow of the decoding process executed in step S302 in FIG. 26 will be subsequently described with reference to a flowchart in FIG. 27.

At a start of the decoding process, the decoding section 612 in step S331 sets a variable T indicating a position of the VPDU line designated as a processing target (line number from the upper side in the image) to an initial value (=1).

In step S332, the decoding section 612 performs a VPDU process for a VPDU line 1 which is the first VPDU line from the upper side of the image. Details of this process will be described below. After completion of the process performed for the VPDU line 1, the process proceeds to step S333.

In step S333, the decoding section 612 determines whether or not an unprocessed VPDU line is present. In a case of determination that unprocessed VPDU line is present without completion of processing of the VPDU line on the lowermost stage of the image, the process proceeds to step S334.

In step S334, the decoding section 612 adds 1 to the value of the variable T (T=T+1). After increment of the value of the variable T, the process proceeds to step S335.

In step S335, the decoding section 612 determines whether or not the variable T is an even number. In a case of determination that the variable T is an even number (i.e., a current VPDU line T is the even-numbered VPDU line from the upper side of the image, and a current VPDU is a VPDU in a lower stage within a CTU), the process proceeds to step S336.

In step S336, the decoding section 612 performs a VPDU process for a VPDU line T (even number) which is a Tth VPDU line (i.e., even-numbered line) from the upper side of the image. Details of this process will be described below. After completion of the process performed for the VPDU line T (even number), the process returns to step S333.

Moreover, in step S335, in a case of determination that the variable T (excluding T=1) is an odd number (i.e., the current VPDU line T is an odd-numbered VPDU line from the upper side of the image (an odd-numbered line excluding the first line from the upper side), and that the current VPDU is a VPDU in an upper stage within the CTU), the process proceeds to step S337.

In step S337, the decoding section 612 performs a VPDU process for a VPDU line T (odd number) which is a Tth VPDU line from the upper side of the image (i.e., an odd-numbered line excluding the first line from the upper side). Details of this process will be described below. After completion of the process performed for the VPDU line T (odd number), the process returns to step S333.

Accordingly, the processing in each of the steps from step S333 to step S336 (or from step S333 to step S335, and step S337) is repeated until completion of all the VPDU lines. Thereafter, in a case of determination that no unprocessed VPDU line is present (all VPDU lines have been processed) in step S333, the decoding process ends, and the process returns to FIG. 26.

### <Flow of VPDU Process for VPDU Line 1>

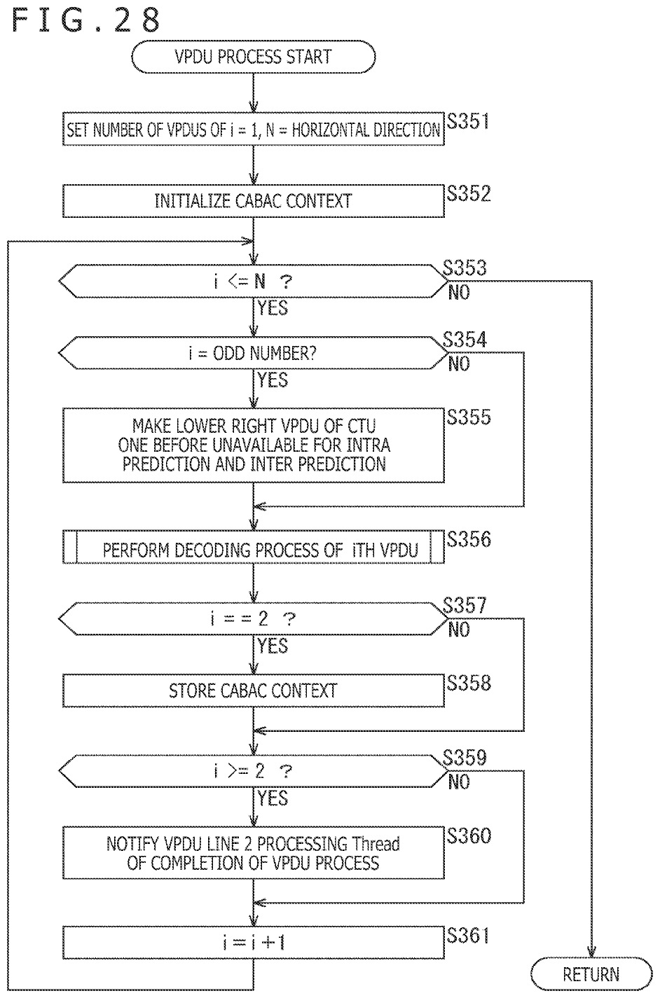

An example of a flow of the VPDU process for the VPDU line 1 executed in step S332 in FIG. 27 will be subsequently described with reference to a flowchart in FIG. 28.

At a start of the VPDU process, the decoding section 612 in step S351 sets a variable i indicating a position of a current VPDU (VPDU number from the left end of the image) to an initial value (=1). Moreover, the decoding section 612 sets a number N to the number of VPDUs in the horizontal direction.

In step S352, the decoding section 612 initializes CABAC context (occurrence probability).

In step S353, the decoding section 612 determines whether or not a variable i is N or smaller (i<=N). In a case of determination that the variable i is N or smaller and that an unprocessed VPDU is present in the VPDU line 1, the process proceeds to step S354.

In step S354, the decoding section 612 determines whether or not the variable i is an odd number. In a case of determination that the variable i is an odd number (i.e., the current VPDU is an upper left VPDU of a CTU), the process proceeds to step S355.

In step S355, for intra prediction and inter prediction, the decoding section 612 makes reference to a lower right VPDU of a CTU located one CTU before to be unavailable. After completion of the processing in step S355, the process proceeds to step S356.

Moreover, in step S354, in a case of determination that the variable i is an even number (i.e., the current VPDU is an upper right VPDU of the CTU), the process proceeds to step S356 while skipping the processing in step S355.

In step S356, the decoding section 612 executes a VPDU decoding process to decode coded data of an ith VPDU from the left end. This VPDU decoding process will be described below. After decoding the coded data of the ith VPDU from the left end, the process proceeds to step S357.

In step S357, the decoding section 612 determines whether or not the variable i has a value of 2 (i==2). In a case of determination that the variable i has a value of 2, the process proceeds to step S358.

In step S358, the decoding section 612 stores CABAC context (occurrence probability) associated with the second VPDU from the left end of the image and generated in step S356. After the context is stored, the process proceeds to step S359.

Moreover, in a case of determination that the variable i has a value other than 2 (the processing target is not the second VPDU from the left end of the image) in step S357, the process proceeds to step S359 while skipping the processing in step S358.

In step S359, the decoding section 612 determines whether or not the variable i has a value of 2 or larger (i >=2). In a case of determination that the variable i has a value of 2 or larger, the process proceeds to step S360.

In step S360, the decoding section 612 notifies a VPDU line 2 processing Thread, which is a thread processing a VPDU line 2, of completion of the VPDU process. After completion of the VPDU process completion notification, the process proceeds to step S361.

Moreover, in a case of determination that the variable i has a value smaller than 2 (the processing target is the VPDU at the left end of the image) in step S359, the process proceeds to step S361 while skipping the processing in step S360.

In step S361, the decoding section 612 adds 1 to the value of the variable i (i=i+1). After increment of the value of the variable i, the process returns to step S353.

Accordingly, the processing in each of the steps from step S353 to step S361 is repeated until completion of all the VPDUs in the VPDU line 1. Thereafter, in a case of determination that no unprocessed VPDU is present (all VPDUs in the VPDU line 1 have been processed) in step S353, the VPDU process ends, and the process returns to FIG. 27.

### <Flow of VPDU Decoding Process>

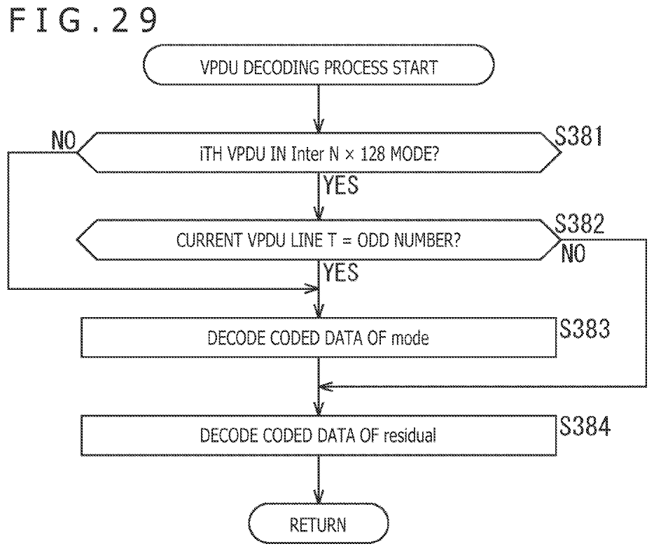

An example of a flow of the VPDU decoding process executed in step S356 in FIG. 28 and other steps, for example, will be subsequently described with reference to a flowchart in FIG. 29.

At a start of the VPDU decoding process, the decoding section 612 in step S381 determines whether or not an ith VPDU (i.e., current VPDU) is in Inter N×128 mode (i.e., included in a prediction block having a block size of N×128 for which inter prediction has been performed). In a case of determination that the ith VPDU is in Inter N×128 mode, the process proceeds to step S382.

In step S382, the decoding section 612 determines whether or not a variable T is an odd number, i.e., whether or not a current VPDU line T as a processing target is an odd-numbered VPDU line from the upper side of the image. In a case of determination that the variable T is an odd number, the process proceeds to step S383.

Moreover, in a case of determination that the current VPDU is not in Inter N×128 mode in step S381, the process proceeds to step S383 while skipping the processing in step S382.

In this case, the current VPDU is a VPDU located in an upper stage within a CTU, and therefore the decoding section 612 decodes coded data of mode information in step S383. After the coded data of the mode information is decoded, the process proceeds to step S384.

In addition, in step S382, in a case of determination that the variable T is an even number (i.e., the current VPDU line T is an even-numbered VPDU line from the upper side of the image, and the current VPDU is a VPDU in a lower stage within the CTU), a decoded result of the VPDU in the upper stage of the corresponding CTU is applied. In this case, the process proceeds to step S384 while skipping the processing in step S383.

In step S384, the decoding section 612 decodes coded data of coefficient data (residual) associated with residual data between the image and a prediction image for the current VPDU. After completion of the processing in step S384, the VPDU decoding process ends, and the process returns to the VPDU process which has executed the VPDU decoding process.

### <Flow of VPDU Process for VPDU Line T (Even Number)>

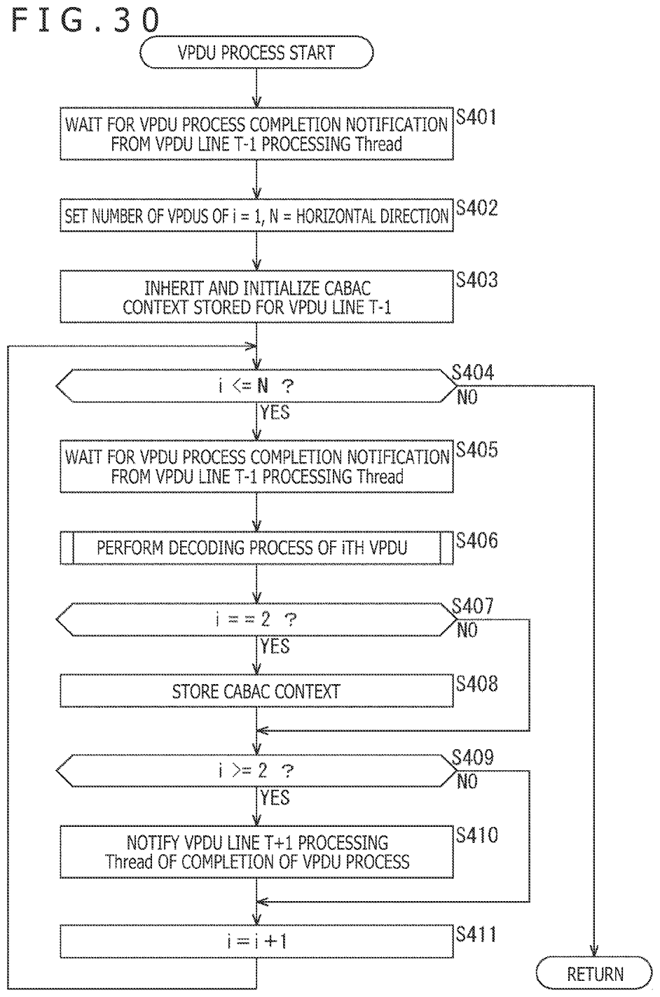

An example of a flow of the VPDU process for a VPDU line T (even number) executed in step S336 in FIG. 27 will be subsequently described with reference to a flowchart in FIG. 30.

At a start of the VPDU process in this case, the decoding section 612 in step S401 waits until reception of a VPDU process completion notification from a VPDU line T−1 processing Thread which is a thread processing a VPDU line T−1 one line above. After acquisition of the VPDU process completion notification from the VPDU line T−1 processing Thread, the process proceeds to step S402.

In step S402, the decoding section 612 sets a variable i to an initial value (=1). Moreover, the decoding section 612 sets a number N to the number of VPDUs in the horizontal direction.

In step S403, the decoding section 612 inherits CABAC context (occurrence probability) stored by the VPDU process of the VPDU line T−1 one line above, and initializes CABAC.

In step S404, the decoding section 612 determines whether or not the variable i is N or smaller (i<=N). In a case of determination that the variable i is N or smaller and that an unprocessed VPDU is present in the VPDU line T, the process proceeds to step S405.

In step S405, the decoding section 612 waits until acquisition of a VPDU process completion notification from the VPDU line T−1 processing Thread to control processing timing. After acquisition of the VPDU process completion notification from the VPDU line T−1 processing Thread, the process proceeds to step S406.

In step S406, the decoding section 612 executes a VPDU decoding process (FIG. 29) to decode coded data of an ith VPDU from the left end. After decoding of the coded data of the ith VPDU from the left end, the process proceeds to step S407.

In step S407, the decoding section 612 determines whether or not the variable i has a value of 2 (i==2). In a case of determination that the variable i has a value of 2, the process proceeds to step S408.

In step S408, the decoding section 612 stores CABAC context (occurrence probability) associated with the second VPDU from the left end of the image and generated in step S406. After the context is stored, the process proceeds to step S409.

Moreover, in a case of determination that the variable i has a value other than 2 (the processing target is not the second VPDU from the left end of the image) in step S407, the process proceeds to step S409 while skipping the processing in step S408.

In step S409, the decoding section 612 determines whether or not the variable i has a value of 2 or larger (i >=2). In a case of determination that the variable i has a value of 2 or larger, the process proceeds to step S410.

In step S410, the decoding section 612 notifies a VPDU line T+1 processing Thread, which is a thread processing a VPDU line T+1 located one line below, of completion of the VPDU process. After completion of the VPDU process completion notification, the process proceeds to step S411.

Moreover, in a case of determination that the variable i has a value smaller than 2 (the processing target is the VPDU at the left end of the image) in step S409, the process proceeds to step S411 while skipping the processing in step S410.

In step S411, the decoding section 612 adds 1 to the value of the variable i (i=i+1). After increment of the value of the variable i, the process returns to step S404.

In other words, the processing in each of the steps from step S404 to step S411 is repeated until completion of all the VPDUs in the VPDU line T. Thereafter, in a case of determination that no unprocessed VPDU is present (all VPDUs in the VPDU line T have been processed) in step S404, the VPDU process ends, and the process returns to FIG. 27.

### <Flow of VPDU Process for VPDU Line T (Odd Number)>

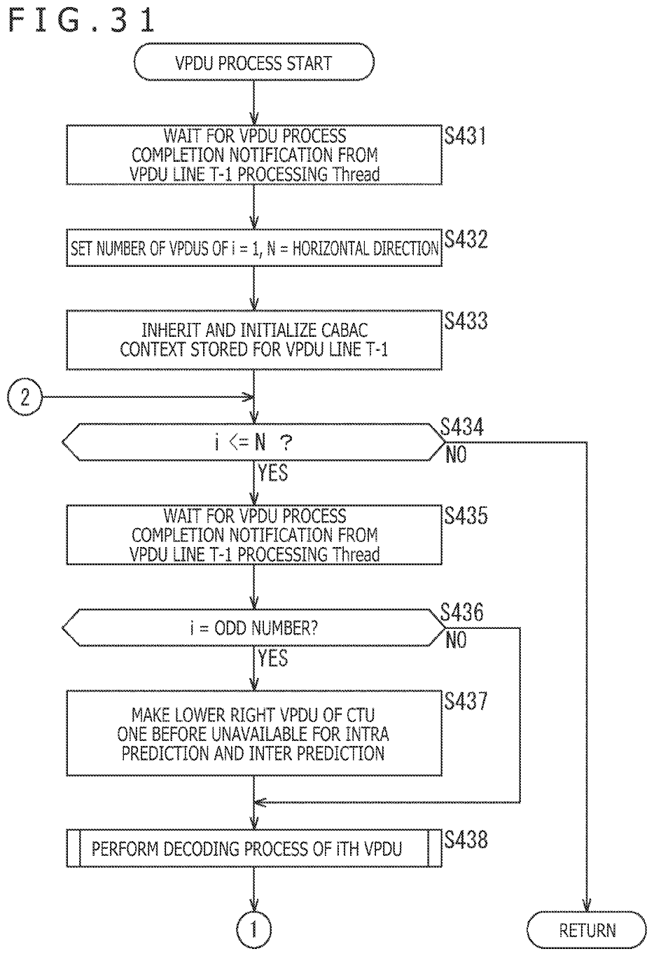

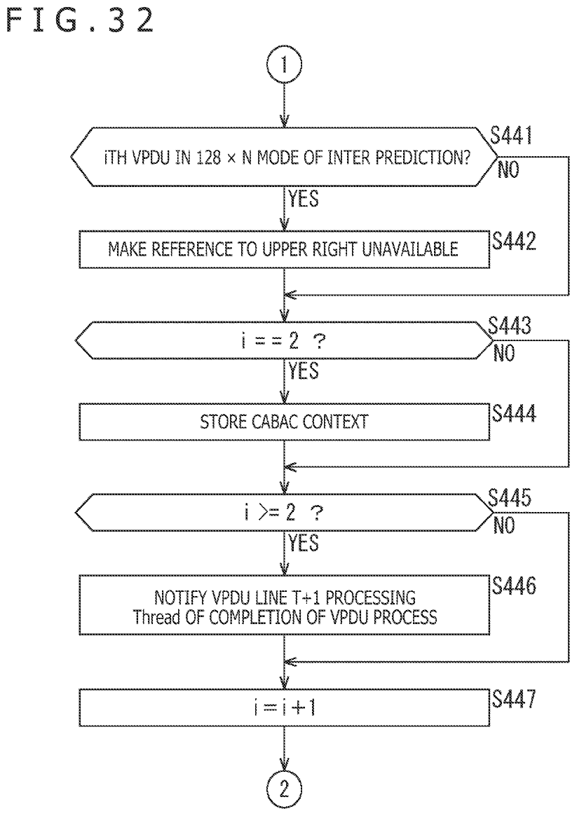

An example of a flow of the VPDU process for a VPDU line T (odd number) (i.e., VPDU process for an odd-numbered VPDU line excluding the first line from the upper side) executed in step S337 in FIG. 27 will be subsequently described with reference to flowcharts in FIGS. 31 and 32.

At a start of the VPDU process in this case, processing in each of steps from step S431 to step S435 in FIG. 31 is executed similarly to the processing in the each of the steps from step S401 to step S405 in FIG. 30. After completion of step S435, the process proceeds to step S436.

In step S436, the decoding section 612 determines whether or not the variable i is an odd number. In a case of determination that the variable i is an odd number (i.e., a current VPDU is an upper left VPDU of a CTU), the process proceeds to step S437.

In step S437, for intra prediction and inter prediction, the decoding section 612 makes reference to a lower right VPDU of a CTU located one CTU before to be unavailable. After completion of step S437, the process proceeds to step S438.

Moreover, in step S436, in a case of determination that the variable i is an even number (i.e., the current VPDU is an upper right VPDU of the CTU), the process proceeds to step S438 while skipping the processing in step S437.

In step S438, the decoding section 612 executes the VPDU decoding process (FIG. 29) to decode coded data of an ith VPDU from the left end. After decoding of the coded data of the ith VPDU from the left end, the process proceeds to step S441 in FIG. 31.

In step S441 in FIG. 31, the decoding section 612 determines whether or not the ith VPDU is in Inter N×128 mode (i.e., included in a prediction block having a block size of N×128 for which inter prediction has been performed). In a case of determination that the ith VPDU is in Inter 128×N mode, the process proceeds to step S442.

In this case, the current VPDU is included in the prediction block having the block size 128×N for which inter prediction has been performed, and therefore the decoding section 612 in step S442 makes reference to a block located on the upper right of the prediction block to be unavailable. After completion of step S442, the process proceeds to step S443.

In addition, in a case of determination that the ith VPDU is not in Inter 128×N mode in step S441, the process proceeds to step S443.

Thereafter, processing in each of steps from step S443 to step S447 is executed similarly to the processing in each of the steps from step S407 to step S411 in FIG. 30. After completion of step S447, the process returns to step S434 in FIG. 31.

In other words, the processing in each of the steps from step S434 to step S438 in FIG. 31, and in each of the steps from step S441 to step S447 in FIG. 32 is repeatedly executed until completion of all the VPDUs in the VPDU line T. Thereafter, in a case of determination that no unprocessed VPDU is present (all VPDUs in the VPDU line T have been processed) in step S434 in FIG. 31, this VPDU process ends, and the process returns to FIG. 27.

By executing the respective processes in the manner described above, the image decoding apparatus 600 is capable of reducing a decrease in the degree of parallelism of decoding.

### <6. Method 2>

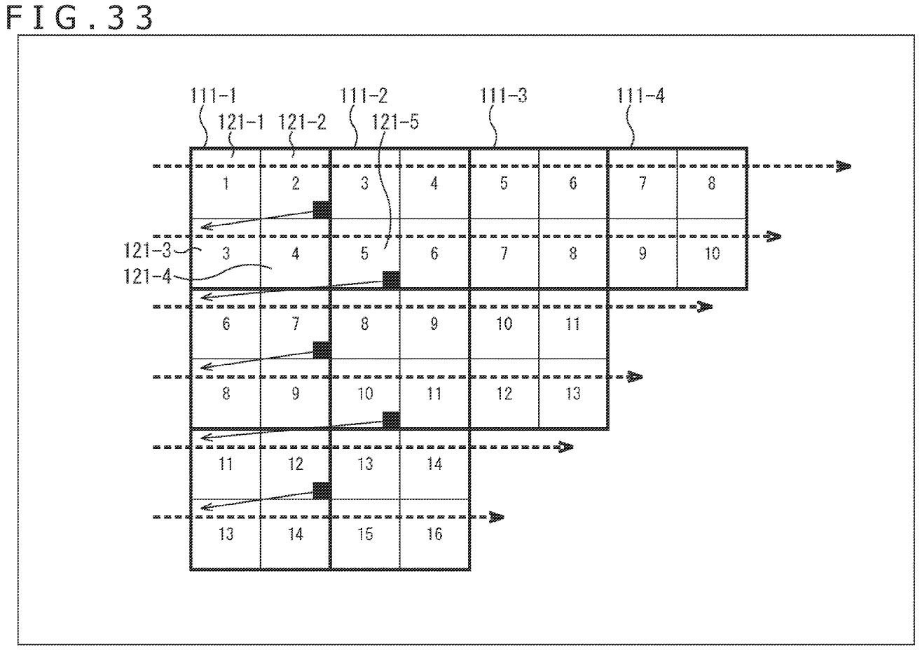

Subsequently described in detail will be “method 2” described above. FIG. 33 depicts a part of an image corresponding to a coding target similarly to FIG. 6. According to method 2, processes (entropy-coding and entropy-decoding) are parallelized for each line of the VPDUs 121 as indicated by dotted arrows in FIG. 33 similarly to the case of method 1. In the case of method 2, however, a process for an even-numbered VPDU line from the upper side is executed with a delay of 2 VPDUs from a VPDU line one line above the even-numbered VPDU line, a process for an odd-numbered VPDU line excluding the first line from the upper side is executed with a delay of 3 VPDUs from a VPDU line one line above the odd-numbered VPDU line.

In FIG. 33, a numeral contained in each of the VPDUs 121 indicates a processing order. As can be seen from the figure, a pipeline delay of 2 VPDUs is produced within a CTU, and a pipeline delay of 3 VPDUs is produced between CTUs.

### <6-1: Method 2-1, Method 2-2>

In method 2-1, CABAC context different for each processing of the VPDUs 121 in each of the stages within the CTU 111 is used. Moreover, in method 2-2, CABAC context is inherited (copied) between VPDU lines.

As described above, each of VPDUs in each of VPDU lines is processed using an occurrence probability derived at the time of VPDU processing one processing before as context. However, the VPDU at the left end of the uppermost VPDU line in the image is processed using an initial context value. Moreover, a VPDU at the left end of an even-numbered VPDU line from the upper side is processed using an occurrence probability derived at the time of the second VPDU from the left end in a VPDU line located one line above a current VPDU line as indicated by a black square and an arrow in FIG. 33. Moreover, a VPDU at the left end of an odd-numbered VPDU line from the upper side excluding the first line is processed using an occurrence probability derived at the time of the third VPDU from the left end in a VPDU line one line above the current VPDU line as indicated by a black square and an arrow in FIG. 33.

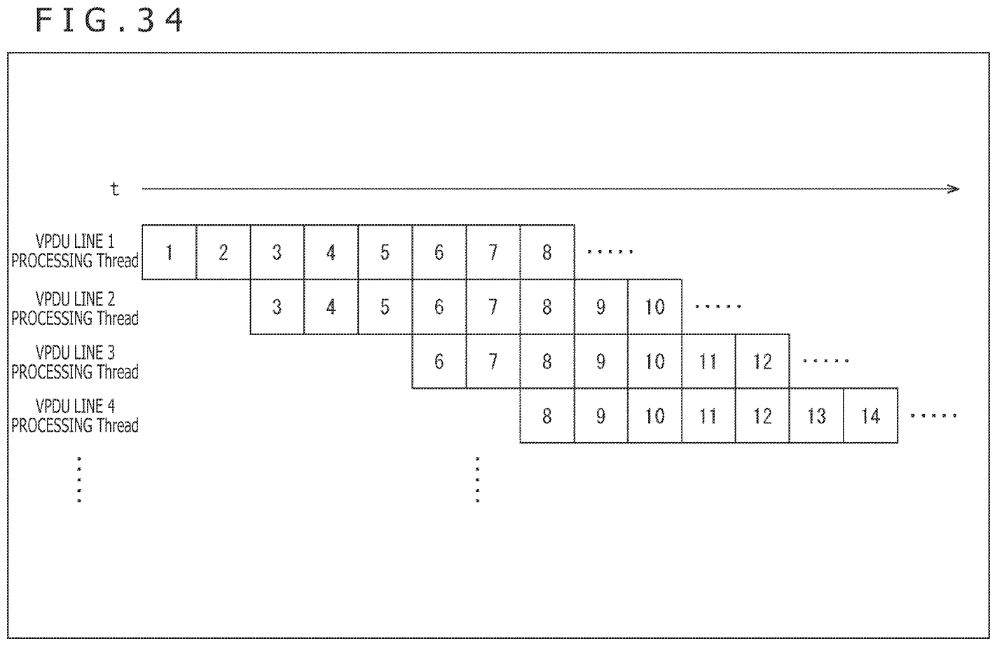

Specifically, as depicted in FIG. 34, a processing thread for an even-numbered VPDU line from the upper side is delayed by 2 VPDUs from a processing thread for the VPDU line one line above the even-numbered VPDU line, while a processing for an odd-numbered VPDU line excluding the first line from the upper side is delayed by 3 VPDUs from a VPDU line one line above the odd-numbered VPDU line.

By setting the processing delay of the odd-numbered VPDU line excluding the first line from the upper side to 3 VPDUs as described above, a dependence relation between transform block lines as a relation established by reference of inter prediction can be reduced without using the limitation to inter prediction adopted in method 1-4-2, and therefore reduction of an increase in the waiting time is achievable.

Note that method 2-3, method 2-3-1, method 2-4, method 2-4-1, and method 2-4-2 are similar to method 1-3, method 1-3-1, method 1-4, method 1-4-1, and method 1-4-3 in <4. Method 1> described above. Accordingly, description of these methods is omitted.

### 7. Second Embodiment

### <7-1: Image Coding Apparatus>

### <Application of Present Technology>

Methods 2 to 2-4-2 described above are also applicable to any apparatus, device, system, or the like. For example, the present technology described in <6. Method 2> may be applied to the image coding apparatus 500 in FIG. 18. Specifically, in the coding section 515, a processing thread for an even-numbered VPDU line from the upper side may execute processing with a delay of 2 VPDUs from a processing thread for a VPDU line located one line above the even-numbered VPDU line, and a processing thread for an odd-numbered VPDU line excluding the first line from the upper side may execute processing with a delay of 3 VPDUs from a VPDU line located one line above the odd-numbered VPDU line.

For example, the coding section 515 may entropy-code the leftmost transform block in the uppermost transform block line in an image using an initial occurrence probability value, may entropy-code each of the leftmost transform blocks in the transform block lines each belonging to a coding tree unit in the highest order of a coding block having the same tree structure as that of transform blocks located one line above, and in the second uppermost transform block line and the transform block lines below the second uppermost transform line in the image using an occurrence probability derived by entropy-coding of the second leftmost transform block in a transform block line one line above, and may entropy-code each of the leftmost transform blocks in the transform block lines belonging to a coding tree unit different from that of the transform blocks one line above, and in the second uppermost transform block line and the transform block lines below the second uppermost transform block line in the image using an occurrence probability derived by entropy-coding of the third leftmost transform block in the transform block line one line above.

The image coding apparatus 500 thus configured is capable of reducing a dependence relation between transform block lines as a relation established by reference of inter prediction, and therefore is capable of reducing an increase in the waiting time, without using the limitation to inter prediction adopted in method 1-4-2. Moreover, the image coding apparatus 500 is capable of reducing a decrease in the degree of parallelism of coding.

### <7-2: Flow of Process>

### <Flow of Image Coding Process>

Described next will be flows of respective processes executed by the image coding apparatus 500 in this case. An image coding process in this case is executed by a flow similar to the flow described with reference to the flowchart in FIG. 19.

### <Flow of Prediction Process>

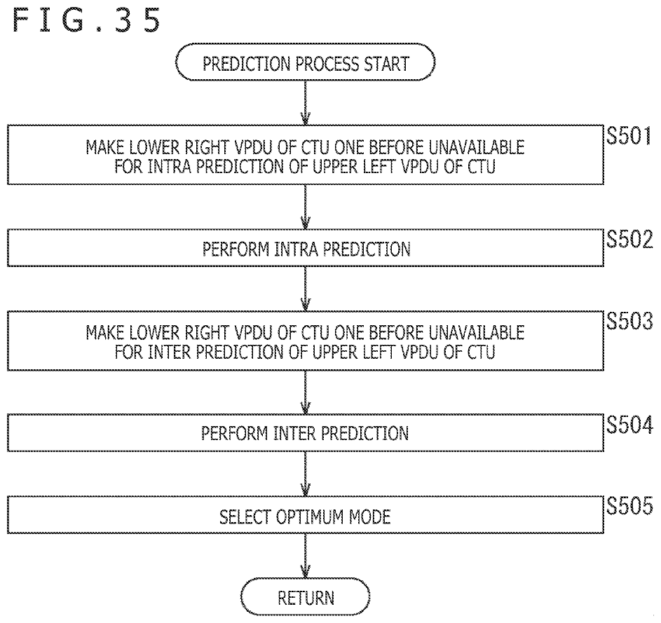

An example of a flow of a prediction process in this case will be subsequently described with reference to a flowchart in FIG. 35.

At a start of the prediction process in this case, processing in each of steps from step S501 to step S505 is executed similarly to the processing in each of the steps from step S131 to step S133, step S135, and step S136 in FIG. 20. Accordingly, in this case, the processing in step S134 in FIG. 20 is skipped (omitted).

### <Flow of Coding Process>

A coding process in this case is executed by a flow similar to the flow described with reference to the flowchart in FIG. 21.

### <Flow of VPDU Process for VPDU Line 1>

A VPDU process for a VPDU line 1 in this case is executed by a flow similar to the flow described with reference to the flowchart in FIG. 22.

### <Flow of VPDU Coding Process>

Moreover, a VPDU coding process in this case is executed by a flow similar to the flow described with reference to the flowchart in FIG. 23.

### <Flow of VPDU Process for VPDU Line T (Odd Number)>

Note that a VPDU process for a VPDU line T (odd number) excluding the first line from the upper side in this case is executed by a flow similar to the flow described with reference to the flowchart in FIG. 24.

### <Flow of VPDU Process for VPDU Line T (Even Number)>

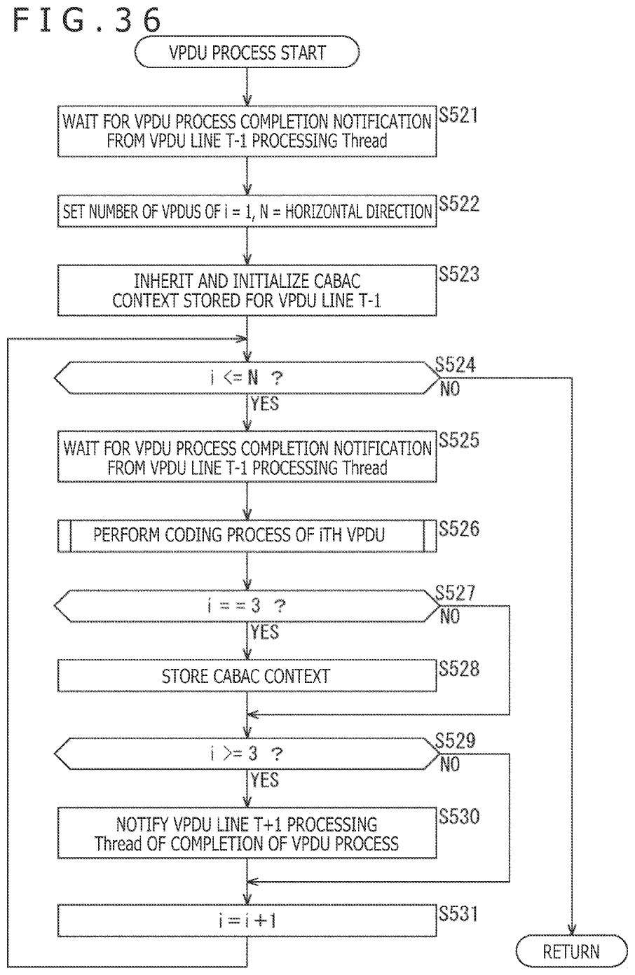

An example of a flow of a VPDU process for an even-numbered VPDU line T from the upper side in this case will be described with reference to a flowchart in FIG. 36.

At a start of the VPDU process, processing in each of steps from step S521 to step S526 is executed similarly to the processing in each of the steps from step S211 to step S216 in FIG. 24.

In step S527, the decoding section 515 determines whether or not a variable i has a value of 3 (i==2). In a case of determination that the variable i has a value of 3, the process proceeds to step S528.

In step S528, the coding section 515 stores CABAC context (occurrence probability) associated with the third VPDU from the left end of an image and generated in step S526. After the context is stored, the process proceeds to step S529.

Moreover, in a case of determination that the variable i has a value other than 3 (the processing target is not the third VPDU from the left end of the image) in step S527, the process proceeds to step S529 while skipping the processing in step S528.

In step S529, the coding section 515 determines whether or not the variable i has a value of 3 or larger (i>=3). In a case of determination that the variable i has a value of 3 or larger, the process proceeds to step S530.

In step S530, the coding section 515 notifies a VPDU line T+1 processing Thread, which is a thread processing a VPDU line T+1 located one line below, of completion of the VPDU process. After completion of the VPDU process completion notification, the process proceeds to step S531.

Moreover, in a case of determination that the variable i has a value smaller than 3 (the processing target is the first or second VPDU from the left end of the image) in step S529, the process proceeds to step S531 while skipping the processing in step S530.

In step S531, the coding section 515 adds 1 to the value of the variable i (i=i+1). After increment of the value of the variable i, the process returns to step S524.

In such a manner, the processing in each of the steps from step S524 to step S531 is repeated until completion of all the VPDUs in the VPDU line T. Thereafter, in a case of determination that no unprocessed VPDU is present (all VPDUs in the VPDU line T have been processed) in step S524, this VPDU process ends, and the process returns to FIG. 21.

By executing the respective processes in the manner described above, the image coding apparatus 500 is capable of reducing a dependence relation between transform block lines as a relation established by reference of inter prediction, and therefore is capable of reducing an increase in the waiting time, without using the limitation to inter prediction adopted in method 1-4-2. Moreover, the image coding apparatus 500 is capable of reducing a decrease in the degree of parallelism of coding.

### <7-3: Image Decoding Apparatus>

### <Application of Present Technology>

Moreover, the present technology in <6. Method 2> described above (method 2 to 2-4-2) is applicable to the image decoding apparatus 600 in FIG. 25, for example. Specifically, in the decoding section 612, a processing thread for an even-numbered VPDU line from the upper side may execute processing with a delay of 2 VPDUs from a processing thread for a VPDU line one line above the even-numbered VPDU line, and a processing thread for an odd-numbered VPDU line excluding the first line from the upper side may execute processing with a delay of 3 VPDUs from a VPDU line one line above the odd-numbered VPDU line.

For example, the decoding section 612 may entropy-decode coded data of the leftmost transform block in the uppermost transform block line in an image using an initial occurrence probability value, may entropy-decode coded data of each of the leftmost transform blocks in the transform block lines each belonging to a coding tree unit in the highest order of a coding block having the same tree structure as that of transform blocks located one line above, and in the second uppermost transform block line and the transform block lines below the second uppermost transform block line in the image using an occurrence probability derived by entropy-decoding of coded data of the second leftmost transform block in the transform block line one line above, and may entropy-decode coded data of each of the leftmost transform blocks in the transform block lines belonging to a coding tree unit different from that of transform blocks one line above, and in the second uppermost transform block line and the transform block lines below the second uppermost transform block line in the image using an occurrence probability derived by entropy-decoding of coded data of the third leftmost transform block in the transform block line one line above.

The image decoding apparatus 600 thus configured is capable of reducing a dependence relation between transform block lines as relation established by reference of inter prediction, and therefore is capable of reducing an increase in the waiting time, without using the limitation to inter prediction adopted in method 1-4-2. Moreover, the image decoding apparatus 600 is capable of reducing a decrease in the degree of parallelism of coding.

### <7-4: Flow of Process>

### <Flow of Image Decoding Process>

Described next will be flows of respective processes executed by the image decoding apparatus 600 in this case. An image decoding process in this case is executed by a flow similar to the flow described with reference to the flowchart in FIG. 26.

### <Flow of Decoding Process>

In addition, a decoding process in this case is executed by a flow similar to the flow described with reference to the flowchart in FIG. 27.

### <Flow of VPDU Process for VPDU Line 1>

Moreover, a VPDU process for a VPDU line 1 in this case is executed by a flow similar to the flow described with reference to the flowchart in FIG. 28.

### <Flow of VPDU Decoding Process>

Furthermore, a VPDU decoding process in this case is executed by a flow similar to the flow described with reference to the flowchart in FIG. 29.

### <Flow of VPDU Process for VPDU Line T (Even Number)>

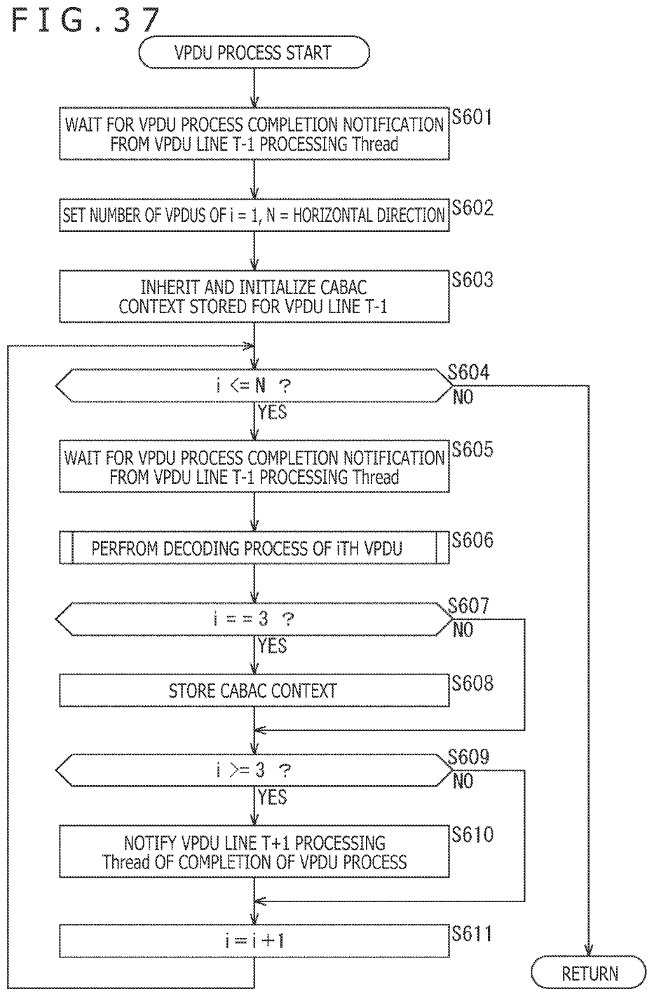

An example of a flow of a VPDU process for a VPDU line T (even number) in this case will be subsequently described with reference to a flowchart in FIG. 37.

At a start of the VPDU process in this case, processing in each of steps from step S601 to step S606 is executed similarly to the processing in each of the steps from step S401 to step S406 in FIG. 30.

In step S607, the decoding section 612 determines whether or not a variable i has a value of 3 (i==2). In a case of determination that the variable i has a value of 3, the process proceeds to step S608.

In step S608, the decoding section 612 stores CABAC context (occurrence probability) associated with the third VPDU from the left end of an image and generated in step S606. After the context is stored, the process proceeds to step S609.

Moreover, in a case of determination that the variable i has a value other than 3 (the processing target is not the third VPDU from the left end of the image) in step S607, the process proceeds to step S609 while skipping the processing in step S608.

In step S609, the decoding section 612 determines whether or not the variable i has a value of 3 or larger (i >=3). In a case of determination that the value of the variable i has a value of 3 or larger, the process proceeds to step S610.

In step S610, the decoding section 612 notifies a VPDU line T+1 processing Thread, which is a thread processing a VPDU line T+1 as a VPDU line located one line below, of completion of the VPDU process. After completion of the VPDU process completion notification, the process proceeds to step S611.

Moreover, in a case of determination that the variable i has a value smaller than 3 (the processing target is the first or second VPDU from the left end of the image) in step S609, the process proceeds to step S611 while skipping the processing in step S610.

In step S611, the decoding section 612 adds 1 to the value of the variable i (i=i+1). After increment of the value of the variable i, the process returns to step S604.

In such a manner, the processing in each of the steps from step S604 to step S611 is repeated until completion of all the VPDUs in the VPDU line T (even number). Thereafter, in a case of determination that no unprocessed VPDU is present (all VPDUs in the VPDU line T (even number) have been processed) in step S604, this VPDU process ends, and the process returns to FIG. 21.

### <Flow of VPDU Process for VPDU Line T (Odd Number)>

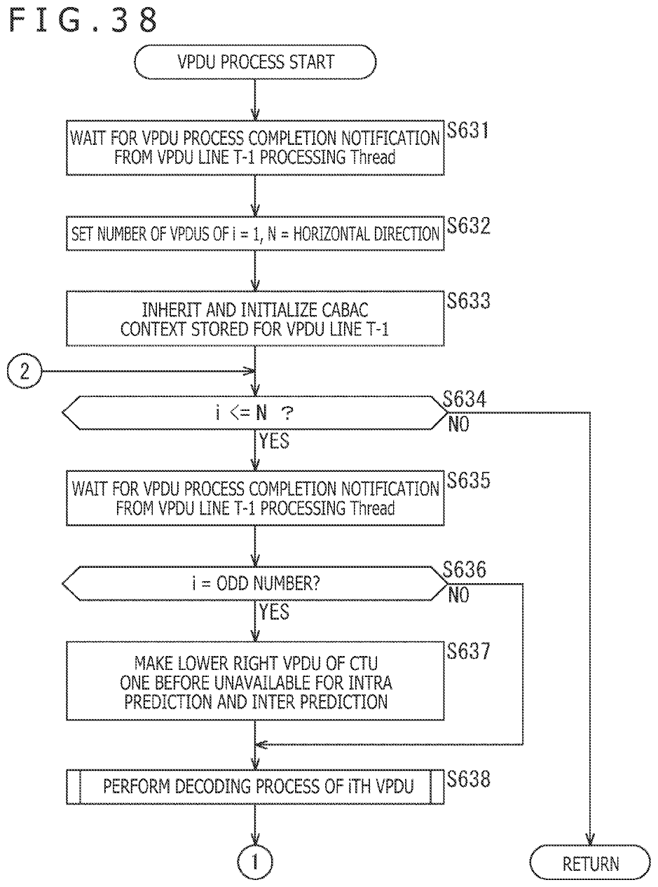

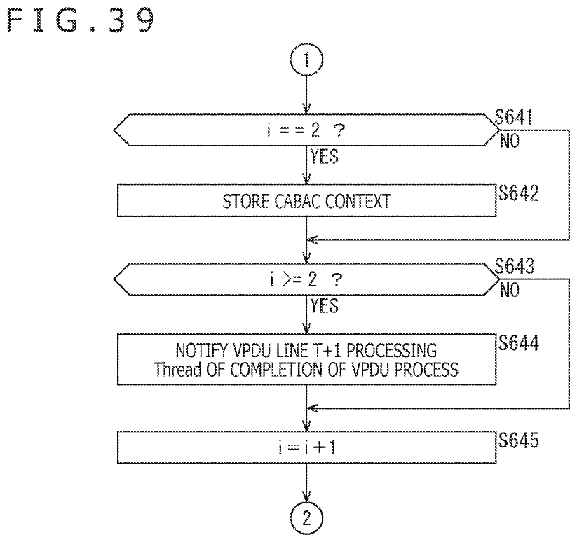

An example of a flow of the VPDU process for a VPDU line T (odd number) (i.e., VPDU process for an odd-numbered VPDU line excluding the first line from the upper side) in this case will be subsequently described with reference to flowcharts in FIGS. 38 and 39.

At a start of the VPDU process in this case, processing in each of steps from step S631 to step S638 in FIG. 38 is executed similarly to the processing in each of the steps from step S431 to step S438 in FIG. 31. After completion of step S638, the process returns to step S641 in FIG. 39.

Thereafter, processing in each of steps from step S641 to step S645 in FIG. 39 is executed similarly to the processing in each of the steps from step S443 to step S447 in FIG. 32. Accordingly, in this case, the processing in step S441 and step S442 in FIG. 32 is skipped (omitted).

After completion of step S645, the process returns to step S634 in FIG. 38.

In other words, the processing in each of the steps from step S634 to step S638 in FIG. 38, and in each of the steps from step S641 to step S645 in FIG. 39 is repeatedly executed until completion of all VPDUs in a VPDU line T (odd number). Thereafter, in a case of determination that no unprocessed VPDU is present (all VPDUs in the VPDU line T (odd number) have been processed) in step S634 in FIG. 38, this VPDU process ends, and the process returns to FIG. 27.

By executing the respective processes in the manner described above, the image decoding apparatus 600 is capable of reducing a dependence relation between transform block lines as a relation established by reference of inter prediction, and therefore is capable of reducing an increase in the waiting time, without using the limitation to inter prediction adopted in method 1-4-2. Moreover, the image decoding apparatus 600 is capable of reducing a decrease in the degree of parallelism of coding.

### <8. Supplementary Notes>

### <Computer>

A series of processes described above may be executed either by hardware or by software. In a case where the series of processes is executed by software, a program constituting the software is installed in a computer. Examples of the computer herein include a computer incorporated in dedicated hardware, and a computer capable of executing various functions under various programs installed in the computer, such as a general-purpose personal computer.

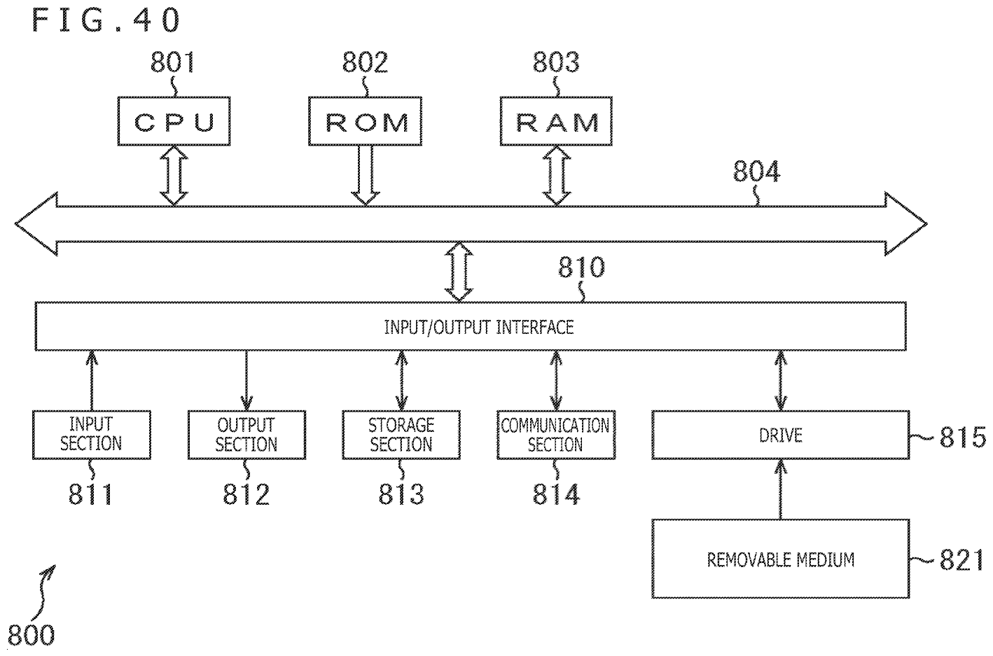

FIG. 40 is a block diagram depicting a hardware configuration example of a computer which executes the series of processes described above under a program.

A computer 800 depicted in FIG. 40 includes a CPU (Central Processing Unit) 801, a ROM (Read Only Memory) 802, and a RAM (Random Access Memory) 803 connected to each other via a bus 804.

An input/output interface 810 is further connected to the bus 804. An input section 811, an output section 812, a storage section 813, a communication section 814, and a drive 815 are connected to the input/output interface 810.

For example, the input section 811 includes a keyboard, a mouse, a microphone, a touch panel, an input terminal, and others. For example, the output section 812 includes a display, a speaker, an output terminal, and others. For example, the storage section 813 includes a hard disk, a RAM disk, a non-volatile memory, and others. For example, the communication section 814 includes a network interface. The drive 815 drives a removable medium 821 such as a magnetic disk, an optical disk, a magneto-optical disk, and a semiconductor memory.

According to the computer configured as described above, for example, the CPU 801 loads a program stored in the storage section 813 into the RAM 803 via the input/output interface 810 and the bus 804, and executes the loaded program to perform the series of processes described above. Data and the like required when the CPU 801 executes various processes are also stored in the RAM 803 as necessary.

For example, the program executed by the computer (CPU 801) is allowed to be recorded in the removable medium 821 as a package medium or the like, and applied in this form. In this case, the program is allowed to be installed into the storage section 813 via the input/output interface 810 from the removable medium 821 attached to the drive 815.

Moreover, the program is allowed to be provided via a wired or wireless transfer medium such as a local area network, the Internet, and digital satellite broadcasting. In this case, the program is allowed to be received by the communication section 814, and installed into the storage section 813.

Furthermore, the program is allowed to be installed in the ROM 802 or the storage section 813 beforehand.

### <Unit of Information and Processing>

Each of a data unit for which various types of information described above are set, and a data unit targeted by various types of processing is any unit, and is not limited to the examples described above. For example, each of these information and processing may be set for each of a TU (Transform Unit), a TB (Transform Block), a PU (Prediction Unit), a PB (Prediction Block), a CU (Coding Unit), and an LCU (Largest Coding Unit), a sub block, a block, a tile, a slice, a picture, a sequence, or a component, or may be performed for data in these types of data unit. Needless to say, the data unit can be set for each information and processing, and the data unit of all information and processing need not be equalized. Note that a storage place for these types of information may be any place, and may be stored in a header, a parameter set, or the like in the data unit described above. Moreover, these types of information may be stored in a plurality of positions.

### <Control Information>

Control information associated with the present technology described in the respective foregoing embodiments may be transferred from the coding side to the decoding side. For example, control information for controlling whether to permit (or prohibit) application of the present technology described above (e.g., enabled_flag) may be transferred. Moreover, for example, control information indicating a target to which the present technology described above is applied (or a target to which the present technology is not applied) may be transferred. For example, control information for designating a block size (upper limit, lower limit, or both), a frame, a component, a layer, or the like to which the present technology is applied (or application thereto is permitted or prohibited) may be transferred.

### <Application of Present Technology>

The present technology is applicable to any image coding and decoding system. Specifically, specifications of various types of processes associated with image coding and decoding, such as transform (inverse transform), quantization (inverse quantization), coding (decoding), and prediction, may be any specifications, and are not limited to the specifications described in the above examples unless inconsistency with the present technology described above is produced. Moreover, a part of these processes may be omitted unless inconsistency with the present technology described above is produced.

Furthermore, the present technology is applicable to multi-viewpoint image coding and decoding system which codes and decodes multi-viewpoint images including images having a plurality of viewpoints (views). In this case, it is sufficient if the present technology is applied to coding and decoding of respective viewpoints (views).

In addition, the present technology is applicable to a hierarchical image coding (scalable coding) decoding system which codes and decodes hierarchical images having a plurality of layers (hierarchized) so as to obtain scalability functions for predetermined parameters. In this case, it is sufficient if the present technology is applied to coding and decoding of respective hierarchies (layers).

For example, the image processing apparatus, the image coding apparatus, and the image decoding apparatus according to the embodiments described above are applicable to various types of electronic apparatuses, such as a transmitter and a receiver (e.g., television receiver and cellular phone) for wired broadcasting like satellite broadcasting and cable TV, distribution on the Internet, distribution to terminals via cellular communication, or the like, and a device (e.g., hard disk recorder and camera) which records images in such a medium as an optical disk, a magnetic disk, or a flash memory, or reproduces images from these types of recording medium.

Moreover, the present technology is allowed to be practiced as any configuration incorporated in a device constituting any apparatus or system, such as a processor (e.g., video processor) as a system LSI (Large Scale Integration) or the like, a module (e.g., video module) using a plurality of processors or the like, a unit (e.g., video unit) using a plurality of modules or the like, and a set (e.g., video set) as a unit to which another function is added (i.e., a configuration of a part of a device).

Furthermore, the present technology is applicable to a network system including a plurality of devices. For example, the present technology is applicable to a cloud service which provides services associated with images (moving images) for any terminal such as a computer, an AV (Audio Visual) apparatus, a portable information processing terminal, and an IoT (Internet of Things) device.

Note that a system, a device, a processing unit, and the like to which the present technology is applied is usable in any fields, such as transportation, medical treatments, crime prevention, agriculture, stock breeding, mining, beauty, plants, home appliances, meteorology, and nature surveillance. Moreover, use applications in these fields may be any use applications.

For example, the present technology is applicable to a system or a device used for providing appreciation content or the like. Moreover, for example, the present technology is applicable to a system or a device used for transportation, such as monitoring of a traffic status and autonomous driving control. Furthermore, for example, the present technology is applicable to a system or a device used for security. In addition, for example, the present technology is applicable to a system or a device used for automatic control of a machine or the like. Besides, for example, the present technology is applicable to a system or a device used for a system or a device used for agriculture or stock breeding. Moreover, for example, the present technology is applicable to a system or a device used for monitoring of a state of nature such as a volcano, a forest, and an ocean, wildlife, or the like. Furthermore, for example, the present technology is applicable to a system or a device used for sports.

### <Others>

Note that a “flag” in the present description refers to information for identifying a plurality of states, including not only information used for identifying two states including true (1) and false (0) states, but also information allowing identification of three or more states. Accordingly, the “flag” may have two values including 1 and 0, for example, or three or more values. The number of bits constituting the “flag” therefore may be any number, and may include one bit or a plurality of bits. Moreover, it is assumed that a bit stream includes not only identification information (including flag), but also difference information indicating a difference between the identification information and information as a certain reference. Accordingly, the “flag” and the “identification information” in the present description contain not only the corresponding information, but also difference information indicating a difference from information as a reference.

Furthermore, various kinds of information (e.g., metadata) concerning coded data (bit stream) may be transferred or recorded in any form as long as the information is associated with the coded data. The term “associated” herein refers to a state where one data is made available (linked) during processing of other data, for example. Accordingly, respective pieces of data associated with each other may be combined into one piece of data, or may be handled as separate pieces of data. For example, information associated with coded data (image) may be transferred via a transfer path different from a transfer path of this coded data (image). Moreover, for example, information associated with coded data (image) may be recorded in a recording medium different from a recording medium (or a different recording area of the same recording medium) of this coded data (image). Note that the “associated” state is not limited to a state of the entire data, and may be a state of a part of the data. For example, an image and information associated with the image may be associated with each other in units of any frame, such as a plurality of frames, one frame, or a part in a frame.

Note that each of terms such as “synthesize,” “multiplex,” “add,” “integrate,” “include,” “store,” “put into,” “stick into,” and “insert” in the present description refers to combining a plurality of pieces into one piece, such as combining coded data and metadata into one piece of data, and indicates one method of producing the “associated” state described above.

Furthermore, embodiments of the present technology are not limited to the embodiments described above and may be modified in various manners without departing from the subject matters of the present technology.

Moreover, for example, a configuration described as one apparatus (or processing section) may be divided into a plurality of apparatuses (or processing sections). Conversely, a configuration described above as a plurality of apparatuses (or processing sections) may be combined into one apparatus (or processing section). Furthermore, needless to say, a configuration other than the configurations described above may be added to the configuration of the respective apparatuses (or respective processing sections). In addition, if configurations or operations as the entire system are substantially identical, a part of a configuration of a certain apparatus (or processing section) may be included in a configuration of another apparatus (or another processing section).

Note that a system in the present description refers to a set of a plurality of constituent elements (e.g., devices, modules (parts)). It does not matter whether or not all the constituent elements are contained in an identical housing. Accordingly, a plurality of devices accommodated in different housings and connected to each other via a network, and one device which includes a plurality of modules accommodated in one housing are both considered as a system.

Moreover, for example, the present technology may have a configuration of cloud computing where one function is shared and processed by a plurality of apparatuses in cooperation with each other via a network.

Furthermore, for example, programs described above may be executed by any apparatus. In this case, it is sufficient if the apparatus has a necessary function (e.g., a function block), and acquires necessary information.

In addition, for example, the respective steps described in the flowcharts described above may be executed by one apparatus, or shared and executed by a plurality of apparatuses. Moreover, in a case where one step includes a plurality of processes, the plurality of processes included in the one step may be executed by one apparatus, or shared and executed by a plurality of apparatuses. In other words, a plurality of processes included in one step may be executed as processes of a plurality of steps. Conversely, processes described as a plurality of steps may be combined and executed as one step.

Note that a program executed by a computer may be a program where processes of steps describing the program are executed in an order described in the present description in time series, or separately executed in parallel or at necessary timing such as an occasion of a call. In other words, the processes of the respective steps may be executed in an order different from the order described above as long as no inconsistency is produced. Furthermore, the processes of the steps describing the program may be executed in parallel with processes of other programs, or may be executed in combination with other programs.

Note that a plurality of aspects of the present technology presented in the present description may be independently practiced as separate aspects as long as no inconsistency is produced. Needless to say, any of the plurality of aspects of the present technology may be combined and practiced. For example, a part or all of the present technology described in any one of the embodiments may be combined with a part or all of the present technology described in any of the other embodiments. In addition, a part or all of any aspect of the present technology may be combined with other technologies not described above, and practiced in this form.

Note that the present technology is allowed to also have following configurations.

(1)

An image processing apparatus including:

a coding section that codes coefficient data associated with an image, in parallel for each of lines of transform blocks each of which is a unit transforming image data into coefficient data.

(2)

The image processing apparatus according to (1), in which

the coding section sequentially codes each of the lines of the transform blocks of the coefficient data associated with the image, transform block by transform block in an order from a left transform block, and

the coding section entropy-codes each of the transform blocks using an occurrence probability derived by entropy-coding performed one entropy-coding before.

(3)

The image processing apparatus according to (2), in which

the coding section entropy-codes a leftmost transform block in an uppermost line of the transform blocks in the image using an initial value of the occurrence probability, and

the coding section entropy-codes each of the leftmost transform blocks in a second uppermost line of the transform blocks and lines below the second uppermost line in the image using an occurrence probability derived by entropy-coding of the second leftmost transform block in the line of the transform blocks one line above.

(4)

The image processing apparatus according to (2), in which

the coding section entropy-codes a leftmost transform block in an uppermost line of the transform blocks in the image using an initial value of the occurrence probability,

the coding section entropy-codes each of the leftmost transform blocks in lines that are a second uppermost line of the transform blocks and lines below the second uppermost line in the image, and that each belong to a coding tree unit in an uppermost order of a coding block of a tree structure identical to a tree structure of the transform blocks one line above, using an occurrence probability derived by entropy-coding of a second leftmost transform block of the line of the transform blocks located one line above, and

the coding section entropy-codes each of the leftmost transform blocks in the lines that are the second uppermost line of the transform blocks and the lines below the second uppermost line in the image, and that each belong to a coding tree unit different from the coding tree unit of the transform blocks one line above, using an occurrence probability derived by entropy-coding of a third leftmost transform block of the line of the transform blocks located one line above.

(5)

The image processing apparatus according to (1), in which

each of the transform blocks includes a VPDU (Virtual pipeline data Unit).

(6)

The image processing apparatus according to (1), further including:

a prediction section that performs intra prediction of the image, in which,

for intra prediction of an upper left transform block of a coding tree unit in an uppermost order of a coding block of a tree structure, the prediction section makes reference to a lower right transform block of a coding tree unit coded one tree unit before to be unavailable.

(7)

The image processing apparatus according to (1), further including:

a prediction section that performs inter prediction of the image, in which,

for inter prediction of an upper left transform block of a coding tree unit in an uppermost order of a coding block of a tree structure, the prediction section makes reference to a motion vector of a lower right transform block of a coding tree unit coded one tree unit before to be unavailable.

(8)

The image processing apparatus according to (1) further including:

a prediction section that performs inter prediction of the image, in which,

for inter prediction of a prediction block that is a processing unit of the inter prediction, and has a horizontal length identical to a horizontal length of a coding tree unit in an uppermost order of a coding block of a tree structure, the prediction section makes reference to a motion vector of an upper right transform block to be unavailable.

(9)

The image processing apparatus according to (1), in which,

for each of prediction blocks each of which is a processing unit of inter prediction and has a horizontal length identical to a horizontal length of a coding tree unit in the highest order of a coding block of a tree structure, the coding section codes mode information indicating a mode of inter prediction for each of the prediction blocks, and codes residual data between the image and a prediction image for each of the transform blocks contained in the corresponding prediction block.

(10)

An image processing method including:

coding coefficient data associated with an image, in parallel for each of lines of transform blocks each of which is a unit transforming image data into coefficient data.

(11)

An image processing apparatus including:

a decoding section that decodes coded data, that has been obtained by coding coefficient data associated with an image, in parallel for each line of transform blocks each of which is a unit of transforming image data into coefficient data.

(12)

The image processing apparatus according to (11), in which

the decoding section decodes coded data of each of the lines of the transform blocks of the coefficient data associated with the image sequentially transform block by transform block in an order from the left transform block, and

the decoding section entropy-decodes the coded data of each of the transform blocks using an occurrence probability derived by entropy-decoding performed one entropy-decoding before.

(13)

The image processing apparatus according to (12), in which

the decoding section entropy-decodes coded data of the leftmost transform block in the uppermost line of the transform blocks in the image using an initial value of the occurrence probability, and

the decoding section entropy-decodes coded data of each of the leftmost transform blocks in the second uppermost line of the transform blocks and the lines below the second uppermost line in the image using an occurrence probability derived by entropy-decoding of coded data of the second leftmost transform block in the line of the transform blocks one line above.

(14)

The image processing apparatus according to (12), in which

the decoding section entropy-decodes coded data of the leftmost transform block in the uppermost line of the transform blocks in the image using an initial value of the occurrence probability,

the decoding section entropy-decodes coded data of each of the leftmost transform blocks in the lines that are the second uppermost line of the transform blocks and the lines below the second uppermost line in the image, and each belong to a coding tree unit in an uppermost order of a coding block of a tree structure identical to a tree structure of the transform blocks one line above, using an occurrence probability derived by entropy-decoding of coded data of the second leftmost transform block of the line of the transform blocks located one line above, and

the decoding section entropy-decodes coded data of each of the leftmost transform blocks in the lines that are the second uppermost line of the transform blocks and the lines below the second uppermost line in the image, and each belong to a coding tree unit different from the coding tree unit of the transform blocks one line above, using an occurrence probability derived by entropy-decoding of coded data of the third leftmost transform block of the line of the transform blocks located one line above.

(15)

The image processing apparatus according to (11), in which

each of the transform blocks is a VPDU (Virtual pipeline data Unit).

(16)

The image processing apparatus according to (11), further including:

a prediction section that performs intra prediction of the image, in which,

for intra prediction of an upper left transform block of a coding tree unit in an uppermost order of a coding block of a tree structure, the prediction section makes reference to a lower right transform block of a coding tree unit decoded one tree unit before to be unavailable.

(17)

The image processing apparatus according to (11), further including:

a prediction section that performs inter prediction of the image, in which,

for inter prediction of an upper left transform block of a coding tree unit in an uppermost order of a coding block of a tree structure, the prediction section makes reference to a motion vector of a lower right transform block of a coding tree unit decoded one tree unit before to be unavailable.

(18)

The image processing apparatus according to (11), further including:

a prediction section that performs inter prediction of the image, in which,

for inter prediction of a prediction block that is a processing unit of the inter prediction, and has a horizontal length identical to a horizontal length of a coding tree unit in an uppermost order of a coding block of a tree structure, the prediction section makes reference to a motion vector of an upper right transform block to be unavailable.

(19)

The image processing apparatus according to (11), in which,

for each of prediction blocks each of which is a processing unit of inter prediction and has a horizontal length identical to a horizontal length of a coding tree unit in the highest order of a coding block of a tree structure, the decoding section decodes coded data of mode information indicating a mode of inter prediction for each of the prediction blocks, and decodes coded data of residual data between the image and a prediction image for each of the transform blocks contained in the corresponding prediction block.

(20)

An image processing method including:

decoding coded data, that has been obtained by coding coefficient data associated with an image, in parallel for each line of transform blocks each of which is a unit of transforming image data into coefficient data.

### REFERENCE SIGNS LIST

500: Image coding apparatus
501: Control section
515: Coding section
522: Prediction section
600: Image decoding apparatus
612: Decoding section
619: Prediction section

1. An image processing apparatus comprising:
a coding section that codes coefficient data associated with an image, in parallel for each of lines of transform blocks each of which is a unit transforming image data into coefficient data.

2. The image processing apparatus according to claim 1, wherein
the coding section sequentially codes each of the lines of the transform blocks of the coefficient data associated with the image, transform block by transform block in an order from a left transform block, and
the coding section entropy-codes each of the transform blocks using an occurrence probability derived by entropy-coding performed one entropy-coding before.

3. The image processing apparatus according to claim 2, wherein
the coding section entropy-codes thae leftmost transform block in an uppermost line of the transform blocks in the image using an initial value of the occurrence probability, and
the coding section entropy-codes each of the leftmost transform blocks in a second uppermost line of the transform blocks and lines below the second uppermost line in the image using an occurrence probability derived by entropy-coding of the second leftmost transform block in the line of the transform blocks one line above.

4. The image processing apparatus according to claim 2, wherein
the coding section entropy-codes a leftmost transform block in an uppermost line of the transform blocks in the image using an initial value of the occurrence probability,
the coding section entropy-codes each of the leftmost transform blocks in lines that are a second uppermost line of the transform blocks and lines below the second uppermost line in the image, and that each belong to a coding tree unit in an uppermost order of a coding block of a tree structure identical to a tree structure of the transform blocks one line above, using an occurrence probability derived by entropy-coding of a second leftmost transform block of the line of the transform blocks located one line above, and
the coding section entropy-codes each of the leftmost transform blocks in the lines that are the second uppermost line of the transform blocks and the lines below the second uppermost line in the image, and that each belong to a coding tree unit different from the coding tree unit of the transform blocks one line above, using an occurrence probability derived by entropy-coding of a third leftmost transform block of the line of the transform blocks located one line above.

5. The image processing apparatus according to claim 1, wherein
each of the transform blocks includes a VPDU (Virtual pipeline data Unit).

6. The image processing apparatus according to claim 1, further comprising:
a prediction section that performs intra prediction of the image, wherein,
for intra prediction of an upper left transform block of a coding tree unit in an uppermost order of a coding block of a tree structure, the prediction section makes reference to a lower right transform block of a coding tree unit coded one tree unit before to be unavailable.

7. The image processing apparatus according to claim 1, further comprising:
a prediction section that performs inter prediction of the image, wherein,
for inter prediction of an upper left transform block of a coding tree unit in an uppermost order of a coding block of a tree structure, the prediction section makes reference to a motion vector of a lower right transform block of a coding tree unit coded one tree unit before to be unavailable.

8. The image processing apparatus according to claim 1, further comprising:
a prediction section that performs inter prediction of the image, wherein,
for inter prediction of a prediction block that is a processing unit of the inter prediction, and has a horizontal length identical to a horizontal length of a coding tree unit in an uppermost order of a coding block of a tree structure, the prediction section makes reference to a motion vector of an upper right transform block to be unavailable.

9. The image processing apparatus according to claim 1, wherein,
for each of prediction blocks each of which is a processing unit of inter prediction and has a horizontal length identical to a horizontal length of a coding tree unit in the highest order of a coding block of a tree structure, the coding section codes mode information indicating a mode of inter prediction for each of the prediction blocks, and codes residual data between the image and a prediction image for each of the transform blocks contained in the corresponding prediction block.

10. An image processing method comprising:
coding coefficient data associated with an image, in parallel for each of lines of transform blocks each of which is a unit transforming image data into coefficient data.

11. An image processing apparatus comprising:
a decoding section that decodes coded data, that has been obtained by coding coefficient data associated with an image, in parallel for each line of transform blocks each of which is a unit of transforming image data into coefficient data.

12. The image processing apparatus according to claim 11, wherein
the decoding section decodes coded data of each of the lines of the transform blocks of the coefficient data associated with the image sequentially transform block by transform block in an order from the left transform block, and
the decoding section entropy-decodes the coded data of each of the transform blocks using an occurrence probability derived by entropy-decoding performed one entropy-decoding before.

13. The image processing apparatus according to claim 12, wherein
the decoding section entropy-decodes coded data of the leftmost transform block in the uppermost line of the transform blocks in the image using an initial value of the occurrence probability, and
the decoding section entropy-decodes coded data of each of the leftmost transform blocks in the second uppermost line of the transform blocks and the lines below the second uppermost line in the image using an occurrence probability derived by entropy-decoding of coded data of the second leftmost transform block in the line of the transform blocks one line above.

14. The image processing apparatus according to claim 12, wherein
the decoding section entropy-decodes coded data of the leftmost transform block in the uppermost line of the transform blocks in the image using an initial value of the occurrence probability,
the decoding section entropy-decodes coded data of each of the leftmost transform blocks in the lines that are the second uppermost line of the transform blocks and the lines below the second uppermost line in the image, and each belong to a coding tree unit in an uppermost order of a coding block of a tree structure identical to a tree structure of the transform blocks one line above, using an occurrence probability derived by entropy-decoding of coded data of the second leftmost transform block of the line of the transform blocks located one line above, and
the decoding section entropy-decodes coded data of each of the leftmost transform blocks in the lines that are the second uppermost line of the transform blocks and the lines below the second uppermost line in the image, and each belong to a coding tree unit different from the coding tree unit of the transform blocks one line above, using an occurrence probability derived by entropy-decoding of coded data of the third leftmost transform block of the line of the transform blocks located one line above.

15. The image processing apparatus according to claim 11, wherein
each of the transform blocks is a VPDU (Virtual pipeline data Unit).

16. The image processing apparatus according to claim 11, further comprising:
a prediction section that performs intra prediction of the image, wherein,
for intra prediction of an upper left transform block of a coding tree unit in an uppermost order of a coding block of a tree structure, the prediction section makes reference to a lower right transform block of a coding tree unit decoded one tree unit before to be unavailable.

17. The image processing apparatus according to claim 11, further comprising:
a prediction section that performs inter prediction of the image, wherein,
for inter prediction of an upper left transform block of a coding tree unit in an uppermost order of a coding block of a tree structure, the prediction section makes reference to a motion vector of a lower right transform block of a coding tree unit decoded one tree unit before to be unavailable.

18. The image processing apparatus according to claim 11, further comprising:
a prediction section that performs inter prediction of the image, wherein,
for inter prediction of a prediction block that is a processing unit of the inter prediction, and has a horizontal length identical to a horizontal length of a coding tree unit in an uppermost order of a coding block of a tree structure, the prediction section makes reference to a motion vector of an upper right transform block to be unavailable.

19. The image processing apparatus according to claim 11, wherein,
for each of prediction blocks each of which is a processing unit of inter prediction and has a horizontal length identical to a horizontal length of a coding tree unit in the highest order of a coding block of a tree structure, the decoding section decodes coded data of mode information indicating a mode of inter prediction for each of the prediction blocks, and decodes coded data of residual data between the image and a prediction image for each of the transform blocks contained in the corresponding prediction block.

20. An image processing method comprising:
decoding coded data, that has been obtained by coding coefficient data associated with an image, in parallel for each line of transform blocks each of which is a unit of transforming image data into coefficient data.
